(19) United States
(12) Patent Application Publication
(10) Pub. No.: US 2026/0086240 A1
(43) Pub. Date: Mar. 26, 2026

(54) LIDAR WITH GUARD LASER BEAM AND ADAPTIVE HIGH-INTENSITY LASER BEAM

(71) Applicant: James O'Keeffe, MOUNTAIN VIEW, CA (US)

(72) Inventor: James O'Keeffe, MOUNTAIN VIEW, CA (US)

(21) Appl. No.: 19/409,440

(22) Filed: Dec. 4, 2025

Related U.S. Application Data
(63) Continuation-in-part of application No. 17/114,456, filed on Dec. 7, 2020, now abandoned.
Application No. 17/114,456 is a continuation-in-part of application No. 16/459,494, filed on Jul. 1, 2019, now Pat. No. 10,859,678.
Application No. 16/459,494 is a continuation-in-part of application No. PCT/US2017/069173, filed on Dec. 31, 2017.
Application No. 17/114,456 is a continuation-in-part of application No. 15/832,790, filed on Dec. 6, 2017, now Pat. No. 10,908,264.
Application No. 15/832,790 is a continuation-in-part of application No. PCT/US2017/049231, filed on Aug. 29, 2017.
(60) Provisional application No. 62/380,951, filed on Aug. 29, 2016.
(60) Provisional application No. 62/441,492, filed on Jan. 2, 2017.
(60) Provisional application No. 62/441,563, filed on Jan. 3, 2017.
(60) Provisional application No. 62/441,627, filed on Jan. 3, 2017.

(51) Int. Cl. G01S 17/931; G01S 7/481; G01S 7/4865

(52) U.S. Cl. CPC G01S 17/931; G01S 7/4817; G01S 7/4865

(57) ABSTRACT

Described herein are LIDAR systems that dynamically enhance a complex shape region of interest in a field of view (FOV) using a micromirror array. Also described herein are LIDAR systems that generate low-intensity (e.g. eye-safe) laser pulses in a protective guard region (e.g. a guard ring) that surrounds the high-intensity laser pulses to adapt or steer an angular range of the high-intensity laser pulses to avoid an object detected within the low-intensity guard region.

### CROSS REFERENCE TO RELATED APPLICATIONS

This application is a continuation of pending U.S. patent application Ser. No. 17/114,456, filed Dec. 7, 2020, titled “LIDAR WITH GUARD LASER BEAM AND ADAPTIVE HIGH-INTENSITY LASER BEAM”, which is a continuation-in-part of U.S. patent application Ser. No. 16/459,494, filed Jul. 1, 2019, titled “MICROMIRROR ARRAY FOR FEEDBACK-BASED IMAGE RESOLUTION ENHANCEMENT,” now U.S. Patent Application Publication No. 2019/0324124, which is a continuation-in-part of International Application No.

PCT/US2017/069173, filed Dec. 31, 2017; which application claims the benefit of the following: U.S. Provisional Application No. 62/441,492, filed Jan. 2, 2017, titled DYNAMICALLY STEERED LASER RANGE FINDING FOR OBJECT LOCALIZATION, and U.S. Provisional Application No. 62/441,563, filed Jan. 3, 2017, titled ELECTRONICALLY STEERED LIDAR WITH DIRECTION FEEDBACK, and U.S.

Provisional Application No. 62/441,627, filed Jan. 3, 2017, titled LASER RANGE FINDING WITH DYNAMICALLY CONFIGURED MICROMIRRORS, all by the present inventor; the disclosures of which are fully incorporated by reference herein.

Pending U.S. patent application Ser. No. 17/114,456 is also a continuation-in-part of U.S. patent application Ser. No. 15/832,790, filed Dec. 6, 2017, titled “LIDAR WITH AN ADAPTIVE HIGH-INTENSITY ZONE,” now U.S. Patent Application Publication No. 2018/0106890, which is a continuation-in-part of International Application No.

PCT/US2017/049231, filed Aug. 29, 2017, which claims the benefit of priority to of U.S. provisional patent application Ser. No. 62/380,951, filed on Aug. 29, 2016.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND

In digital photography a charge-coupled-device CCD sensor can gather light from several million directions simultaneously to generate detailed images. In contrast, many light detection and ranging systems (LIDARs) scan or rotate laser beams to measure the time of flight in a sequence of directions. The sequential measurement nature limits the total number of range measurements per second. Hence a LIDAR that scans a FOV in a uniform deterministic manner can provide poor angular resolution. In a related area analog micromirror arrays have been proposed for providing zoom properties in digital cameras. Zooming in (e.g., narrowing the FOV) to enhance image quality can be effective for both 2D photography and 3D time-of-flight cameras (e.g., Flash LIDARs). However there are circumstances where a wide field of view and enhanced image quality are both desirable. U.S. Pat No. 9,383,753 to Templeton discloses a LIDAR with dynamically adjustable angular resolution, but only describes dynamic angular velocity in a single axis for a rotating LIDAR. U.S. Pat. No. 9,383,753 further assumes a rotating LIDAR and does not provide for arbitrary laser orientation within a scan. Hence, dynamically adapting LIDAR or camera measurement density within a scan, to improve the accuracy of object boundary detection in the FOV remains a challenge.

Laser light poses several safety risks to humans, based on the coherent nature of laser radiation. The potential for eye damage is often the modality that requires the most stringent limits on laser power. In controlled environments (e.g. a laboratory) precautions can be used such as protective eyewear or housing a laser in a specialized enclosure with safety interlocks. In open environments (e.g. streets and highways) such precautions cannot be assumed and hence eye-safety is often ensured by using inherently eye-safe lasers (e.g. ANSI Z136.4 class 1 lasers).

Laser range finding is a useful technology for autonomous vehicles but must operate safely in human-filled environments. Maximum measurement range can benefit from higher laser intensity. However, many countries and regions of the world impose varying limits on the maximum permissible laser radiation (e.g. energy per square centimeter or energy per pulse).

Traditionally, adherence to these laser radiation limits is ensured by design and validated during the laser system qualification. This designed-in approach to limiting laser radiation exposure is conservative and often suboptimal. Recent, alternative approaches attempt to sense objects in the vicinity of a laser that is operating above an intrinsically safe (e.g. eye-safe) threshold. The intensity of a laser beam can decrease as it travels from a source and hence it may only be necessary to monitor for objects (e.g. people) within a threshold distance from the source to ensure safe laser operation. U.S. Pat. No. 9,121,703 issued to Droz discloses using a proximity sensor to sense an object within a threshold distance of the laser range finder and discontinuing laser emission upon detection. Proximity sensors (e.g. passive infrared sensors) are useful for identifying objects in the vicinity but provide little specificity regarding location and the path or trajectory of objects in the field of view (FOV) of the laser system. Proximity-based laser-deactivation can be useful when a laser system emits high-intensity laser light in a wide range of azimuthal directions (e.g. 360 degrees) but can be overly-conservative (e.g. produce many false positives) for a laser system that emits high-intensity pulses in only a narrow range of directions.

U.S. Pat. No. 8,948,591 to Scherbarth discloses a laser range finder that detects objects within a threshold distance during some previous time period and discontinues laser emission upon detecting an object within the threshold distance. This approach does not address the challenge of high-intensity laser pulses during the discovery of a new object within the threshold distance. Several safety standards (e.g. ANSI Z136.4) require all laser pulses meet an eye-safe intensity requirement, even a single laser pulse during discovery of a new object.

Therefore, an ongoing technical challenge is the operation of a laser range finder in a high-intensity mode while ensuring safety and avoiding frequent false positive laser power reductions.

### SUMMARY

In one aspect a micromirror array can act like an electronically controllable transfer function for light, between an input lens of a camera or LIDAR and a photodetector array. For example an analog micromirror array can perform a zoom function by reconfiguring some or all of the micromirrors to deflect light rays from a portion of an available FOV onto the photodetector array while simultaneously spreading the portion over more elements of the photodetector. This has the effect of increasing image resolution (e.g., the number of photodetector elements per unit solid angle of the field of view or pixels per square degree or elements per steradian in the FOV). However reconfiguring the micromirror array to increase the resolution of a portion of a FOV can have the drawback of reducing the total angular range (FOV) measured by the photodetector array (i.e., zooming in on the scene can have the effect of increasing the resolution while decreasing the total FOV or 2D angular range sensed). While micromirror arrays can be configured into microlens, thereby enhancing image resolution, there are many times when a wide FOV (i.e., maintaining an original 2D angular range of the scene detected by photodetector array) is also desirable.

A system and method are provided to sense a specified FOV with enhanced resolution. In one embodiment a method performed by an imaging system comprises providing at an aperture a 2D field of view (FOV) from a scene to a micromirror array having a first configuration, and thereby deflecting light with the micromirror array from the FOV onto a photodetector array. The method further comprises detecting with the photodetector array a first set of light measurements spanning the FOV, processing the first set of light measurements and thereby identifying a region of interest (e.g., a region surrounding an object edge or a face), in the FOV. The set of light measurements can have a first resolution in the region of interest, based on the angular range that each element in the photodetector array receives, for example 1 light measurement or 1 photodetector element per one square degree of solid angle in the FOV. The first resolution can be based on the first configuration of the micromirror array. The method further comprises configuring the micromirror array based at least in part on the identified region of interest and thereby detecting with the photodetector array a second set of light measurements spanning the FOV with a second resolution in the region of interest that is greater than the first resolution.

In one aspect the method can conserve the size (e.g., angular range) of the original FOV, thereby keeping people and pets in the frame of the resulting 2D images and not distracting a user with an unwanted zoom effect. In another aspect the method can enhance image resolution while simultaneously conserving the original FOV; by configuring the micromirror array to compress light rays from one or more uninteresting portions of the FOV onto fewer pixels in the photodetector array (e.g., based on the first set of light measurements) and thereby enabling light rays from the region(s) of interest to be spread over more pixels to enhance the resolution. Therefore, by creating areas of sparse and denser light rays on the photodetector array simultaneously the original FOV is conserved.

In a system embodiment a processing subassembly with access to both sensor data from the photodetector array and a micromirror configuration can correct for the distortive effect of the dense and sparse zones on the photodetector array and generate an eye-pleasing output image. In another embodiment, data from sensors or sources other than the photodetector array can be used to identify the region(s) of interest. In a second embodiment a method performed by an imaging system comprises: Processing sensor data indicative from a scene in the vicinity of a micromirror array and thereby identifying a region of interest in the sensor data, wherein the micromirror array has a field of view encompassing at least some of the scene, wherein the micromirror array comprises a plurality of micromirrors with an initial configuration that deflects light from the region of interest towards a detector array and thereby provides a first resolution at the detector array for the light from the region of interest. The method further comprises reconfiguring at least a subset of the plurality of micromirrors in the micromirror array, based at least in part on the identified region of interest and thereby providing at the detector array a second resolution for light form the region of interest that is greater than the first resolution. In a third embodiment the micromirror array can be part of a ranging subassembly in a LIDAR. For example, a flash LIDAR can illuminate a field of view (FOV) with flashes of light (e.g., laser light) and gather reflections from the FOV at a photodetector array. A micromirror array can be configured based on an identified region of interest to non-uniformly spread the light reflections from the flashes of light based on the identified region of interest.

In a second group of embodiments a LIDAR performs a progressive boundary localization (PBL) method to determine the location of time-of-flight (TOF) boundaries to within some minimum angular spacing in a FOV (i.e., progressively resolve the boundaries of objects in environment local to the LIDAR). The method can generate a sequence of laser pulses, measure a corresponding sequence of laser reflections and measure a time of flight and direction corresponding to each of the laser pulse. In response to identifying a nearest neighbor pair of laser pulses within a range of directions for which the TOF difference is greater than a TOF threshold, dynamically steering the LIDAR to generate one or more intervening laser pulses with directions based on at least one of the nearest neighbor pair directions. The method can continue until all nearest neighbor pairs for which the TOF difference is greater than a TOF threshold have an angular separation (i.e., difference in directions for the laser pulses in each pair) less than a direction threshold (e.g., less than 0.5 degrees direction difference). In this way a PBL method can localize the boundary by refining the angular ranges in which large changes in TOF occur until such ranges are sufficiently small.

In third group of embodiments a method to perform extrapolation-based progressive boundary localization method (EPBL) with a LIDAR is disclosed. The method can use a LIDAR to find a first portion of a boundary in the FOV, extrapolate the direction of the boundary and thereby dynamically steer the LIDAR to scan in a second region of the FOV for the boundary.

Hence the continuous and “straight-line” nature of object boundaries can be used to dynamically steer a LIDAR to scan the boundary. Similarly a classified object (e.g., a Van) can have a predicted boundary such that finding one part of the object and extrapolating or predicting a second portion of the object boundary (e.g., based on classification or a straight line edge in an identified direction) is used to dynamically steer a LIDAR scan. In one example, a LIDAR scans a first search region within a FOV, identifies a first set of locations or sub-regions of the first search regions that located on or intersected by a TOF boundary (e.g., an object edge). The exemplary EPBL method then extrapolates an estimated boundary location, outside the first search region, based on the first set of locations or sub-regions. The LIDAR then uses the estimated boundary location to configure or dynamically steer a laser within a second search region. The LIDAR can then process reflections form the second search region to determine if the boundary exists in the estimated boundary location.

Within examples, devices, systems and methods for controlling laser power or intensity in various regions of the FOV of a laser range finder are provided. In one example, a method generates high-intensity laser pulses (e.g. above an eye-safe intensity threshold) in a well-defined adaptive-intensity region of a FOV of a laser range finder. The method surrounds the adaptive-intensity region with a protective guard-region of the FOV (e.g. a guard-ring) of lower intensity (e.g. eye-safe intensity) laser pulses. A detector can detect laser reflections from the lower intensity laser pulses in the guard region and in response to sensing an object in the guard region, or entering the guard region within a threshold distance the laser range finder can subsequently reduce the intensity of laser pulses (e.g. to an eye safe intensity) within the adaptive-intensity region. The guard region can act as a safety feature, using low-intensity laser pulses to provide early and spatially accurate warning of objects likely to intersect the path of the high-intensity laser pulses thereby enabling intensity reduction.

In another example, a non-transitory computer readable storage medium having stored therein instructions that when executed by a computer device, cause the computing device to perform functions. The functions comprise dynamically steering with a steerable laser assembly at least one laser beam and thereby generating a first set of laser pulses in an adaptive-intensity region of a FOV, each with an intensity above a threshold intensity, and a second set of laser pulses in a guard region of the FOV, each with an intensity below the threshold intensity. The functions further comprise directing, based on the dynamic steering of the laser beam, the second set of laser pulses such that the guard-region adjoins or encloses at least some of the perimeter of the adaptive-intensity region. The functions can position the guard region such that a plurality of straight line paths in the plane of the FOV that enter the FOV from an edge and intersect the adaptive-intensity region, must first traverse the guard-region, thereby providing forewarning of objects (e.g. pedestrians) likely to enter the adaptive-intensity region. The functions also comprise detecting with detector a set of laser reflections corresponding to the second set of laser pulses. The function also comprise, in response to sensing a first object in the guard region, based at least in part on the set of laser reflections, generating a third set of laser pulses in the adaptive-intensity region each with an intensity below the threshold intensity.

The guard region can serve to detect objects approaching the adaptive-intensity region of the FOV and trigger the laser range finder to reduce the intensity upon detection of an object in the guard region. In one aspect, the laser pulses in the adaptive-intensity region of the FOV can be attenuated (e.g. generated at an eye-safe intensity) in response to detecting and object in the guard-region. In another aspect, a safety test can be evaluated on objects in the guard region (e.g. a criterion that determines whether an object is on a trajectory that will soon intersect the adaptive-intensity region) and the intensity of laser pulses in the adaptive-intensity region can be based on the result of the safety test. Therefore, in one embodiment the present disclosure provides a benefit over systems that discontinue or attenuate laser power in a region when an object is sensed in that region, by instead using a trajectory measured in a defined guard region to control intensity in an adaptive-intensity region. The guard region can be adjoining the adaptive-intensity region and the measured trajectory of an object can indicate imminent intrusion into the adaptive-intensity region.

In another aspect, some of the laser reflections in the guard region can come from known sources (e.g. trees or a portion of a vehicle that is always in the FOV). In one embodiment a method can define one or more mask regions of the FOV whereby reflections from objects in the mask regions are discounted in the process of evaluating a safety test on reflections from the guard region of the FOV in the process of determining the intensity of future laser pulses in the adaptive-intensity region of the FOV.

In a related group of embodiments a laser range finder can receive location estimates for a set of objects in a FOV. The laser range finder can obtain an age associated with each location estimate (e.g. the time elapsed since laser reflections associated with an object location estimate). The laser range finder can determine an object region (e.g. a portion of the FOV or a volume of space) associated with the object at a later time, based at least in part on the age of the location estimate and the position of the location estimate. The laser range finder can generate one or more laser pulses with intensities based on the object regions for the objects. For example, an object in the guard region of the FOV (e.g. a pedestrian) and moving towards the adaptive-intensity region at a slow rate of speed can cause the laser range finder to reduce intensity in the adaptive-intensity region. Conversely, a slow moving pedestrian some distance away (e.g. 100 m) may generate a much smaller object region in the FOV (e.g. angular region at some later time) and thereby not pose an imminent threat of entering or intersecting the path of high intensity laser pulses in an adaptive-intensity region of the FOV. In this case, the laser range finder can generate high-intensity laser pulses, based on the location estimate and the estimate age (e.g. the estimate is 0.5 seconds old).

In one embodiment an imaging system (e.g., a LIDAR or camera) contains a micromirror array that is configured in response to sensor data to dynamically enhance a complex shape region of interest in a field of view (FOV). The micromirror array functions as like an electronically controllable transfer function for light, between an input FOV and a detector array, thereby providing dynamically defined resolution across the detector array. Data from various configurations of the micromirror array is then combined in a 2D or 3D output image. In one aspect the imaging system begins with a first uniform resolution at the detector array and subsequently reconfigures the micromirror array to enhance resolution at a first portion of the detector array (e.g., spread an interesting object across more pixels) reduce resolution from in a less interesting part of a scene and thereby sample all of the original FOV with anisotropic resolution.

In one embodiment a LIDAR generates high-intensity laser pulses with intensities above a threshold intensity (e.g. above an eye-safe intensity) in a 2-D angular range in a field of view. The LIDAR further generates low-intensity (e.g. eye-safe) laser pulses in a protective guard region (e.g. a guard ring) that surrounds the high-intensity laser pulses. In response to detecting an aspect of an object using reflections from the low-intensity laser pulses (e.g. a person on a trajectory that will intersect the high-intensity laser pulses) the LIDAR modifies the angular range of subsequent high intensity laser pulses. In this way the LIDAR can adapt or steer the angular range of the high-intensity laser pulses to avoid an object detected within the low-intensity guard region.

### ADVANTAGES

The techniques described in this specification can be implemented to achieve the following exemplary advantages:

An imaging system with feedback-based micromirror configuration can increasing resolution in regions of interest, decrease resolution elsewhere in a FOV and improve image quality while maintaining the original FOV.

In a related advantage a first configuration of the micromirror array can uniformly spread the incoming FOV from a lens across a detector array. The array can generate first sensor data. A second configuration of the micromirror array can reconfigure a complex shaped plurality of the micromirrors to increase resolution in regions on interest and thereby generate second sensor data. Processing circuitry can use knowledge of the first and second configurations to combine the first and second data to generate a single image. The single image can comprise enhanced resolution in the regions of interest (e.g., at time of flight or color boundaries, around objects, faces, or intensity boundaries) from the second sensor data and background non-enhanced portions from the first sensor data. The micromirror mirror array can be reconfigured faster than a traditional zoom lens, thereby reducing motion distortion when combining first and second data.

In another advantage several embodiments provide for dynamically identifying a complex shaped region of interest (e.g., surrounding a vehicle) that can then be used to reconfigure a corresponding complex shaped subset of micromirrors. A complex shape region of interest can be a complex shape subset of a FOV and can include simple and complex curves or multiple sides (e.g., 5 or more distinct sides).

In another advantage various computer processing techniques can be used to identify regions of interest such as object classification, boundary detection, boundary extrapolation (e.g., predicting a location of some or all of a boundary), iterative boundary localization, facial recognition, location classification (e.g., urban, rural, or indoor). Computer processing techniques used to identify regions of interest from sensor data can use sensor fusion (e.g., combining multiple types of data), can prioritize or score regions of interest. In a related advantage computer processing can generate a profile or range of resolutions by reconfiguring a plurality of micromirrors. For example a region of interest can cause a subset of micromirrors to generate a resolution of 10 detector elements per square degree at the center of a region of interest in the FOV. The circuitry can further reconfigure a second subset of the micromirrors to generate lower resolution of 5 detector elements per square degree at the detector array for a portion of the region of interest surrounding the center of the region of interest.

In another advantage micromirror array can be iteratively reconfigured to progressively enhance resolution based on sensor data gathered from a previous iteration. Hence a micromirror array in a LIDAR could iteratively select regions of interest in which time of flight discrepancies indicate depth or range differences. After each iteration the detector array can generate sensor data indicating subsets of the previous regions of interest in which boundaries still require localization, thereby forming new regions of interest.

In another advantage, data-drive reconfiguration of the micromirror array enables a smaller photodetector array to perform like a more expensive, larger detector array. For example, consider an imaging system with a 100×100 degree FOV sensed with a 200×200 pixel or element photodetector array. The total angular area of the FOV is 100×100 or 10,000 square degrees. The total number of photodetector elements is 40000 and the average angular resolution is 4 pixels per square degree. An embodiment of the present disclosure can identify a region of interest with a complex shape (e.g., a hexagonal 2D shape with area of 100 square degrees in the FOV). The imaging system can then configure a micromirror array to increase the resolution to 100 pixels per square degree for a region of interest (e.g., equivalent to the average resolution of a 1000×1000 element photodetector). The imaging system can reduce the resolution to 3 pixels per square degree in the remainder of the FOV outside the region of interest, so as to sample the entire FOV. In this way the imaging system can sample the same 100×100 FOV while acting like a more expensive 1000×1000 element photodetector array in the region of interest.

In a related advantage the imaging system of the previous example can generate a smaller set of sensor data using anisotropic resolution and only increasing resolution in selected region(s) of interest.

Instead of generating a uniform laser pulse density throughout the FOV, the disclosed techniques provide for non-uniform laser pulse density by dynamically steering a laser based on data indicating the location of important features in the FOV (e.g., boundaries of an object, a person recognized in digital image). This data-driven non-uniform laser pulse spacing has the further benefit of further localizing the important features.

In another advantage the boundaries of objects in the FOV can be progressively localized by refining laser steering parameters in regions of the FOV. The disclosed techniques can improve speed detection for objects in the FOV. The accuracy of speed detection in a laser range finding scan is related to the ability to accurately determine the object boundary during each scan. The disclosed techniques can estimate the boundary location and dynamically steer the laser to investigate the boundary location.

The disclosed techniques enhance the speed of object classification, using boundary localization and dynamic laser pulse density selection.

With the advent of solid-state laser range finders with low azimuthal range (e.g. 90-120 degrees) the danger of high-intensity laser pulses is often confined to a threshold distance in a narrow range of angles. Aspects of the present disclosure provide improved accuracy and timeliness of detecting future intrusion into the path of high-intensity laser pulses. The disclosed laser range finder can improve laser safety by using eye-safe intensity guard pulses in dedicated strategically placed guard regions of a FOV to trigger intensity reduction in neighboring adaptive-intensity regions before an object has a chance to reach the adaptive-intensity region. In another advantage the disclosed systems can use low intensity laser pulses to discover objects, thereby maintaining compliance with safety requirements.

In a related area, a laser range finder can use machine learning to discover common intrusion paths into high intensity laser beams and can subsequently generate guard regions around these path, thereby making the high-intensity laser pulses contingent on analysis of common intrusion paths. In another advantage, the disclosed laser range finder can dynamically steer a laser beam to monitor guard regions first during a scan of the FOV before subsequently generating high intensity laser pulses.

Previous high-intensity laser systems must react quickly to objects to avoid damage caused by the laser intensity. The disclosed laser range finder provides increased reaction time using lower-intensity laser pulses to determine if an object is likely to intersect with high-intensity laser pulses, thereby reducing the number of false positive intensity reductions in the adaptive-intensity regions.

Embodiments of the present disclosure provide the further advantage of enabling analysis of the trajectory of objects in the guard region using lower intensity (e.g. eye-safe) laser pulses. In a related advantage the number of false positive intensity reductions is further reduced by using trajectory determination of objects in the guard region. In one embodiment, the trajectory of an object in the guard region can be safely measured using lower-intensity laser pulses and used to determine the intensity of laser pulses in the adaptive-intensity region. This is advantageous because as an autonomous vehicle with a laser range finder moves down an urban street the majority of pedestrians (e.g. on a sidewalk) enter the FOV at a far distance in the center of the FOV and proceed to move away to the edge as they approach the vehicle. This effect is similar to how stars in science fiction movies (e.g. Start Trek) or stars in video games (e.g. Galaga by NAMCO Inc.) tend to move from the center of the FOV to the sides due to the motion of the observing platform (e.g. the space ship). For this reason, as an autonomous vehicle moves the majority of pedestrians appear to move along a path from the middle of the FOV at far distances (e.g. 100 m) to the edge as they approach the autonomous vehicle. The disclosed embodiments provide a greater reaction time to determine if objects are moving in a typical manner and react accordingly.

In a related advantage, several embodiments provide for adapting the size, intensity and location of guard regions to adapt to different driving conditions. For example, a vehicle stopped at a crosswalk can implement wide guard regions with very low intensity, since the primary danger is a person walking in front of the vehicle. At high speeds guard regions can be narrowed and extended in range to protect people as the vehicle turn.

### BRIEF DESCRIPTION OF THE DRAWINGS

FIGS. 1A and 1B are exemplary diagrams of a laser range finder and a plurality of laser pulse locations in a field of view, according to an embodiment of the present disclosure.

FIG. 2A illustrates a uniformly steered rotating LIDAR generating a sequence of laser pulses in a field of view.

FIGS. 2B, 2C, 2D and 2F illustrate dynamically steered LIDARs generating a variety of non-uniformly distributed sequences of laser pulses, according to embodiments of the present disclosure.

FIG. 3 illustrates several components of a solid state laser range finder, according to an embodiment of the present disclosure.

FIGS. 4A and 4B are functional diagrams illustrating several components of an exemplary dynamically steerable laser range finder in accordance with an embodiment of the present disclosure.

FIG. 5A illustrates an exemplary laser range finding system including a processing subassembly and a steerable laser assembly connected by a communication link, according to an embodiment of the present disclosure.

FIGS. 5B and 5C illustrate exemplary laser steering parameters according to an aspect of the technology.

FIG. 6 illustrates several aspects of a progressive boundary localization method.

FIGS. 7A and 7B illustrate several aspects of a progressive boundary localization method.

FIG. 8 illustrates several aspects of a progressive boundary localization method.

FIG. 9 illustrates several aspects of a progressive boundary localization method.

FIGS. 10A, 10B, 10C, 10D and 10F illustrate several aspects of a progressive boundary localization method.

FIG. 11 illustrates several aspects of an extrapolation-based progressive boundary localization method.

FIG. 12 illustrates several aspects of an extrapolation-based progressive boundary localization method.

FIG. 13 illustrates a micromirror array multiplexor operable to multiplex laser reflections from a plurality of fiber optic image bundles onto a remote photodetector array, according to an embodiment of the present disclosure.

FIG. 14A illustrates a micromirror array operable to focus portions of a FOV onto a detector array according to an embodiment of the present disclosure.

FIG. 14B illustrates a micromirror array operable to focus portions of a FOV onto a detector array according to an embodiment of the present disclosure.

FIG. 15 illustrates several components of a LIDAR with a dynamically configured micromirror array in accordance with an embodiment of the present disclosure.

FIG. 16 illustrates several components of a micromirror array system operable to perform feedback based resolution enhancement in accordance with an embodiment of the present disclosure.

FIGS. 17A and 17B illustrate several components of a micromirror array system operable to perform feedback based resolution enhancement in accordance with an embodiment of the present disclosure.

FIG. 18 illustrates several components of a micromirror array system operable to perform feedback based resolution enhancement in accordance with an embodiment of the present disclosure.

FIG. 19 illustrates several components to provide direction feedback control of an electronically steered LIDAR, in accordance with an embodiment of the present disclosure.

FIG. 20 illustrates several components of an electronically steed LIDAR with a selective light modulator, in accordance with an embodiment of the present disclosure.

FIG. 21 illustrates a remote LIDAR transmitting data to a vehicle based laser range finding system in accordance with an embodiment of the present disclosure.

FIGS. 22A and 22B illustrate several aspects of a system to improve aerodynamic efficiency of a drafting vehicle.

FIGS. 23A, 23B and 23C illustrate exemplary laser range finders according to embodiments of the present disclosure.

FIG. 24A is an exemplary conceptual illustration of a system for generating high-intensity laser pulses surrounded and controlled by aspects of guarding laser pulses according to an embodiment of the present disclosure.

FIG. 24B is an exemplary bistatic laser range finder system for generating high-intensity laser pulses surrounded and controlled by aspects of guarding laser pulses according to an embodiment of the present disclosure.

FIGS. 25A, 25B and 25C illustrate exemplary fields of view for a laser range finder including an adaptive-intensity region and guard regions of the fields of view, according to several embodiments of the present disclosure.

FIGS. 26A and 26B are exemplary conceptual illustrations of controlling the operation of a laser device according to an embodiment of the present disclosure.

FIGS. 27A and 27B illustrate exemplary fields of view for a laser range finder and illustrate the operation of an embodiment of the present disclosure.

FIGS. 28A, 28B, 28C, 28D, 28E and 28F illustrate exemplary zones of high-intensity laser pulses and guard laser pulses based on the speed of a vehicle, in accordance with an embodiment of the present disclosure.

FIG. 29 illustrates a field of view of a laser range finder according to an embodiment of the present disclosure.

FIGS. 30A and 30B illustrate flow diagrams of methods for generating a plurality of laser pulses in an adaptive-intensity region of a field of view with intensities based at least in part on aspects of guard laser pulses from a guard region of the field of view, in accordance with an embodiment of the present disclosure.

FIGS. 31A and 31B are example conceptual illustrations of controlling the operation of a laser device on a vehicle.

FIG. 32 illustrates a flow diagram of methods for generating a plurality of laser pulses with adaptive intensity based on aspects of a set of objects in the vicinity of a laser range finder.

FIG. 33 illustrates a flow diagram of methods for generating a plurality of laser pulses with adaptive intensity based on aspects of a set of objects in the vicinity of a laser range finder.

### DETAILED DESCRIPTION

In digital photography light from is received at a sensor form many points in the local environment at once. In contrast, a laser range finder can use a relatively small number of lasers (e.g., 1-64) to generate laser pulses aimed sequentially at a number of points (e.g., 100,000) to perform laser ranging scans of the FOV. Hence, the laser pulses (e.g., and corresponding time of flight measurements in discrete directions) represent a scarce resource and the FOV is often undersampled with respect to sensing detailed boundaries of objects in the local environment.

Many LIDARs mechanically rotate with a constant or nearly constant angular velocity. Such rotating LIDARs can sweep one or more lasers through a deterministic range of directions (e.g., each laser sweeping through a 360 degree azimuthal range at a fixed elevation angle). This type of operation does not constitute dynamically steering the laser(s) in a LIDAR. The angular momentum of the spinning portion in a mechanical LIDAR prevents rapid changes in angular velocity. Each laser in a mechanical LIDAR can generate a uniformly spaced sequence of laser pulses in a 1-D angular range. The angular velocity can be selected for many mechanical LIDAR (e.g., 5-20 Hz for the HDL-64E from Velodyne Inc. or Morgan Hill, CA), but remains constant from one rotation to the next.

A uniform scan of the entire FOV is simple and somewhat inherent in rotating LIDARS, but is sub-optimal for gathering the most information from the FOV. For example, large sections of the FOV (e.g., Walls and roads) can return a predictable, time invariant, homogeneous response. A modern LIDAR can scan over 2 million points per second. Hence one embodiment of the present technology tries to select the 2 million scan points with the most information (e.g., edges or boundaries) by steering the laser in a dynamic manner.

Recently, advancements in electronically-steerable lasers and phased array laser beam forming have made it possible to dynamically steer a laser within a FOV. A steerable laser can be mechanically-steerable (e.g., containing moving parts to redirect the laser) or electronically-steerable (e.g., containing an optical phased array to form a beam at in one of many directions). For the purpose of this disclosure a steerable laser is a laser assembly (e.g., including positioning components) that can change the trajectory or power level of a laser beam. For the purpose of this disclosure a steerable laser is dynamically steerable if it can respond to inputs (e.g., user commands) and thereby dynamically change the power or trajectory of the laser beam in the course of a scan of the FOV. For the purpose of this disclosure dynamically steering a laser is the process of providing input data (e.g., instructions such as laser steering parameters) to a steerable laser that causes the laser to dynamically modulate the power or trajectory of the laser beam during a scan of the FOV. For example, a laser assembly that is designed to raster scan a FOV with a constant scan rate (e.g., 10 degrees per second) and pulse rate (e.g., 10 pulses per second) is not being dynamically steered. In another example, the previous laser assembly can be dynamically steered by providing input signals and circuitry that dynamically changes the angular velocity of the laser assembly to generate non-uniformly spaced laser pulses in the FOV, based on the input signals (e.g., thereby generating an image on a surface in the FOV). A trajectory change can be a direction change (i.e., a direction formed by a plurality of pulses) or a speed change (i.e., how fast the laser is progressing in a single direction across the FOV). For example, dynamically changing the angular speed across a FOV of a pulsed laser with a constant direction causes the inter-pulse spacing to increase or decrease thereby generating dynamically defined laser pulse density.

In the context of the present disclosure most rotating LIDAR do not comprise dynamically steerable lasers since neither the power nor the trajectory of the laser beam is dynamically controllable within a single scan. However a rotating or mechanical LIDAR can be dynamically steered. For example, by providing input data that causes the laser to dynamically vary the laser pulse rate within a scan of the FOV, since the net result is a system that can guide or steer the laser to produce a non-uniform density laser pulse pattern in particular parts of the FOV.

Recently, electronically scanned LIDAR such as the model S3 from Quanergy Inc. of Sunnyvale, CA have been developed. These solid-state electronically scanned LIDAR comprise no moving parts. The absence of angular momentum associated with moving parts enables dynamic steering of one or more lasers in electronically scanned solid-state LIDAR systems.

In many laser range finding systems the laser is periodically pulsed and the exact pulse location in the FOV cannot be controlled. Nevertheless such a periodic pulse laser can be used with the present disclosure to produce a complex shaped region of higher pulse density than the area surrounding the region by increasing the laser dwell time within the region. In this way a periodically pulsed laser will produce a greater density of pulses in the complex shaped region of a FOV. For the purpose of this disclosure a complex shaped region is a region having a complex-shaped perimeter such as a perimeter with more than four straight edges or a perimeter with one or more curved portions and two or more distinct radii of curvature. Exemplary complex-shaped regions are, a region with a pentagonal perimeter, a hexagonal perimeter an elliptical perimeter or a perimeter capturing the detailed outline of a car. Other laser range finding systems transmit a continuous laser signal, and ranging is carried out by modulating and detecting changes in the intensity of the laser light. In continuous laser beam systems time of flight is directly proportional to the phase difference between the received and transmitted laser signals.

In one aspect the dynamically steered laser range finder can be used to investigate a FOV for boundaries associated with objects. For example, a small shift in the position of the LIDAR laser may identify a large change in TOF associated with the edge of an object 100 ft away. In contrast RADAR has much greater beam divergence and hence a much wider spot size impacts the object (often many times the object size). Hence the reflections from beam scanned RADAR represent the reflections from many points on the object, thereby making beam steered RADAR useful for object detection but impractical for performing detailed boundary localization. Hence, due in part to the large beam divergence of RADAR beams, a small change in radar beam direction can provide little if any actionable information regarding the edges of an object. In contrast the spot size of the laser remains small relative to the boundary of many important objects (people, dogs, curbs). The present technology can enable the boundaries (e.g., edges) of objects to be dynamically determined by a process of iteratively refining the scan points for the electronically steered LIDAR. For example, the LIDAR can use a bisection algorithm approach to iteratively search for the boundary of a pedestrian in the FOV. The LIDAR could first receive an indication that point P1 in a point cloud has a TOF consistent with the pedestrian and can scan iteratively to the right and left of P1 with decreasing angular range (e.g., in a bisection approach) to estimate the exact location of the boundary between the pedestrian and the surrounding environment. In general, this technique can be used to dynamically configure a laser in a LIDAR to investigate changes in TOF within a point cloud to iteratively improve boundary definition.

Unlike digital cameras where light is received form many points at once, a laser range finder can rely on a relatively small number of laser beams (e.g. 1-64) aimed sequentially at a number of points (e.g. 100,000) during each scan of the FOV. Hence, the measurement density of laser ranging systems is often much lower than digital cameras. The laser pulses represent a scarce resource and the FOV is often undersampled with respect to sensing detailed boundaries or changes in topology. For example, a tree in the field of view could be scanned with 1000 points during a scan of the FOV and the same tree could occupy one million pixels in a digital camera image. For the purpose of this disclosure the FOV of a laser transmitter is the set of all directions in which the laser transmitter can emit a laser light. For the purpose of this the FOV of a detector (e.g. a photodetector) is the set of all directions along which the detector can detect light (e.g. a laser pulse). The FOV of a laser range finder is set of all directions in which the laser range finder can perform laser range finding (e.g. the set of all directions in which the laser range finder can both transmit and receive laser light). For the purpose of this disclosure a single scan of a FOV by a laser range finder is the process of performing laser ranging measurements in the largest substantially unique set of directions (e.g. the longest sequence of directions that does not repeat or cover a substantially similar portion of the FOV). In a simple example, a rotating laser range finder may scan the FOV by performing a 360 degree revolution. A raster scanning laser range finder may scan he FOV by performing 10 left to right sweeps of a FOV and changing the elevation angle of the a laser generator after each sweep to cover the entire FOV.

### Steerable Laser Assembly

LIDARs often provide laser ranging in a plurality of directions (e.g. a FOV) and thereby generate data for a 3D topology map of the surroundings. To accomplish this LIDAR can have a steerable laser assembly. For the purpose of this disclosure a steerable laser assembly is an assembly that scans one or more laser beam within a FOV. A steerable laser assembly can include a laser generator (e.g. a laser diode) and a laser positioner (e.g. a rotating scanning mirror) to position the laser beam in a variety of directions in during a scan of the FOV. The steerable laser assembly can be mechanically-steerable (e.g. containing moving parts to direct a laser beam) or electronically-steerable (e.g. containing an optical phased array to form a laser beam at in one of many directions).

Many LIDARs have a mechanically steerable laser assembly that rotates with a constant angular velocity and thereby scans the FOV with uniform measurement spacing (e.g. 1 laser pulse and 1 measurement for every 1 degree of the azimuthal FOV). The pattern of generated laser pulses is uniform and largely determined by the angular velocity of the rotating components. The angular velocity can be selected for many mechanical LIDAR (e.g. 5-20 Hz for the HDL-64E from Velodyne Inc. or Morgan Hill, Calif.), but remains constant (or nearly constant) from one rotation to the next. The uniform angular spacing of laser pulses within the FOV is simple and somewhat inherent in rotating LIDARs, but is sub-optimal for gathering the most information from the FOV. For example, large sections of the FOV can return a predictable, time-invariant, homogeneous response, such as reflections from walls or unoccupied sections of a highway.

### Dynamically Steerable Laser Assembly

In a mechanical LIDAR the inertia of the spinning components prevents rapid changes in the angular velocity that would be necessary to dynamically steer a laser beam to produce a complex non-uniform and dynamically defined patterns of laser pulses. Recently, advancements in electronically-steerable lasers and phased array laser beam forming have made it possible to dynamically steer a laser beam within a FOV. Electronically-scanned LIDAR are solid-state and comprise no moving parts (e.g. the model S3 from Quanergy Inc. of Sunnyvale, CA). In a solid state LIDAR, the absence of inertia associated with moving parts makes it possible to move a laser beam along a complex trajectory thereby producing a series of laser pulses with non-uniform spacing, density, and location in the FOV.

For the purpose of this disclosure, a dynamically steerable laser assemblies are a subset of steerable laser assemblies wherein the assembly can dynamically steer one or more laser beams by accepting inputs (e.g. user commands) and thereby dynamically change aspects of the laser beam such as beam power, spot size, intensity, pulse repetition frequency, beam divergence, scan rate or trajectory. A dynamically steerable laser assembly can change aspects of one or more laser beams several times during a scan of the FOV. For example, a differentiating aspect of many dynamically steerable laser assemblies over traditional laser assemblies is circuitry operable to process instructions while the laser beam scans the FOV and continually adjust the direction of a laser beam. This is similar to the dynamic manner in which a 3D printer dynamically rasters a polymer filament to print an arbitrary shaped object. A traditional mechanically steered LIDAR, with associated inertia, can only implement small changes in angular velocity during each scan (e.g. changing from 20 Hz to 20.5 Hz scan rate in the course of a single 360 degree rotation). In contrast, it can be appreciated that a dynamically steerable LIDAR can make several changes to aspects of the laser pulse pattern in the course of a single scan of the FOV (e.g. rapidly changing the trajectory of a laser beam by 90 degrees within 10 milliseconds or tracing the outline of a complex shape with many turns during a single scan).

For the purpose of this disclosure, dynamically steering a laser beam with a steerable laser assembly is a process of providing input data to the steerable laser assembly that causes the steerable laser assembly to dynamically modulate at least one aspect of the resulting laser pulse sequence during a scan of the FOV. Exemplary modulated aspects can include the beam or pulse power, spot-size, intensity, pulse repetition frequency (PRF), beam divergence, scan rate or trajectory of the laser beam. For example, a laser assembly that is designed to raster scan a FOV with a constant scan rate and pulse rate (e.g. PRF) is acting as a steerable laser assembly but is not being dynamically steered. The distinction is that such a laser assembly is not receiving input or acting on previous input and dynamically altering aspects of the beam pattern during the course of each scan of the FOV. However, the same steerable laser assembly could be dynamically steered by providing input signals that cause the steerable laser assembly to generate a variable laser power at locations in the FOV, based on the input signals (e.g. thereby generating an image on a surface in the FOV). A trajectory change can be a direction change (i.e. a direction formed by a plurality of pulses) or a speed or scan rate change (i.e. how fast the laser is progressing in a single direction across the FOV). For example, dynamically steering a steerable laser assembly can be dynamically changing the angular velocity, thereby causes the inter-pulse spacing to increase or decrease and generating a dynamically laser pulse density. In one aspect, dynamic steering can often be recognized as the process of implementing dynamic control of a laser pulse pattern during a scan of a FOV.

In the context of the present disclosure, many rotating LIDAR do comprise steerable laser assemblies, but these assemblies are not dynamically steerable since neither the power nor the trajectory of the laser beam is dynamically controllable within a single scan of the FOV.

However, a rotating or mechanical LIDAR could be dynamically steered, for example, by providing input data that causes the laser to dynamically vary the laser pulse rate within a scan of the FOV, since the net result is a system that can guide or steer the laser to produce a non-uniform density laser pulse pattern in particular parts of the FOV.

In many laser range finders the laser is periodically pulsed as the laser assembly moves along a trajectory and the exact location of each laser pulse in the FOV is controlled. Nevertheless such a periodically pulses laser generator can be used in a steerable laser assembly to produce a complex shaped region with greater than average spatial density pulse density, For example, by increasing the laser dwell time within the complex shaped region. In this way, a periodically pulsed laser generator (e.g. a laser diode) can produce a greater density of pulses in the complex shaped region. Other laser range finding systems transmit a continuous laser signal, and ranging is carried out by modulating and detecting changes in the intensity of the laser light. In a continuous laser beam systems the distance to a reflection location can be determined based on the phase difference between the received and transmitted laser signals.

In one aspect, a dynamically steered laser range finder can be used to mine the FOV for the boundaries. For example, a LIDAR can generate laser pulses with a 3 milliradian beam divergence, thereby resulting in a 2 cm by 2 cm laser spot size at a distance of 200 m. This small laser spot size enables the LIDAR to identify the boundaries of an object at 200 m. In many cases the resolution of objects at considerable range is limited by the number of pulses devoted to an object rather than the ability of each pulse to identify a boundary. Therefore, once a boundary is detected a dynamically steerable laser assembly could be dynamically steered to investigate and refine estimates of the boundary by devoting more pulses to the object. In contrast, RADAR has much greater beam divergence and hence a much wider spot size impacts the object (often many times the object size). Hence, the reflections from beam-steered RADAR represent the reflections from many points on the object, thereby making beam steered RADAR useful for object detection but impractical for detailed boundary determination or localization.

Hence, in a RADAR a small change in beam angle provides little if any actionable information regarding the edges of an object. In contrast the spot size of the laser remains small relative to the boundary of many important objects (people, dogs, curbs). The present technology enables the boundaries of such objects to be dynamically determined by a process of iteratively refining the scan points for the electronically steered LIDAR. For example, a LIDAR with dynamic steering could use a bisection algorithm approach to iteratively search for the boundary of a pedestrian in the FOV. The LIDAR could first process laser reflection data to identify that a 3D point P1 in the point cloud has a TOF consistent with the pedestrian and can subsequently scan iteratively to the right and left of P1 with decreasing angular range (e.g. in a bisection approach) to estimate the exact location of the boundary between the pedestrian and the surrounding environment. In general, this technique can be used to investigate changes in range (e.g. time of flight changes) within a point cloud to iteratively improve boundary definition or boundary location estimates.

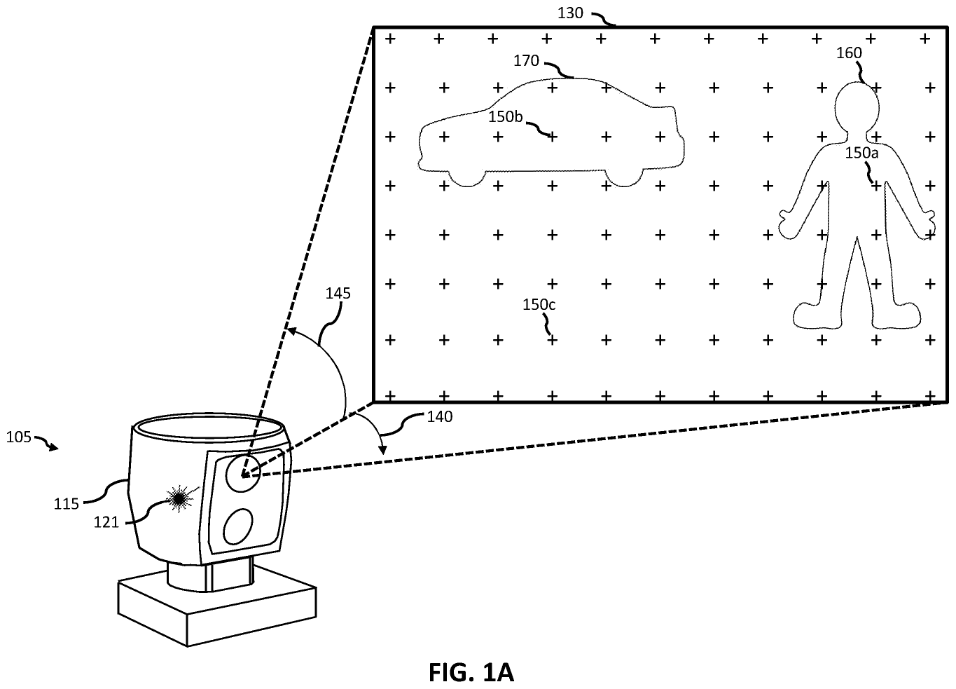

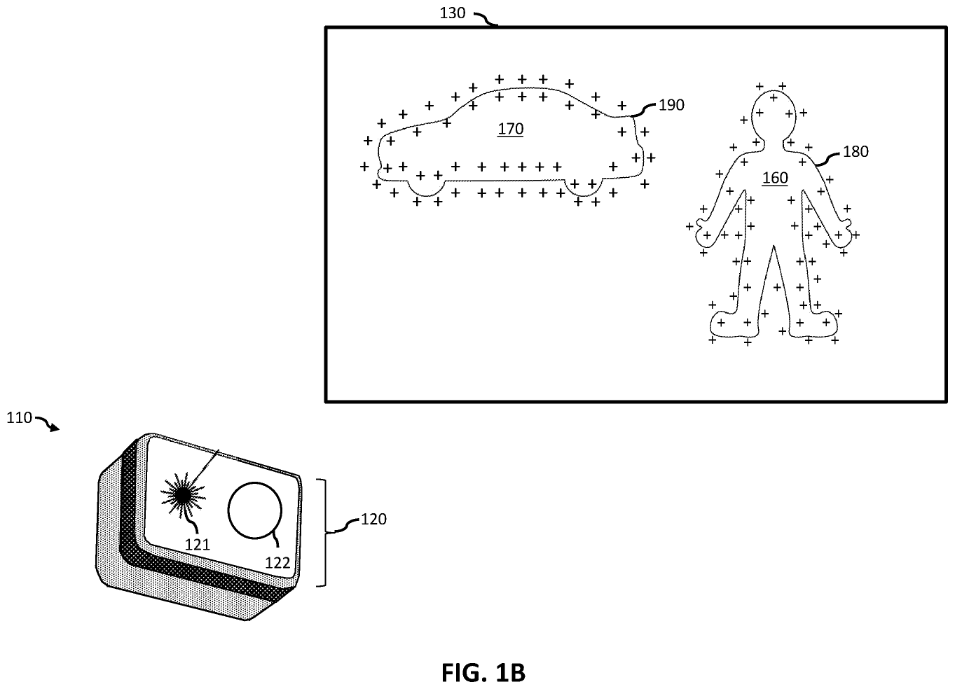

FIG. 1A illustrates a laser range finder system 105 (e.g., a LIDAR) that comprises a steerable laser assembly 115. Steerable laser assembly 115 scans one or more a lasers (e.g., steerable laser 121) within a field of view FOV 130. The field of view 130 can be defined by an azimuthal (e.g., horizontal) angular range 140 and an elevation (e.g., vertical) angular range 145. Steerable laser 121 scans FOV 130 and generates a plurality or sequence of laser pulses, (e.g., laser pulses 150a, 150b and 150c) in a sequence of directions. The direction in the FOV of the each of the plurality of laser pulses is illustrated with a “+” symbol. Some of the laser pulses (e.g., 150a and 150b) can be reflected by objects (e.g., person 160 and vehicle 170). In the embodiment of FIG. 1A the laser pulses are evenly spaced in the FOV, such that the angular separation between neighboring laser pulses is a constant value in one or both of the horizontal and vertical directions. Accordingly, only a few of the laser pulses (e.g., 5-6 pulses) reflect from each of the objects 160 and 170 due in part to the uniform laser pulse density throughout the FOV. For the purpose of this disclosure the FOV of laser range finder 110 can be defined as the set of all directions (e.g., combinations of elevation and azimuthal angles) in which the laser range finder can perform laser ranging measurements.

FIG. 1B illustrates a laser range finder 110, with a steerable laser assembly 120 that scans a steerable laser 121 in the same FOV 130 to generate approximately the same number of laser pulses. In the example of FIG. 1B the steerable laser is dynamically steered (instead of uniformly or non-dynamically steered) to generate a non-uniform high laser pulse density pattern surrounding the boundaries 180 and 190 or person 160 and vehicle 170 respectively. Steerable laser assembly 120 is an example of a dynamically-steerable laser assembly and can comprise circuitry to dynamically accept instructions (e.g., laser steering parameters) and configure laser 121 to rapidly change direction or pulse rate of a laser beam. Several embodiments of the present technology provide for using laser steering parameters to dynamically steer, guide, instruct or configure a steerable laser (e.g., an electronically steerable laser) to generate regions of increased laser pulse density or non-uniform pulse density. Laser range finder 110 can further comprise a laser detector 122 to detect reflections from laser pulses.

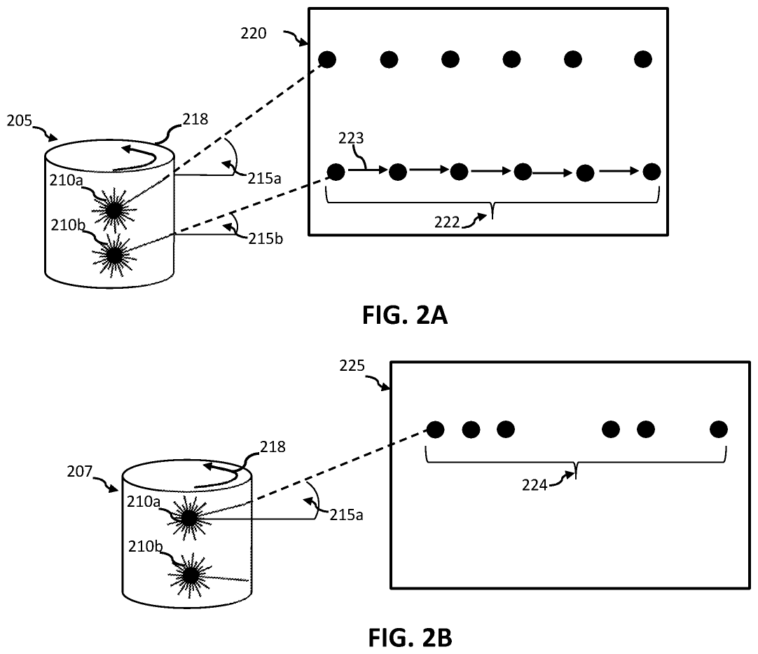

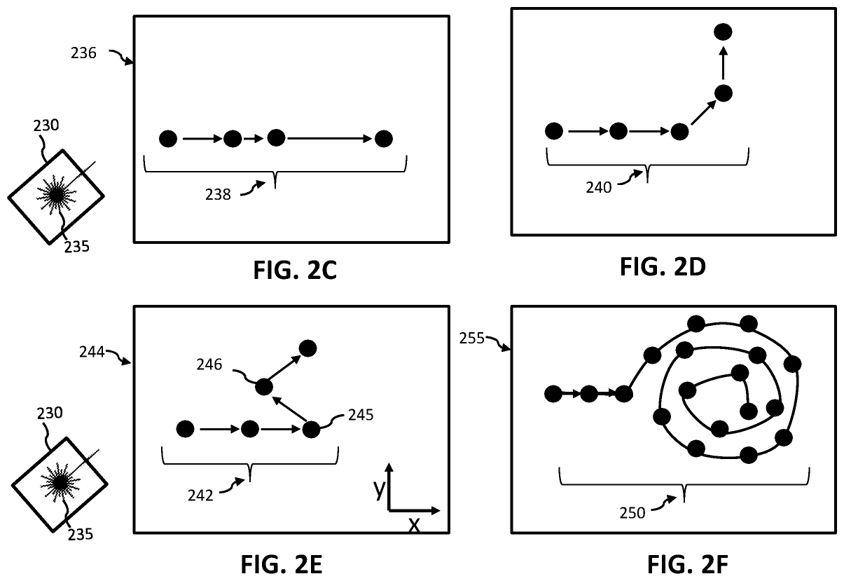

FIG. 2A illustrates some of the features and characteristics of a rotating LIDAR that is not dynamically steered (e.g., the HDL-64e from Velodyne Inc. of Morgan Hill, CA). Rotating LIDAR 205 has two lasers 210a and 210b each having a fixed corresponding elevation angle 215a and 215b. The lasers are mechanically rotated in azimuthal direction 218 (i.e., sweeps the azimuthal angle from 0 -360 degrees). Lasers 210a and 210b rotate at a constant angular velocity and have a constant pulse rate. Each laser thereby produces a corresponding uniformly spaced sequence of laser pulses (e.g., sequence 222) with a constant elevation angle. The lasers proceed across FOV 220 in a predictable manner with each laser pulse in a sequence having a direction that is separated from the immediately previous laser pulse by a constant angular separation in the azimuthal plane. In particular, the lasers are not reconfigured during each scan to dynamically vary either the angular velocity or the pulse rate. For example, each laser pulse in sequence 222 has a direction that can be can be uniquely defined in spherical coordinates by an elevation angle (sometimes called a polar angle) and an azimuthal angle. In the case of sequence 222 each laser pulse has a constant elevation angle 215b and uniformly spaced azimuthal angles. In the case of FIG. 2A the range of azimuthal angle separations from one laser pulse to the next (e.g., angular separation 223) is single value.

In contrast FIG. 2B illustrates a LIDAR 207 that is dynamically steered by modulating the pulse frequency of a laser while rotating the laser at a constant angular velocity. The result of configuring laser 210a to dynamically modulate the pulse frequency is a sequence of laser pulses 224 with directions in a 1-D range that are separated by varying amounts. In the case of FIG. 2B the direction separations from one laser pulse to the next (e.g., angular separation 223) have a 1-D range and hence LIDAR 207 is dynamically steered in a 1 dimension. The directions in sequence 224 span a 1-D range.

In FIG. 2C an electronically steered LIDAR 230 is dynamically steered by modulating the angular velocity of laser 235 while maintaining a constant pulse rate. The result of configuring the electronically steerable laser to dynamically modulate the angular velocity (or position of the laser in the FOV 236) is a sequence 238 of laser pulses with directions in a 1-dimensional range that are separated by varying amounts. FIG. 2C illustrates dynamically steering a laser including at least three different velocities in the course of a single sweep of the FOV including an initial nominal velocity followed by slowing down the laser trajectory to group pulses more closely and then followed by speeding up the laser to separate laser pulses by more than the nominal separation.

FIG. 2D illustrates dynamically steering a laser in 2 dimensions to generate a sequence of laser pulses that span a 2-D angular range. The resulting sequence has a 2-D angular range from a single laser, in contrast to a rotating LIDAR where each laser generates a sequence with a 1-dimensional angular range. A LIDAR can be configured to dynamically steer a laser to produce sequence 240 by dynamically controlling the angular velocity or position of the laser in 2 dimensions (e.g., both azimuthal and elevation). Such a sequence cannot be performed by a rotating LIDAR due in part to the angular momentum of the rotating components preventing fast modulation of the elevation angle above and below azimuthal plane.

FIG. 2E illustrates dynamically steering a laser to generate a sequence of laser pulses, including several direction reversal during the sequence. For example, laser pulse sequence 242 begins by progressing the laser from left to right across the FOV 244. After laser pulse 245 the laser is reconfigured to reverse the X component of the laser direction from the positive X direction to the negative X direction. After laser pulse 246 the laser is configured to reverse direction again (i.e., back to a positive X direction). In contrast to merely modulating the speed of laser 235 in the positive X direction, direction reversals enable a dynamically steered laser to scan back and forth across a discovered boundary. In addition 2-D dynamic steering combined with direction reversal in the course of a scan of FOV 244 enables laser 235 to dynamically scan along a complex shaped boundary of an object.

FIG. 2F illustrates dynamically steering a steerable laser (e.g., electronically steerable laser 235 in FIG. 2E) to generate a sequence of laser pulses 250 that generate a complex (e.g., spiral) shape. Complex sequence 250 is not possible with a LIDAR that is not dynamically steered (e.g., a LIDAR that that merely rotates around a single axis). One advantage of generating a complex shaped sequence with non-uniform spacing is the ability to arbitrarily determine the order in which portions of the FOV 255 are scanned. For example, sequence 250 may eventually scan a similar region with a similar density as a rotating LIDAR but has the advantage of scanning the outer perimeter first and then gradually progressing towards the center of FOV 255.

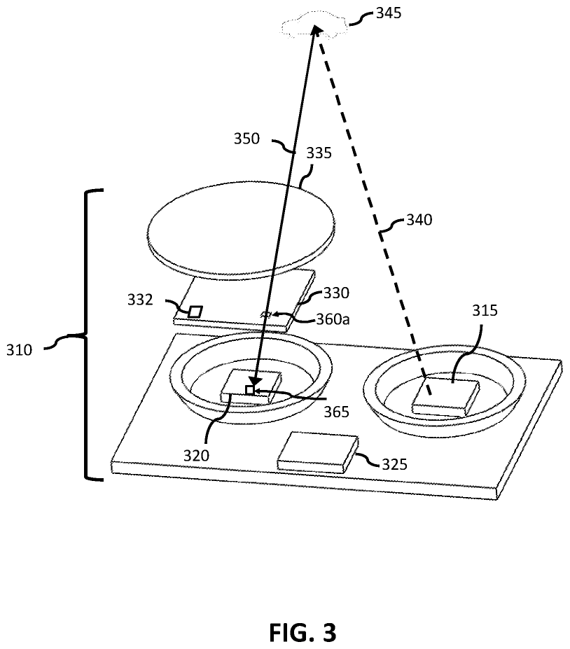

FIG. 3 illustrates some of the components of a solid-state laser range finder 310 operable to be dynamically steered. Laser range finder 310 can have a steerable laser transmitter 315, such as an optical phased array (OPA). Steerable laser transmitter 315 can comprise a laser generator to generate a set of laser pulses and a laser positioner to transmit the pulses in a set of directions in the field of view of the laser range finder. The laser positioner can comprise a laser splitter, a multimode interference coupler, an optical phase shifter (e.g., linear ohmic heating electrodes) or an out of plane optical coupler to combine the split, phase-shifted beams into an output laser beam pointed in a steerable direction. Laser range finder 310 has a light detector 320 (e.g., a PIN photodiode, avalanche photodiode, a focal plane array or CCD array). The light detector can function to detect reflections (e.g., 350) from the set of laser pulses (e.g., 340) when they interact with objects in the field of view (e.g., vehicle 345). Solid state laser range finder 310 can contain a lens 335 operable to focus laser reflections onto the detector 320. Laser range finder 310 can contain control circuitry 325. Control circuitry 325 can function to receive or generate laser steering parameters indicating how the steerable laser transmitter 315 should be steered (e.g., directions, paths, or regions to scan with the laser). Control circuitry 325 can further function to generate commands or signals to the steerable laser assembly 315 instructing the steerable laser assembly to generate a continuous or pulsed laser beam in a sequence of directions.

### Dynamically Steerable Laser Range Finder

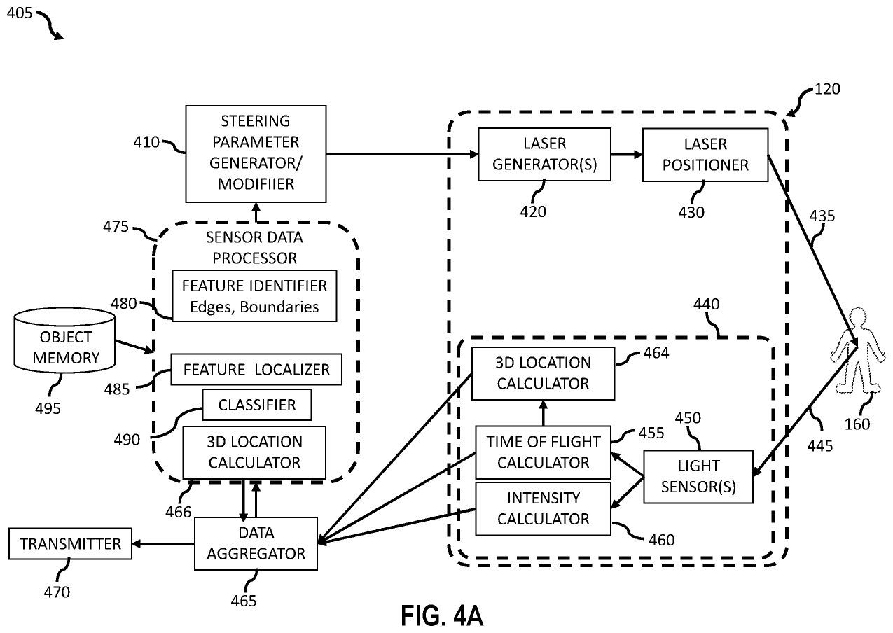

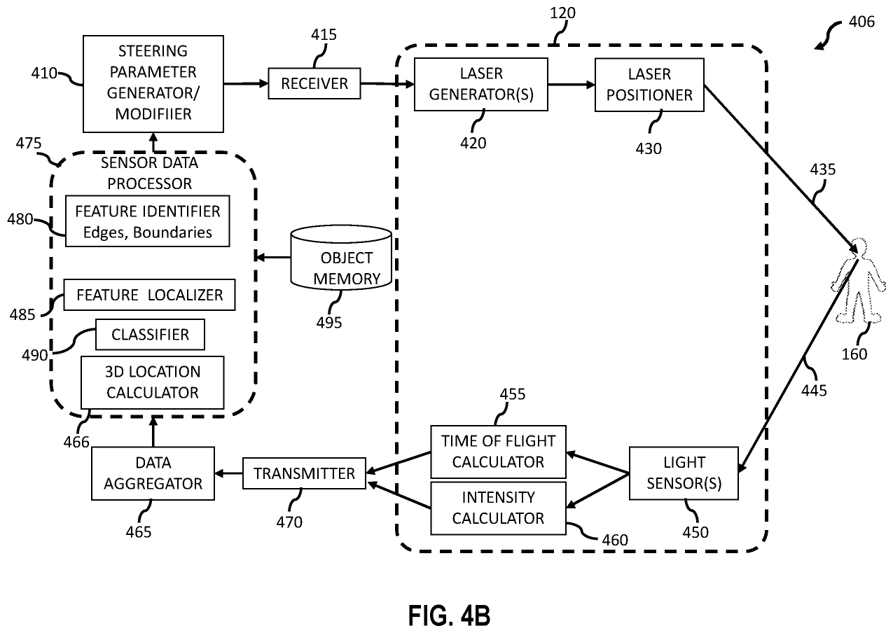

FIG. 4A illustrates several components of an exemplary laser range finder 405 operable to be dynamically steered in accordance with an embodiment of this disclosure. Laser range finder 405 can contain a steerable laser assembly 120 or a steerable laser transmitter (315 in FIG. 3) comprising a laser generator 420 and a laser positioner 430. Laser range finder 405 can contain a laser steering parameter generator 410 to generate laser steering parameters based on processed sensor data from sensor data processor 475. Laser steering parameter generator 200 can function to generate laser steering parameters (e.g., instructions) and transmit the parameters to the steerable laser assembly 120. Laser steering parameter generator 200 can transmit the parameters in a timed manner, such that upon receiving each laser steering parameter the steerable laser assembly 120 executes or reacts to the laser steering parameter. Alternatively, laser steering parameters can be transmitted in a batch or instruction file that is executed over a period of time by the steerable laser assembly 120.

Steerable laser assembly 120 can comprise one or more laser generators 420, a laser positioner 430, and one or more detectors 440. The one or more laser generators 420 can be laser diodes (to produce one or more laser beams (e.g., beam 435) at one or more locations in the FOV determined by the laser positioner 430. Laser positioner 430 functions to steer one or more laser beams (e.g., beam 435) in the FOV based on the laser steering parameters. Laser positioner 430 can mechanically steer a laser beam from laser generator 420. Rotating LIDARs often use a mechanically steered laser positioner. An exemplary mechanically steered laser positioner 430 can include mechanical means such as a stepper motor or an induction motor to move optical components relative to the one or more laser generators. The optical components in an exemplary mechanical laser positioner can include one or more mirrors, gimbals, prisms, lenses and diffraction grating. Acoustic and thermal means have also been used to control the position of the optical elements in the laser positioner 430 relative to the one or more laser generators 420. Laser positioner 430 can also be a solid state laser positioner, having no moving parts and instead steering an incoming laser beam using electronic means to steer the laser beam 435 in an output direction within the FOV. For example, an electronically steerable laser assembly can have a solid state laser positioner comprising a plurality of optical splitters (e.g., Y-branches, directional couplers, or multimode interference couplers) to split an incoming laser beam into multiple portions. The portions of the incoming laser beam can then be transmitted to a plurality of delay line where each portion is delayed by a selectable amount (e.g., delaying a portion by a fraction of a wavelength). Alternatively, the delay lines can provide wavelength tuning (e.g., selecting slightly different wavelengths from an incoming laser beam). The variable delayed portions of the incoming laser beam can be combined to form an output laser beam at an angle defined at least in part by the pattern of delays imparted by the plurality of delay lines. The actuation mechanism of the plurality of delay lines can be thermo-optic actuation, electro-optic actuation, electro-absorption actuation, magneto-optic actuation or liquid crystal actuation. Laser positioner 430 and one or more laser generators 420 can be combined onto a chip-scale optical scanning system such as DARPA's Short-range Wide-field-of-view extremely agile electronically steered Photonic Emitter (SWEEPER).

Detector 440 can contain light sensors 450 (e.g., photodiodes, avalanche photodiodes, PIN diodes or charge coupled devices CCDs), signal amplifiers (e.g., operational amplifiers or transconductance amplifiers), a time of flight calculator circuit 455 and an intensity calculator 460. Detector 440 can comprise one or more photodiodes, avalanche photodiode arrays, charge coupled device (CCD) arrays, single photon avalanche detectors (SPADs), streak cameras, amplifiers and lenses to focus and detect reflected laser light from laser beam 435. The construction of the steerable laser assembly 120 can co-locate detector 440 and laser positioner 430 such that detector 440 is pointed in the direction of the outgoing laser beam and can focus the detector on a narrow part of the FOV where the reflected light is anticipated to come from.

The steerable laser assembly 120 of laser range finder 405 can generate a pulsed or continuous laser beam 435. Steerable laser assembly 120 can receive one or more laser reflections 445 corresponding to laser beam 435. Laser range finder 405 can contain a light sensor 450 to detect reflected light from the laser pulses or continuous laser beam.

Steerable laser assembly 120 can contain a time of flight calculator 455 to calculate the time of flight associated with a laser pulse striking an object and returning. The time of flight calculator 455 can also function to compare the phase angle of the reflected laser beam with the phase of the corresponding outgoing laser beam and thereby estimate the time-of-flight. Time of flight calculator 455 can also contain an analog-to-digital converter to detect an analog signal resulting from reflected photons and convert it to a digital signal. Laser range finder 405 can contain an intensity calculator 460 to calculate the intensity of reflected light.

Laser range finder 405 can contain a data aggregator 465 to gather digitized data from time of flight calculator 455 and intensity calculator 460 or 3D location calculator 464. Data aggregator 465 can group data into packets for transmitter 470 or sensor data processor 475. Laser range finder 405 can contain a transmitter 470 to transmit data packets. Transmitter 470 can send the data to a processing subassembly (e.g., a computer or a remote located sensor data processor) for further analysis using a variety of wired or wireless protocols such as Ethernet, RS232 or 802.11.

Laser range finder 405 can contain a sensor data processor 475 to process sensor data and thereby identify features or classifications for some or all of the FOV. For example, data processor 475 can identify features in the FOV such as boundaries and edges of objects using feature identifier 480. Data processor 475 can use feature localizer 485 to determine a region in which the boundaries or edges lie. Similarly a classifier 490 can use patterns of sensor data to determine a classification for an object in the FOV. For example, classifier 490 can use a database of previous objects and characteristic features stored in object memory 495 to classify parts of the data from the reflected pulses as coming from vehicles, pedestrians or buildings. In the embodiment of FIG. 4A sensor data processor 475 is located close to the steerable laser assembly (e.g., in the same enclosure), thereby enabling processing of the sensor data (e.g., reflection ranges) without the need to transmit the reflection data over a wired or wireless link. FIG. 4A is an example of an embedded processing architecture where the latency associated with a long distance communication link (e.g., Ethernet) is avoided when transmitting range data to the sensor data processor.

FIG. 4B illustrates several components of a dynamically steered laser range finder system 406 in accordance with an embodiment of this disclosure. In this embodiment the data processing and laser steering parameter generation components are remotely located from the steerable laser assembly 120. Laser range finder 406 can contain a receiver 415 to receive laser steering parameters from the remotely located laser steering parameter generator 410. Receiver 415 can be a wired or wireless receiver and implement a variety of communication protocols such as Ethernet, RS232 or 802.11. Transmitter 470 can transmit data from the time of flight calculator 455 intensity calculators and 3D location calculator 464 (in FIG. 4A) to a remote located data aggregator 465.

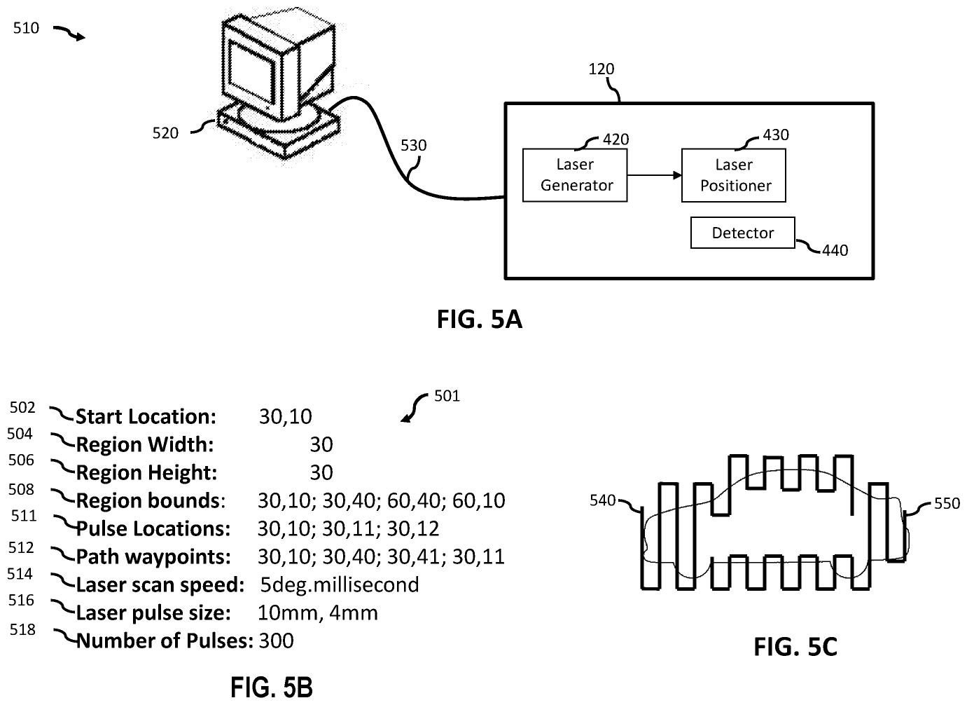

FIG. 5A illustrates several components of a laser range finder 510 according to several embodiment of the present disclosure. Laser range finder 510 can contain a processing subassembly 520, a steerable laser assembly subassembly 120 and a communication link 530 for linking the processing and steerable laser assemblies. Processing subassembly 520 can include one or more processors (e.g., sensor data processor 475 in FIGS. 4A and 4B) and one or more transceivers (e.g., a transceiver including receiver 415 and transmitter 470 in FIG. 4B) such as an Ethernet, RS485, fiber optic, Wi-Fi, Bluetooth, CANBUS or USB transceiver. Processing subassembly 520 can also include a computer-readable storage medium (e.g., flash memory or a hard disk drive) operable to store instructions for performing a method to detect and utilize a remote mirror (e.g., a roadside mirror). Steerable laser assembly 120 can include a laser generator 420 and a laser positioner 430 to steer a laser beam at one or more locations in the FOV based on the laser steering parameters. Laser positioner 430 can include one or more optical delay lines, acoustic or thermally based laser steering elements. In a solid state steerable laser assembly, laser positioner 430 can function to receive instructions (e.g., laser steering parameters) and thereby delay portions of a laser beam (i.e., create a phase difference between copies of the laser beam) and then combine the portions of the laser beam to form an output beam positioned in a direction in the FOV. A mechanical laser positioner 430 can be a mirror and mirror positioning components operable to receive input signals (e.g., PWM input to a steeper motor) based on laser steering parameters and thereby steer the mirror to position a laser in a direction in the FOV. Steerable laser subassembly 120 can also include a detector 440 comprising components such as light sensor(s) 450, time of flight calculator 455 and light intensity calculator 460 and 3D location calculator. Steerable laser subassembly 120 can include one or more transceivers (e.g., receivers 415 and transmitters 470 in FIG. 4B) such as Ethernet, RS485, fiber optic, Wi-Fi, Bluetooth, CANBUS, or USB transceivers. Communication link 530 can be a wired link (e.g., an Ethernet, USB or fiber optic cable) or a wireless link (e.g., a pair of Bluetooth transceivers). Communication link 530 can transfer laser steering parameters or equivalent instructions from the processing subassembly 520 to the steerable laser assembly 120. Communication link 530 can transfer ranging data from the steerable laser assembly to the processing subassembly 520.

When operable linked to steerable laser assembly 120 the processing subassembly 520 can perform one or more embodiments of the method to find, utilize and correct for a remote mirror in the FOV of laser range finder 510.

FIG. 5B illustrates exemplary laser steering parameters 501 according to aspects of the technology. Laser steering parameters can be instructions operable to steer a laser beam with a steerable laser assembly in a FOV or steer a controllable magnifier. For example, in an electronically scanned laser range finder (e.g., model S3 from Quanergy Inc. of Sunnyvale, CA) a set of laser steering parameters can define aspects of the output laser beam such as the direction, pulse duration, intensity and spot size. Laser steering parameters can function to instruct the laser generator 420 in FIG. 4A to define aspects such as laser spot size, intensity and pulse duration. Laser steering parameters can instruct laser positioner 430 in FIG. 4A how to delay portions of the laser beam and combine the delayed portions to define the direction of the output laser beam. A mechanically steered LIDAR can perform dynamic steering by using laser steering parameters to dynamically position the laser in the FOV or to dynamically position a mirror to reflect the laser beam in a desired direction. Laser steering parameters can be operable to instruct a steerable laser assembly to steer a laser beam and can be transmitted to the steerable laser assembly as a file. Alternatively laser steering parameters can be stored in a file and can be sequentially processed and used to generate electrical signals operable to generate and guide a laser beam. For example, laser steering parameters can be similar to the parts of a stereolithography (.STL) file. STL files are commonly used as instruction sets to position extruder heads and cutting heads in 3D printers, cutting tools and laser stereolithography. A set of laser steering parameters 501 can include a start location 502 indicating where one or more other laser steering parameters should be applied. Start location 502 can be a point in a Cartesian coordinate system with an associated unit of measure (e.g., 20 mm to the right and 20 mm above the lower right corner of the lower left corner of the field of view). In several laser range finders the FOV is described in terms of angular position relative to an origin in the FOV. For example, a starting point could be +30 degrees in the horizontal direction and +10 degrees in the vertical direction, thereby indicating a point in the FOV.

A laser steering parameter can be a region width 504 or a region height 506. The width and height can be expressed in degrees within the FOV. One exemplary set of laser steering parameters could include a start location, region width and region height thereby defining a four sided region in the FOV. Other laser steering parameters in the exemplary set of laser steering parameters can indicate how to tailor a scan within this region, such as laser scan speed 514, laser pulse size 516 or number of laser pulses 518.

A laser steering parameter can be one or more region boundaries 508 defining the bounds of a region. A laser steering parameter can be one or more laser pulse locations 511. Pulse locations 511 can provide instructions to a steerable laser to move to corresponding positions in the FOV and generate on or more laser pulses. In some embodiments the laser can be generating a laser beam while being steered from one location to another and can dwell for some time at the laser pulse locations. In other embodiments the steerable laser can use these points 511 to generate discrete pulses at defined locations. In such embodiments the laser beam can be generated at discrete pulse locations and can dwell at the pulse location for some time.

A laser steering parameter can be one or more path waypoints 512, which define points in a FOV where a steerable laser can traverse or points at which the steerable laser can implement direction changes. FIG. 5C illustrates two exemplary paths 540 and 550 that can be defined by path waypoints (e.g., waypoints 512) and used to instruct LIDAR 110. It would be obvious to a person of skill in the art that several laser steering parameters can produce equivalent or nearly equivalent regions of non-uniform pulse density. For example, selecting various combinations of laser steering parameters such as combinations of paths 540 and 550 to produce similar regions of increased or non-uniform laser pulse density.

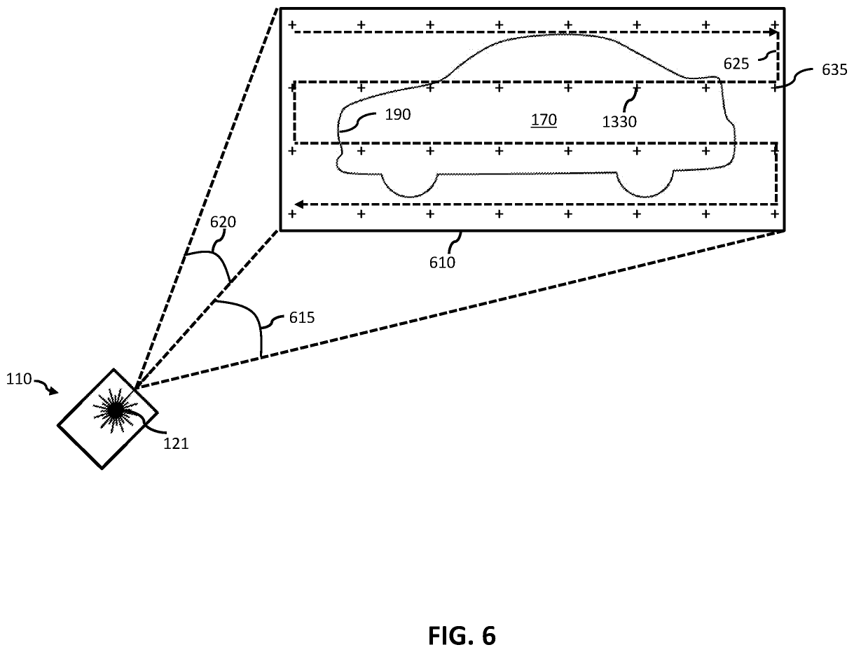

Turning to FIG. 6 in one embodiment of a PBL method a laser range finder 605 can comprise one or more a dynamically steerable lasers (e.g., laser 121) that can scan a FOV 610 comprising an azimuthal angular range 615 and an elevation angular range 620. The dynamically steerable laser 121 can receive and process a plurality of laser steering parameters to sweep a laser beam through a plurality of orientations, illustrated by path 625 in FOV 610. While sweep path 625 steerable laser 121 can generate a sequence or set of laser pulses each with a corresponding direction illustrated by “+” symbols in FIG. 6. Some of the laser pulses (e.g., pulse 630) can intersect with objects (e.g., vehicle 100, indicated by boundary 120). Other pulses (e.g., pulse 635) may not intersect with the vehicle.

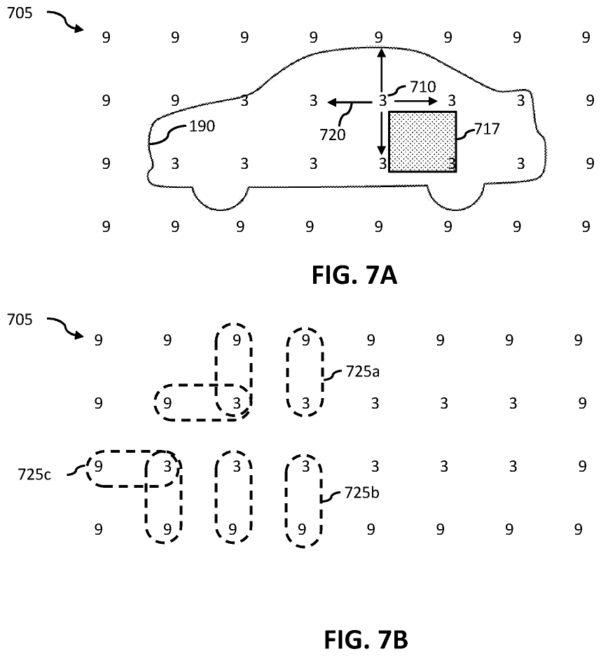

Turning to FIG. 7A, the laser range finder can receive a set of laser reflections corresponding to the sequence of laser pulses and can measure for each laser pulse in the sequence of laser pulses a corresponding direction and a corresponding time of flight (e.g., 100 nS) or range (e.g., 30 m). The set of TOFs and set of directions corresponding to the sequence of laser pulses is illustrated as data matrix 705. Data matrix 705 can also be stored as a list of directions and corresponding TOFs for each laser pulse in the sequence of laser pulses. For the purpose of illustration laser reflections from vehicle 100 have a TOF of 3 and laser reflections from outside the boundary 120 of vehicle 100 have a TOF of 9. A challenge is to identify the location of boundary 120 from data matrix 705. One approach is to identify nearest neighbors for each laser reflection and to identify if a TOF boundary lies between the nearest neighbor pairs. Each laser pulse (e.g., the laser pulse illustrated by data point 710) can have a plurality of nearest neighbors in a plurality of directions or a plurality of ranges of directions (e.g., direction 715 and 720).

Turning to FIG. 7B several pairs of laser pulses (e.g., pairs 724a-c) can be identified such that the difference in the TOF between laser pulses in each pair is greater than a threshold value. For example, pair 725a contains a first laser pulse within the vehicle perimeter with a TOF of 3 and a second laser pulse outside the vehicle perimeter with a TOF of 9. The difference in the TOF values can be greater than a TOF threshold of 5, thereby indicating the presence of a TOF boundary (e.g., the edge of a vehicle) in the angular range between the directions associated with each of the laser pulses in each pair.

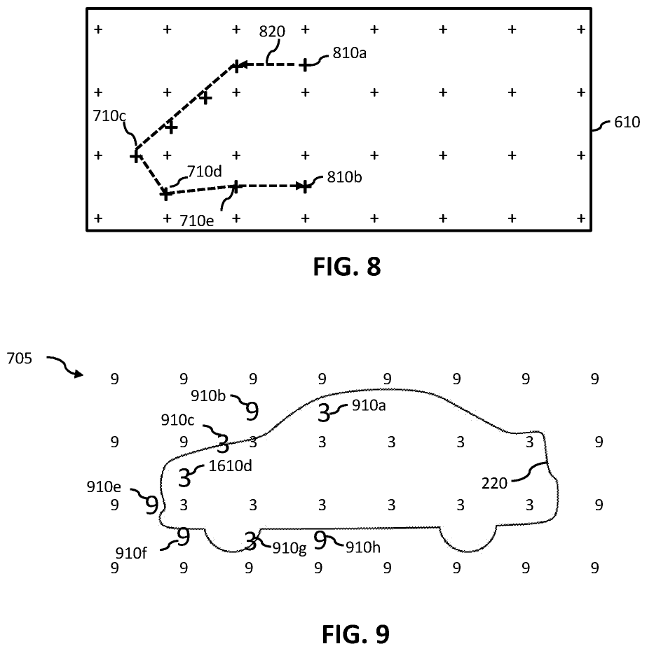

FIG. 8 illustrates the original FOV 610 and the original sequence of laser pulses. In response to identifying the pairs for which the TOF difference is greater than a threshold value (e.g., pairs 725a-c in FIG. 7B), one or more second laser steering parameters can be dynamically generated to steer the steerable laser along a path 820 that generates additional laser pulses in the intervening spaces corresponding to each of the pairs. For example, laser pulses 810a-b can be generated as the steerable laser moves along path 820. Path 820 can be a complex shape (e.g., roughly outlining the boundary 120 of vehicle 100). In one aspect, the second set of laser steering parameters to generate path 820 can vary two angular velocities simultaneously between neighboring laser pulses 810d and 810e. In another aspect, path 820 can cause the steerable laser to change direction from a negative azimuthal angular velocity before laser pulse 810c to a positive azimuthal angular velocity after laser pulse 810c. The PBL method enables the intervening laser pulses 810a-e to be located in parts of the FOV 610 estimated to contain an object boundary (i.e., that have TOF differences greater than the TOF threshold.

The direction of each of the intervening pulses 810a-e is indicated by the 2-D location in the FOV 610. The direction of intervening pulse 810a can be based one or more of the directions of the corresponding pair of laser pulses 725a. For example, path 820 can be designed to place pulse 810a midway between the laser pulses in pair 725a. Path 820 can place intervening pulses 810a-e at specified angular direction relative to one of the pulses in each of the pairs of laser pulses with TOF difference. For example, the first sequence of laser pulses produced by steering the LIDAR 605 along path 625 in FIG. 6 can have an angular spacing of 1 degree in elevation and 1 degree azimuthal. Intervening laser pulses 810a-e can be placed in a direction in the FOV 610 with a separation of 0.3-0.5 degrees from one of the laser pulse directions in the corresponding pairs of laser pulses. The intervening laser pulses 810a-e can be located a defined angular separation from a first pulse in a corresponding laser pulse pair and in a direction towards the second laser pulse in the pair, thereby ensuring that each intervening laser pulse destroys the nearest neighbor relationship of the corresponding laser pulse pair (e.g., 725a in FIG. 7B). In this way nearest neighbor pairs 725a-c with a TOF difference greater than a TOF threshold may no longer be nearest neighbor pairs when the intervening laser pulses are generated.

Intervening laser pulses (e.g., pulses 810a-b) can be added to the sequence of laser pulses. In one aspect intervening laser pulse 810a causes laser pulse pair 725a in FIG. 7B to no longer be a nearest neighbor pair. Therefore, as intervening laser pulses are added to the sequence of laser pulses the nearest neighbor pairs can be modified by new intermediate laser pulses.

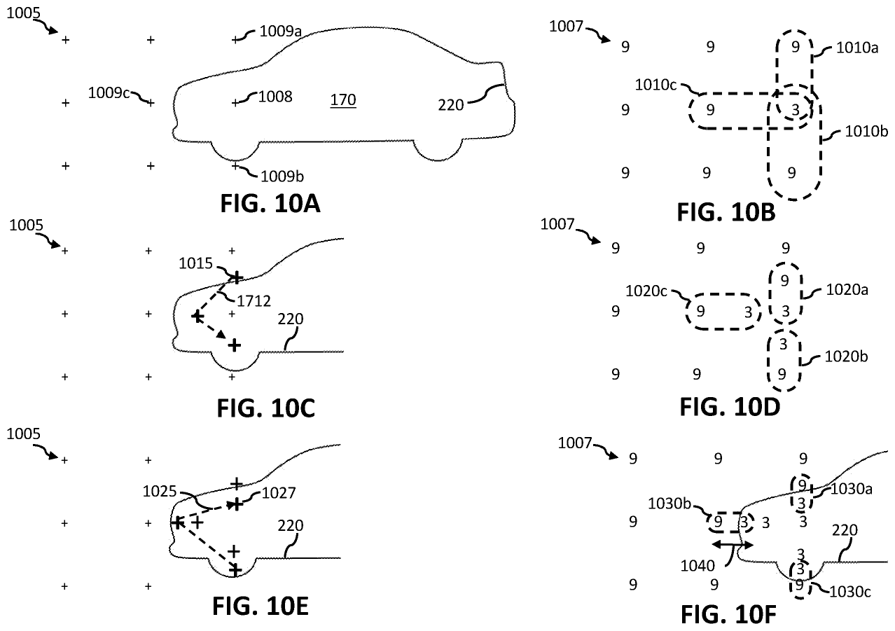

Turning to FIG. 9 the laser range finding system can calculate a TOF 910a-h for each of the intervening laser pulses. FIG. 10A-E illustrates an embodiment of a PBL method wherein a LIDAR scans a FOV and generates a sequence of range measurements that progressively localize time-of-flight boundaries. In the embodiment of FIG. 10A-E nearest neighbor pairs of laser pulses are identified in a sequence of laser pulses, such that the TOF difference between pulses in each nearest neighbor pair is greater than a TOF threshold and then iteratively adding intervening laser pulses with directions that destroy the nearest neighbor relationship of the corresponding laser pulse pairs. The LIDAR can dynamically steer and generate intervening laser pulses, thereby refining the location of the TOF boundary, until each nearest neighbor pair with a TOF difference greater than the TOF threshold are separated by less than a threshold distance (e.g., a direction difference less than 0.5 degrees).

In FIG. 10A, a laser range finding system can scan a 2-D (elevation, azimuthal) range of orientations while generating a sequence of laser pulses 1005. In FIG. 10B the laser range finder system can receive a sequence of laser reflections 1007 corresponding to the sequence of laser pulses 1005 and can measure or calculate a direction and TOF corresponding to each of the outgoing sequence of laser pulses. The laser range finder system can identify one or more of the sequence of laser pulses (e.g., pulse 1009 in FIG. 10A) for which the difference in TOF to a nearest neighbor pulse is greater than a threshold value. For example, the TOF difference between laser pulse 1008, within the vehicle 100 and nearest neighbor pulses 1009a-c outside the vehicle perimeter can be greater than a threshold (e.g., a TOF threshold of 5). FIG. 10B illustrates three pairs 1010a-c of laser reflections for which the TOF difference (i.e., the difference between a first TOF in the pair and a second TOF from the pair) is greater than a threshold.

In FIG. 10C the laser range finder system can generate a set of laser steering parameters and use these to guide the system along a path 1012 to generate intervening laser pulses e.g., 1015. The intervening laser pulses and path 1012 can have directions in the FOV based on one or more of the laser pulses in the pairs of laser pulses 1010a-c. In FIG. 10D time of flight data can be measured for the intervening laser pulses and they can be added to the sequence of laser pulses 1005. A TOF test can again be performed that identifies those nearest neighbor pairs of laser pulses for which the TOF difference is greater than a TOF threshold. The TOF threshold can be modified each time the TOF test is performed in order to localize iteratively smaller TOF differences. In FIG. 10D three new pairs of laser pulses 1020a-c are generated that fail the TOF test (i.e., have TOF differences greater than a TOF threshold). In one aspect of several embodiments the location of the intervening pulses can be seen to prevent the original laser pulse pairs 1010a-c from reoccurring during subsequent applications of the TOF test, thereby ensuring that the boundary (e.g., boundary 120 in FIG. 10A) is localized to a smaller area in successive iterations of the TOF test. In FIG. 10E the laser range finder system uses the identified pairs of laser pulses to generate a new path 1025 with more intervening laser pulses (e.g., 1027). FIG. 10F illustrates that the TOF test can be applied again to identify pairs of nearest neighbor laser pulses (1730a-c) between which the TOF boundary 120 lies. The TOF test can be applied until each pair of nearest neighbor pulses that fails the TOF test has an angular separation e.g., 1040 less than a threshold separation or distance (e.g., an angular separation between points in each pair of less than 0.5 degrees).

In several embodiments, a LIDAR can apply a boundary localization test to each point in an existing set of laser pulses with corresponding directions and TOF values. The localization test can define several angular ranges. Consider that laser reflection 710 in FIG. 7A can be located at 0 degrees elevation and 0 degrees azimuth. An angular range can be all negative elevation angles along direction 715. An exemplary 2-D angular range relative to point 710 can be elevation angles with a range 0-1 degree and azimuthal angles in a range 0-1 degree, thereby defining a box 717. The localization test can identify for each laser pulse whether there exists a nearest neighbor for each of the angular ranges for which the TOF difference is greater than a TOF threshold and for which the angular separation (e.g., the square root of the sum of the squares of the angular separations along each of the elevation and azimuthal axes) is greater than a threshold separation. When such a nearest neighbor exists the laser pulses in the sequence fails the localization test and the PBL method places an intervening laser pulses in the region between the laser pulses and the nearest neighbor and adds the intervening laser pulse to the sequence thereby destroying the nearest neighbor relationship between the laser pulses and the original nearest neighbor. In one aspect a PBL method, immediately after generating an intervening laser pulse a LIDAR can apply the localization test to the new intervening laser pulse. In this way a LIDAR can iteratively localize a TOF boundary, such that all pairs of laser pulses between which the TOF boundary lie are separated by no more than a threshold angular separation.

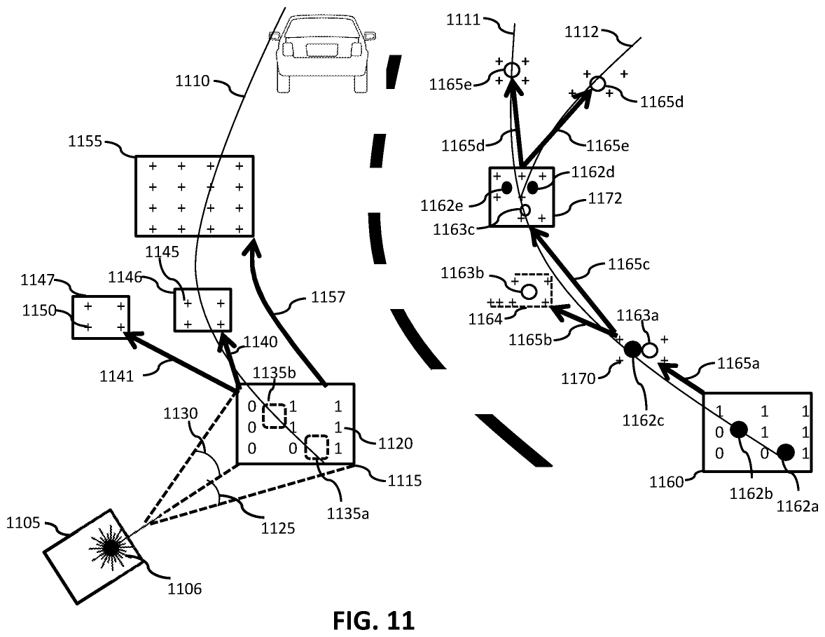

FIG. 11 illustrates a PBL method wherein a LIDAR identifies a first portion of a TOF boundary in a FOV and estimates a direction (i.e., an angular offset in the FOV) to reach a search zone (e.g., an angular range) wherein the LIDAR searches for a second portion of the TOF boundary.

Several embodiments of FIG. 11 can be considered extrapolation-based progressive boundary localization (EPBL) methods. Using EPBL one or more locations on a TOF boundary identified by a LIDAR in a first search region within a FOV can be used to extrapolate or predict an estimated boundary location outside of the first search region. The LIDAR can then dynamically steer to generate a second search region based on the estimated boundary location. The extrapolation of the estimated boundary location can be based on the shape of a line through the one or more locations identified on the boundary (e.g., a straight line fit through two locations or a curve fitted through 3 or more locations). In other embodiments the extrapolation of a predicted or estimate boundary location outside the first search region can be based on a classification of the type of boundary. For example, many objects that a LIDAR on an autonomous vehicle can encounter have common shape characteristics within various object classifications such as common road intersection patterns, trucks shapes, overpasses, pedestrians, cyclists or buildings. An extrapolation of an estimated boundary location can be based on processing one or more known boundary locations in the context of one or more predicted object classifications. For example, a newly discovered TOF boundary may be one or many object types (e.g., a tree or a pedestrian at the corner of a road intersection). An exemplary EPBL embodiment could apply a 50% probability that the boundary is the trunk of a tree and a 50% probability that the boundary is the body of a person and estimate a boundary location outside a first search region based on the blended classification and the one or more known boundary locations. Subsequent search regions generated based on the estimated boundary location can cause the predicted classification to favor either the tree or the person and future extrapolation of estimated boundary locations can be weighted according to the set of known boundary locations and the updated classification weightings.

Various embodiments provide for calculating a confidence value or standard deviation associated with the direction (i.e., the angular offset to reach a new search zone defined by an estimated boundary location or vector). For example, everyday objects can have boundaries or edges with simple shapes (straight lines or simple curves) arranged in a direction relative to an observation point. Hence while it may be impractical for a rotating LIDAR to try to dynamically track and scan the boundary of object at an arbitrary orientation, it may be more practical to use a dynamically steerable LIDAR. In comparison to a steerable RADAR that tracks an objects movement from one scan to another and can predict a direction for the object, the disclosed PBL method can estimate the edges of an object within a single scan by finding a first portion of an edge and predict a direction for the edge (based on curve fitting, object classification or extrapolation). The method can then scan a laser beam in a pattern at a second location some distance along the predicted direction of the boundary in the FOV. Turning to FIG. 11 a LIDAR 1105 can scan a dynamically steerable laser 1106 in a first 2-D angular range 1115 (e.g., defined by an elevation angular range 1130 and an azimuthal angular range 1125). The total FOV of LIDAR 1105 can include several boundaries such as road edges 1110, 1111 and 1112. LIDAR 1105 can scan a path that comprises a sequence of orientations in the 2-D angular range. While scanning the path LIDAR 1105 can generate a sequence of laser pulses and measure a corresponding sequence of laser reflections. LIDAR 1105 can calculate a TOF (e.g., TOF 1120) or a distance corresponding with each of the sequence of outgoing laser pulses. The TOF values can have differences that indicate approximate location of a first portion of boundary 1110. For example, the TOF values (e.g., TOF 1120) can indicate angular regions 1135a-b that encompass a part of the boundary 1110. In one embodiment the LIDAR 1105 can calculate one or more regions in angular range 1115 that intersects the boundary. In other embodiments LIDAR 1105 can calculate one or more location estimates for points on the boundary 1110. For example, the PBL method can estimate that points on boundary 1110 are located midway between nearest neighbor points that indicate they are on opposite sides to the TOF boundary based on a TOF difference. One or more first locations or regions on the boundary 1110 can be used by the LIDAR to calculate a vector 1140 or 1141 used to steer the LIDAR 1105 to a second region estimated to overlap a second portion of boundary 1110. Shift vector 1140 can be a 2-D direction shift (e.g., a 10 degree elevation angle shift and a −10 degree azimuthal angle shift) to change the orientation of steerable laser 1106 from the first angular range 1115 to a second angular range 1146. In one aspect a shift vector 1141 can point to a search region 1147 that does not span the boundary 1110. In this case, in response to identifying that a search region (e.g., region 1147 including laser pulse 1150) does not contain a boundary, a new larger search region 1155 can be defined in an effort to reacquire the boundary 1110. One advantage of the EPBL method of FIG. 11 is that a second search region need not surround or adjoin a first search region. Instead a first search region can identify a direction of a TOF boundary. The direction can be used to generate a vector 1140 (i.e., a 1-D or 2-D angular shift) that functions to shift LIDAR 1105 to a new search location. In a related embodiment several locations on a first portion of a boundary calculated from a first search area can be used to interpolate a shape and direction of a boundary (e.g., a line or a curve). For example, three locations identified on a boundary 1110 from a first sequence of laser pulses including laser pulse 1120 can be used to define a curve or an arc 1157 on which other portions of the boundary 1110 are expected to lie.

In a related embodiment, a LIDAR can scan a path including a sequence of orientations in a first 2-D search region 1160 of a FOV. While scanning the path, the LIDAR can generate a plurality of laser pulses, receive a corresponding sequence of laser reflections and calculate a TOF corresponding to each of the outgoing laser pulses. The LIDAR can identify the presence of a TOF boundary (e.g., the edge of a vehicle or the edge 1111 of a roadway), by identifying one or more nearest neighbor pairs of laser reflections for which the TOF difference is greater than a TOF threshold. The LIDAR can calculate a set of boundary locations (e.g., locations 1162a and 1162b) based on the TOF measurements from the first search region 1160. The LIDAR can process one or more locations in the set of boundary locations (e.g., locations 1162a and 1162b) to predict an estimated boundary location 1163a, located outside the first search region. The LIDAR can generate a set of laser steering parameters, based on the estimated boundary location and dynamically steer a laser 1106 based on the laser steering parameters to generate a second plurality of laser pulses (e.g., including laser pulse 1170) in a second search region. In this way a LIDAR scan can be guided by identifying and adding directions in a FOV (e.g., locations in a FOV) that lie on a TOF boundary, predicting and estimated boundary location outside a first search region and scanning a second search regions with laser pulses based on the predicted trajectory of the TOF boundary. The method can be performed iteratively in the course of a single scan by building up a set of confirmed boundary locations, predicting estimated boundary locations and scanning a second search region around the estimated boundary location. In one embodiment of an EPBL method illustrate in FIG. 11, a first search region 1160 is used to generate boundary locations 1162a-b, that are then used to extrapolate the estimate boundary location 1163a or vector 1165a pointing to a second search region. A LIDAR scans a second search region to identify another boundary location 1162c that is added to the set of boundary locations. The updated set of boundary locations can be used to extrapolate a new estimated boundary location 1163b or an associated vector 1165b leading to a third search region that can be defined by path 1164. Path 1164 can have a complex shape involving a number of right angle turns or direction reversals with the FOV, thereby requiring dynamic steering of the LIDAR. In FIG. 11 the third search region (e.g., defined by path 1164) does not intersect or contain the TOF boundary 1111. For example, all laser pulses along path 1164 can have reflections that indicate a common TOF associated with one or other side of boundary 1111. In one aspect, in response to identifying that a search region does not contain a boundary location (i.e., does not intersect a TOF boundary) an EPBL method can generate a new estimated boundary location 1163c and dynamically steer a laser 1106 to generate a new search region 1172. The new search region 1172 can have a wider angular range designed to reacquire the boundary location surrounding the new estimated boundary location 1163c. The new estimated boundary location 1163c can be based on one, some or all of the locations in the set of boundary locations as well as the estimated boundary location 1163b that failed to generate a new boundary location. Search region 1172 can yield reflections that indicate a divergence or splitting of a TOF boundary. Such TOF boundary splitting can occur where objects overlap in the FOV of the LIDAR 1105.

Consider that many common objects that a vehicle-based LIDAR may encounter can comprise a series of intersecting straight-line or curved boundaries, such as the intersecting architectural lines of an overpass or a freeway exit. In response to identifying two intersecting or diverging boundaries in a search region 1172 (e.g., indicated by boundary locations 1162d and 1162e), the LIDAR can generate distinct estimated boundary locations 1163d and 1163e (or vectors 1165d and 1165e) for multiple distinct TOF boundaries 1111 and 1112.

In another embodiment of a EPBL method a LIDAR 1105 can track several TOF boundaries 1110 and 1111 simultaneously, by several distinct sets of boundary locations and periodically generating a new search regions for each based on a new extrapolated estimated boundary location. An EPBL method that tracks several boundaries at once can perform different functions in parallel such as extrapolating an estimated boundary location for a first boundary while scanning a new search region for a second boundary. Similarly an EPBL method can perform a wide angle 2-D scan of a FOV to search for new TOF boundaries while extrapolating boundary locations and tracking one or more previously discovered boundaries.

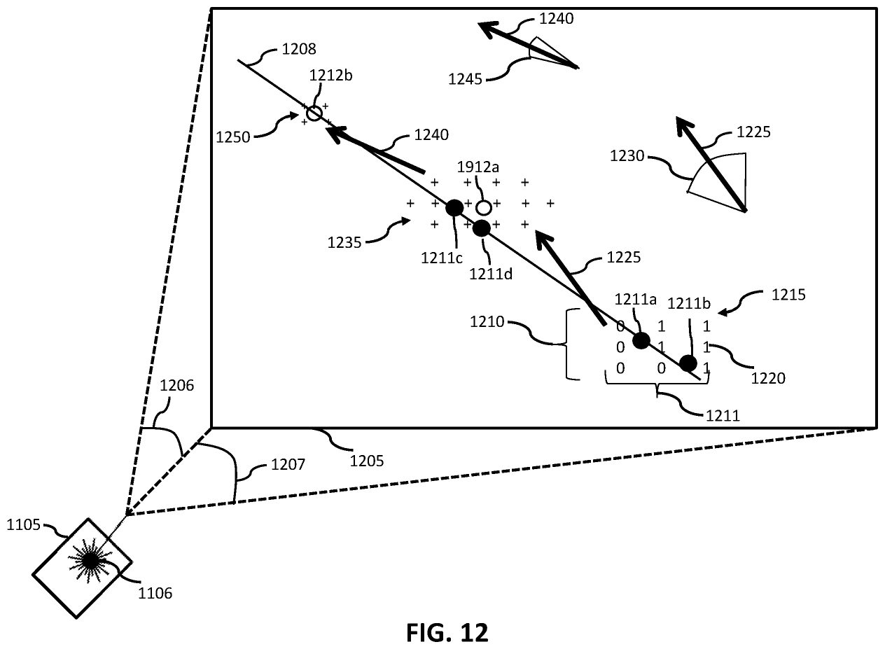

FIG. 12 illustrated an embodiment wherein an angular range 1230 is associated with a vector 1225 extrapolated from a set of boundary locations 1211a and 1211b. This angular range or confidence value can be based on how well the boundary locations fit a particular shape. For example, the angular range or confidence value can be based on the mean square error of line or curve fit to the set of boundary location used to generate vector 1225 or estimated boundary location 1212a.

Turning in detail to FIG. 12 a LIDAR 1105 can have a FOV 1205 comprising a 2-D angular range comprising a range of possible elevation angles 1206 and a range of possible azimuthal angles 1207. An EPBL method performed by a LIDAR can scan a first search region comprising an elevation angular range 1210 and an azimuthal angular range 1211, to produce a first set of laser pulses. The LIDAR can measure a set of reflection 1215 corresponding to the outgoing sequence of laser pulses and can measure a TOF (e.g., 1220) corresponding with each laser pulse in the sequence. The LIDAR can calculate a set of locations (e.g., location 1211a and 1211b) on a TOF boundary 1208 and can further extrapolate a vector 1225 (and confidence range 1230) to an estimated boundary location 1212a. The LIDAR can dynamically steer a laser 1106 to generate a second set of laser pulses 1235 based on the vector 1225 or the estimated boundary location 1212a. The size of the second set of laser pulses 1235 can be based on the confidence value 1230. For example, if processing the set of boundary locations indicates a straight-line boundary with a small mean square error line fit, the angular range or confidence value associated with vector 1230 can be small and consequently the size of the second set of laser pulses 1235 can be small. Conversely, if the set of boundary locations indicate a boundary with a complex shape (e.g., a tree) the angular range 1230 can remain high, or the confidence value associated with estimated boundary location 1212a can remain low, thereby causing laser 1105 to dynamically scan a larger search region 1235. Over time as the set of boundary locations grows to include 1211c and 1211d the angular range 1245 associated with subsequent vectors 1240 indicating the location of subsequent estimated boundary locations 1212b can be reduced as the overall shape of the TOF boundary 1208 becomes evident. Hence the size of subsequent search region 1250 can be sized according to the confidence level of the LIDAR in the estimated boundary location 1212b. In one aspect a dynamically steered LIDAR can have a FOV with at least two dimensions (e.g., an elevation dimension indicated by an elevation angle and an azimuthal dimension indicated by an azimuthal angle).

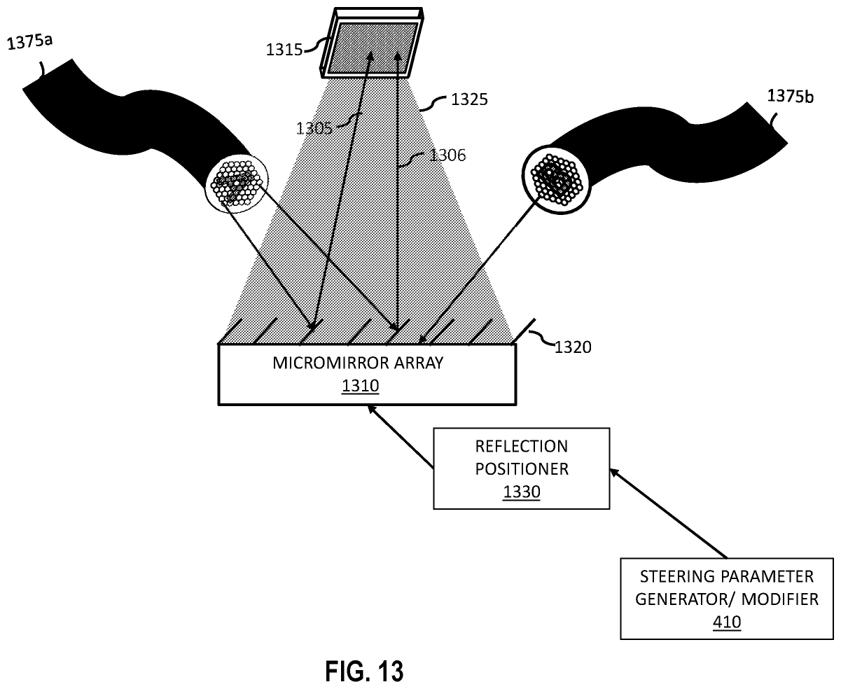

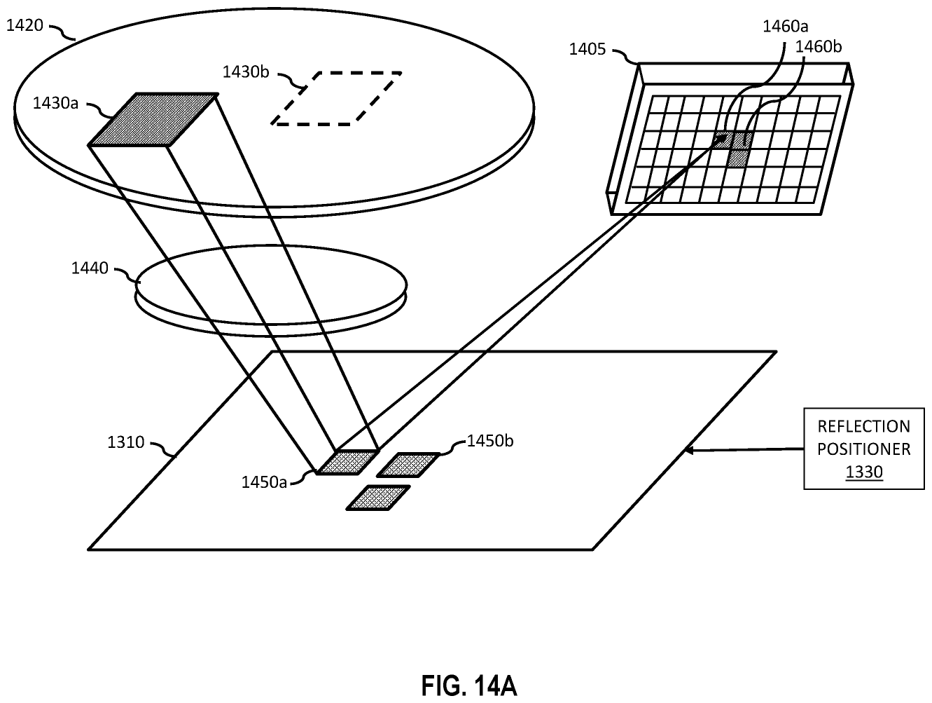

FIG. 13 illustrates a micromirror array 1310 placed in the field of view 1325 of a photodetector 1315 that can operate to multiplex light reflections from the output ends of two coherent fiber optic image bundles (CFOBs) 1375a and 1375b onto the photodetector array 1315. Exemplary micromirror arrays include the DLP6500FLQ DLP chip available from Texas Instruments Inc. of Santa Clara, CA. Modern micromirror array chip can comprise over 4 million electronically positioned micromirrors (e.g., mirror 1320). Reflection positioner 1330 can be similar to an LCD driver chip and can signal individual micromirrors or groups of micromirrors to change position. In the position shown in FIG. 13 the micromirror array deflects light reflections from CFOB 1375a onto photodetector 1315, while light reflections from CFOB 1375b are not deflected towards the photodetector array 1315.

The micromirror array 1310 can be used to dynamically select inputs for the FOV 1325 of detector 1315. Micromirror array 1310 can occupy the entire FOV 1325 of a detector or photodetector array 1315. In various configurations the micromirror can then present to the detector 1315 light reflections from one of multiple CFOBs, light reflection multiple CFOBs simultaneously with light reflections from each CFOB directed to different parts of the detector. Alternatively, micromirror 1310 can then present to the detector 1315 light reflections from multiple CFOBs simultaneously with light from each CFOB directed to overlapping parts of the detector. Mirrors (e.g., 1320) in some or all of the micromirror arrays can be arranged at different angles to form angled reflectors to focus light reflections from all or portions of a CFOB onto a single detector element or a few detector elements. This can be useful for detecting if any optical fiber in a portion of the output surface of a CFOB is carrying a light reflection. Alternatively micromirrors can form a convex mirror arrangement, thereby spreading light reflections from a portion of the CFOB output surface over a wider portion of the detector (e.g., a wider range of elements in a detector array). In this way the micromirror array can magnify, combine, select and overlap portions of one or multiple CFOBs onto a photodetector 1315. The usefulness of the micromirror array is enhances by available light reflections from multiple FOVs based on the plurality of CFOBs.

### LIDAR With a Micromirror Array for Dynamic Reflection Distribution

In a related group of embodiments, a flash LIDAR can use a micromirror array to dynamically select one or more subsets of a FOV to transmit to a detector or detector array, and thereby improve the LIDAR resolution. While 2D digital cameras and 3D time-of-flight cameras are similar in some aspects, the different objectives makes scaling detector array in LIDARs challenging. Specifically, 2D digital cameras integrate the charge (photon current) at each pixel on the CCD array over a relatively large acquisition time (e.g., 10-100 milliseconds) often with little regard for when photons arrive within the acquisition time window. Subsequently, a readout circuit can read the charge stored on many pixels in a serial or parallel manner. Advances in the speed of readout circuitry have enables the resolution of 2D cameras (e.g., number of pixels) to outpace the complexity of the corresponding readout circuitry. For example, readout circuits in 2D cameras are servicing increasing numbers of pixels per readout circuit, thereby enabling higher resolution 2D digital camera. Conversely, 3D time-of-flight cameras are designed to determine when light reflection arrives at the detector array and thereby determine distance to a reflection source. Each pixel often has associated electronics (e.g., transimpedance amplifiers, phase comparators or timing circuits). Hence LIDAR resolution (numbers of pixels per array) has lagged behind that of 2D digital cameras and ways to increase this resolution remain a challenge.

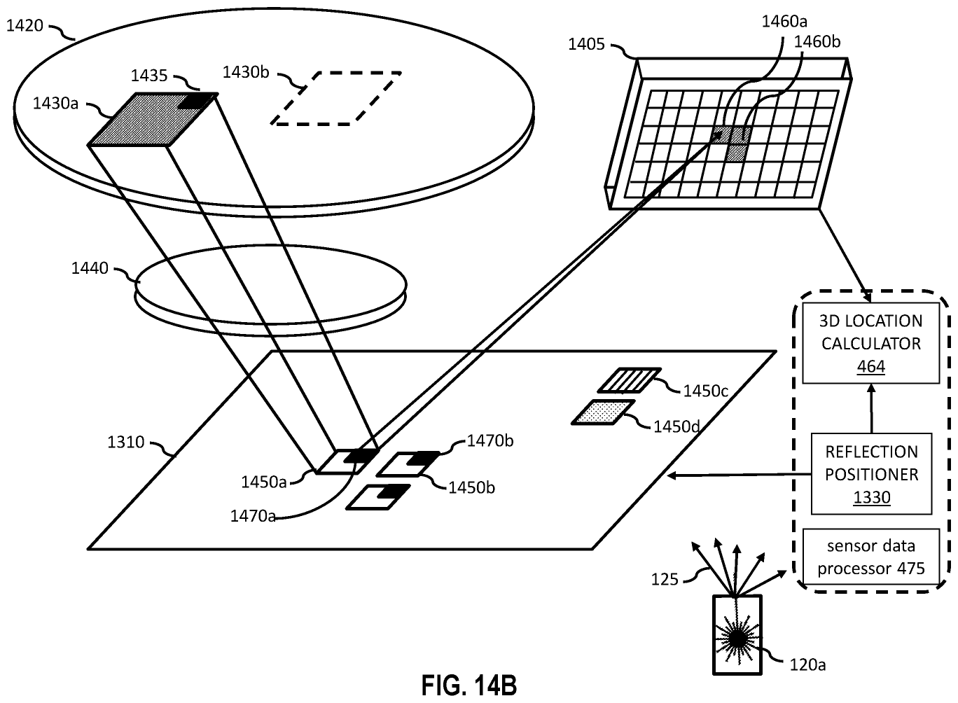

FIG. 14A illustrates an embodiment of a flash LIDAR using a micromirror array to dynamically select subsets of the reflected FOV and thereby improve the resolution. Consider the following example: many state-of-the-art focal plane arrays for IR wavelengths have 128×128 elements (e.g., the TigerCub Flash Lidar available from Advanced Scientific Concepts Inc. or Santa Barbara CA). Consider that for a 64 degree azimuthal FOV each element receives laser reflections from 0.5 degrees of the FOV. This may seem like a high resolution but consider that at 100 m distance from such a flash lidar a 0.5degree FOV resolution results in a 1 meter capture area (e.g., 100×Tan(0.5 degrees). Hence an unaided 128×128 element detector array has a 1 square meter resolution at 100 m. A challenge is to enhance this resolution and one way to achieve this is to only accept laser reflections from a portion of each 0.5×0.5 degree region of the FOV that serves each element in the array.

FIGS. 14A and 14B illustrate an embodiment where a micromirror array 1310 selects a sequence of portions of an incoming FOV to present to a detector 1405. In one example micromirror 1310 has 8 million micromirrors. Hence, the ratio of micromirrors to detector elements can be large (e.g., 488 micromirrors per detector element for a 128×128 element detector array and an 8 M mirror DLP chip). Turning to FIG. 14A, micromirror array 1310 can be positioned in the FOV of a detector array 1405. Micromirror array 1310 can also have a FOV 1420 comprising the set of all directions that a light reflection can reach the micromirror array 1310. In one operating mode, portions 1430a and 1430b of the micromirror FOV 1420 can be focused using input lens 1440 onto corresponding portions 1450a and 1450b of micromirror array 1310. In one example the portions 1450a and 1450b can each comprise 488 micromirrors (corresponding to 8 million total mirrors divided by 128×128 total detector elements).

In one aspect, reflection positioner circuitry 1330 can function to adjust the 488 micromirrors in each of the portions 1450a and 1450b to focus light reflections from the corresponding portions of the micromirror FOV onto corresponding detector elements 1460a and 1460b respectively. For example, reflection positioner circuitry 1330 can instruct the 488 micromirrors in portion 1450a to form a concave reflector with a focal distance equal to the detector array. This can provide operation similar to direct illumination of the detector element by laser reflections from a portion of the FOV. This mode can be useful for detecting weak reflections, since many micromirrors can combine laser reflections from a single part of the FOV (e.g., a 0.5×0.5 degree portion corresponding to 488 micromirrors).

FIG. 14B illustrates another related operating mode in which a micromirror array utilizes only a fraction of the micromirrors in the portions 1450a and 1450b to deflect light reflections from corresponding portions of the FOV 1420 towards the detector array 1405. In the embodiment of FIG. 14B electronic circuitry 1480 can comprise reflection positioner circuitry 1330 and can instruct micromirror array 1310 to direct a first quarter of each group of 488 micromirrors (e.g., subsets 1470a and 1470b within portions 1450a and 1450b) towards the detector array. A controller 820 in electronic circuitry 1480 can instruct emitter 120a to emit a flash or beam of light, thereby illuminating some or all of FOV 1420. The detector array 1405 can measure and record the light reflections on the detector elements (e.g., a 128×128 array).

Electronic circuitry 1480, including reflection positioner circuitry 1330 can subsequently instruct the micromirror array 1310 to position a second quarter of the 488 micromirrors in each portion (e.g., portion 1450a and 1450b) towards corresponding detector elements 1460a and 1460b.

Controller 820 can instruct the light emitter to generate a second light pulse operable to illuminate some or all of a scene visible in FOV 1420. Detector array 1405 can again detect a second set of light reflections from the 128×128 detector elements. The electronic circuitry can generate several configurations thereby positioning a plurality of subsets of the micromirror in each portion of the array towards the detector array. Following each configuration of the micromirror the electronic circuitry can instruct the light emitter to generate one or more light pulses. Following each light pulse a set of light reflections are detected by detector array 1405. Detector array 1405 can detect the time of arrival of reflections and an arrival direction. The arrival direction can be indicated by the detector element (e.g., 1460a or 1460b) in the detector array that detects each light reflection. Electronic circuitry 1480 can further comprise a 3D location calculator 464. For the set of reflections corresponding to each micromirror array configuration the detected times of arrival and directions of arrival can be conveyed from the detector to the 3D reflection positioner using signals.

In one aspect, the 3D location calculator 464 can also receive data indicative of the configuration of the micromirror array 1310. For each light reflection in the set of light reflections the 3D location calculator can generate a 3D location indicative of a reflection location corresponding to the light reflection. The 3D location can be based on a detector element (e.g., the position in a detector array where the reflection was sensed) and further based on the configuration of the micromirror array (i.e., the subset of directions in the FOV being deflected towards the detector array). For example, a detected light reflection at detector element 1460a can indicate a reflection at a location encompasses by region 1430a in the FOV 1420. The micromirror array configuration can further refine the portion of the FOV to indicate the reflection came from the upper left portion 1435 of region 1430a. The time-of-flight between the corresponding emitted light pulse and a light reflection can indicate the range to the reflection location within region 1435. Hence the various micromirror array configurations enable more unique 2D locations (i.e., 2D reflection directions) to be generated (i.e., measured) in a corresponding 3D point cloud, than the number of photodetector elements in array 1405. For example the configuration of FIG. 14B enables 4 discrete configurations of the micromirror array 1310 and a 128×128 detector array to sense reflections in 4×128×128 unique directions.

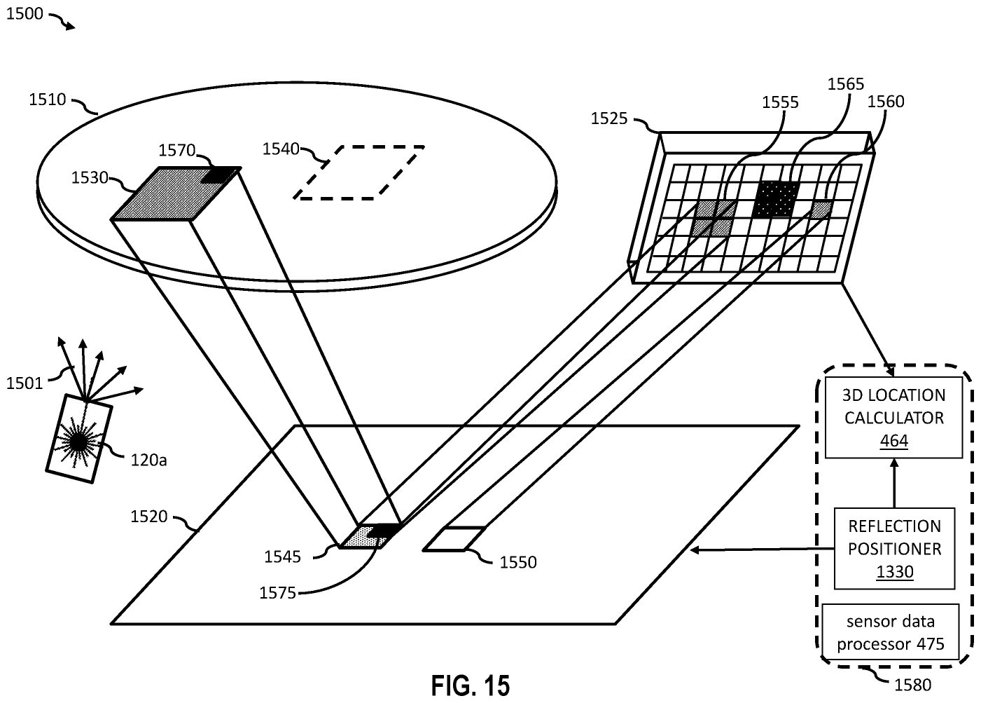

FIG. 15 illustrates a LIDAR 1500 comprising a laser transmitter 1505. Transmitter 1505 can transmit a laser beam 1501 in a plurality of directions in a FOV 1510. Laser reflections from directions in FOV 1510 can be focused onto a micromirror array 1520 in a deterministic or uniform manner using receiver optics 1515. For example, a lens can gather reflections from region 1530 of FOV 1510 onto region 1545 of the micromirror array. A region 1540 of the FOV (i.e., a subset of directions in FOV 1510) with a similar size to region 1530 can be focused onto a region 1550 of the micromirror array (i.e., a subset of the micromirrors) with a similar size to region 1545 of the micromirror array. Hence LIDAR 1500 can have a fixed ratio of the number of micromirrors per unit of solid angle (e.g., steradians or square degrees), as a function of location on the micromirror array configuration. However, the micromirror can be easily configured to distribute this fixed number of micromirrors per square degrees of FOV in a non-uniform manner to an associated detector array.

In one aspect, while the ratio of solid angle in FOV 1510 to micromirrors in the micromirror array can be fixed, the micromirror array can be dynamically configured (e.g., using reflection positioner circuitry 1330) to distribute the reflected laser beams in a dynamic manner. For example, reflected laser beams from region 1530 of FOV 1510 can be spread across region 1555 (comprising 4 pixels) of detector array 1525. Conversely, reflected laser beams from region 1540 are focused by region 1550 of the micromirror array on a single pixel 1560. In a similar way laser reflections from a subset 1575 of the micromirrors can be directed to a particular receiver element (e.g., pixel). In one embodiment, dynamically configuring micromirror array 1520 to spread laser reflection from a region 1530 across an increased number of receiver pixels can identify a time-of-flight (TOF) boundary (e.g., the edge of an object) in the FOV. For example sub-region 1570 of region 1530 can indicate a TOF boundary relative to the remainder of region 1530 and the TOF boundary can be identifies based in part on focusing subset 1575 of the micromirrors onto a dedicated group of pixels 1565 in detector array 1525 (i.e., across a wider angular range in the receiver array). LIDAR 1500 can iteratively localize a boundary by iteratively spreading a sub-region (e.g., 1570) identified to contain a TOF boundary across a greater portion of the receiver array (e.g., upon identification that region 1570 contains a TOF boundary, reconfiguring the micromirror array 1520 to focus a corresponding subset 1575 onto region 1565 or photodetector array 1525.

Micromirror array 1520 can be dynamically configured to increase or decrease the ratio of input solid angle from the FOV to output solid angle at the photodetector array based on variety of parameters such as scene classification (e.g., urban, suburban, or highway), the presence of a particular object (e.g., cars, people etc.) the presence of boundaries (e.g., a roadside, overpass or person outline). Micromirror array 1520 can also be configured to periodically enhance a sequence of regions in the FOV (e.g., to periodically enhance each portion of the FOV), thereby providing periodic resolution enhancement to one, some or all regions of the FOV.

In a related embodiment to LIDAR 1500 a digital camera can have a similar arrangement. Instead of a laser transmitter the digital camera can generate light or rely on ambient light. The digital camera can identify edges within the FOV (e.g., based on initial data received at a CCD array similar to receiver 1525). Upon identification of boundaries or edges in initial image data the digital camera can reconfigure a micromirror array to dynamically enhance boundary localization by spreading the boundary containing regions across more pixels in the receiver array. The output image can be a combination of data including uniform and non-uniform configurations of the micromirrors.

### Micromirror Array for Resolution Enhancement

In one aspect a micromirror array can act like an electronically controllable transfer function for light, between an input lens of a camera and a photodetector array. For example, an analog micromirror array can perform a zoom function by deflecting a small portion of available FOV onto the photodetector array while simultaneously spreading the small portion over the detector. This has the effect of increasing image resolution (e.g., pixels per square degree of the field of view). However zooming in a portion of the FOV with the micromirror array can have the drawback of narrowing the FOV (i.e., zooming in on the scene). There are many applications where both enhanced resolution and a wide FOV are desirable. In one embodiment a method performed by an imaging system comprises providing at an aperture a 2D field of view (FOV) from a scene to a micromirror array having a first configuration, and thereby deflecting light with the micromirror array from the FOV onto a photodetector array. The method further comprises detecting with the photodetector array a first set of light measurements that span the FOV, processing the first set of light measurements and thereby identifying a region of interest (e.g., a portion of the FOV or scene containing an object edge or a face), in the FOV, having a first resolution at the detector array. The method further comprises configuring the micromirror array based at least in part on the identified region of interest and thereby detecting with the photodetector array a second set of light measurements spanning the FOV with a second resolution in the region of interest that is greater than the first resolution.

In one aspect the method can conserve the size (e.g., angular range) of the original FOV, thereby keeping people and pets in the frame and not distracting a user with an unwanted zoom effect. In another aspect the method can enhance image resolution while simultaneously conserving the original FOV; by configuring the micromirror array to compress light rays from one or more uninteresting portions of the FOV onto fewer pixels in the photodetector array (e.g., based on the first set of light measurements) and thereby enabling light rays from the region(s) of interest to be spread over more pixels to enhance the resolution. Therefore, by creating areas of sparse and denser light rays on the photodetector array simultaneously, the original FOV can be conserved.

In a system embodiment a processing subassembly with access to data from the photodetector array and micromirror configuration can correct for the distortive effect of the dense and sparse zones on the photodetector array and generate an eye-pleasing output image. In another embodiment, data from sensors or sources other than the photodetector array can be used to identify the region(s) of interest. In a second embodiment a method performed by an imaging system comprises: Processing sensor data indicative of a scene in the vicinity of a micromirror array and thereby identifying a region of interest in the sensor data, wherein the micromirror array has a field of view encompassing at least some of the scene, wherein the micromirror array comprises a plurality of micromirrors with an initial configuration that deflects light from the region of interest towards a detector array and thereby provides a first resolution at the detector array for the light from the region of interest, configuring the plurality of micromirrors in the micromirror array, based at least in part on the identified region of interest and thereby providing at the detector array a second resolution for light form the region of interest that is greater than the first resolution.

In a third embodiment the micromirror array can be part of a ranging subassembly for a light detection and ranging system (LIDAR). For example a flash LIDAR can illuminate a field of view (FOV) with flashes of light and gather reflections from the FOV at a photodetector array. A micromirror array can be configured based on an identified region of interest to non-uniformly spread the light reflections from the flashes of light based on the identified region of interest.

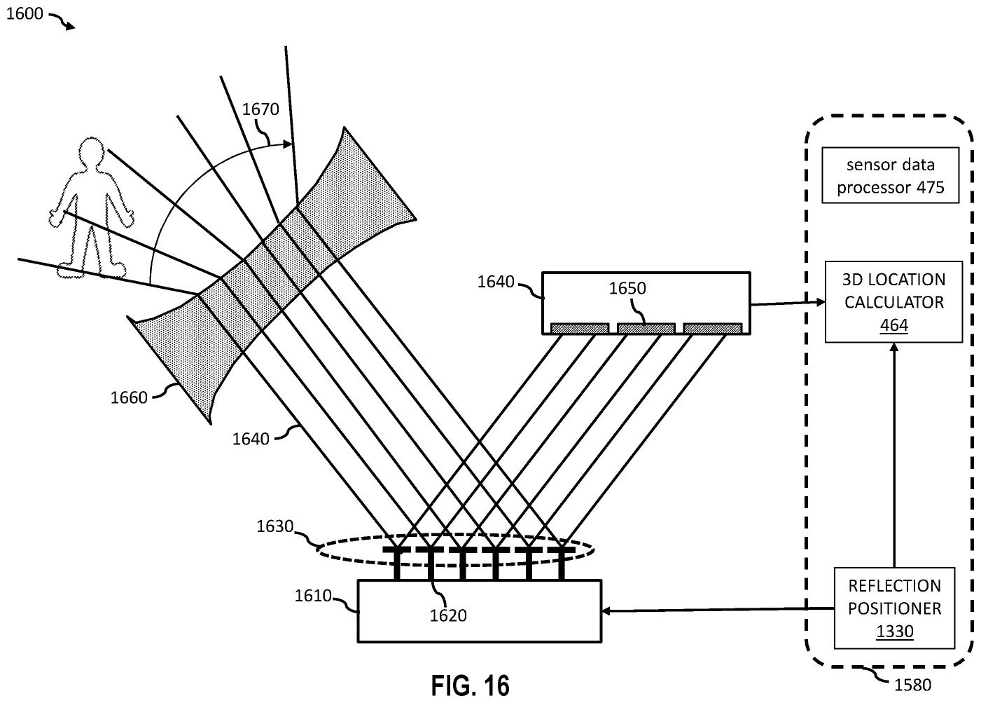

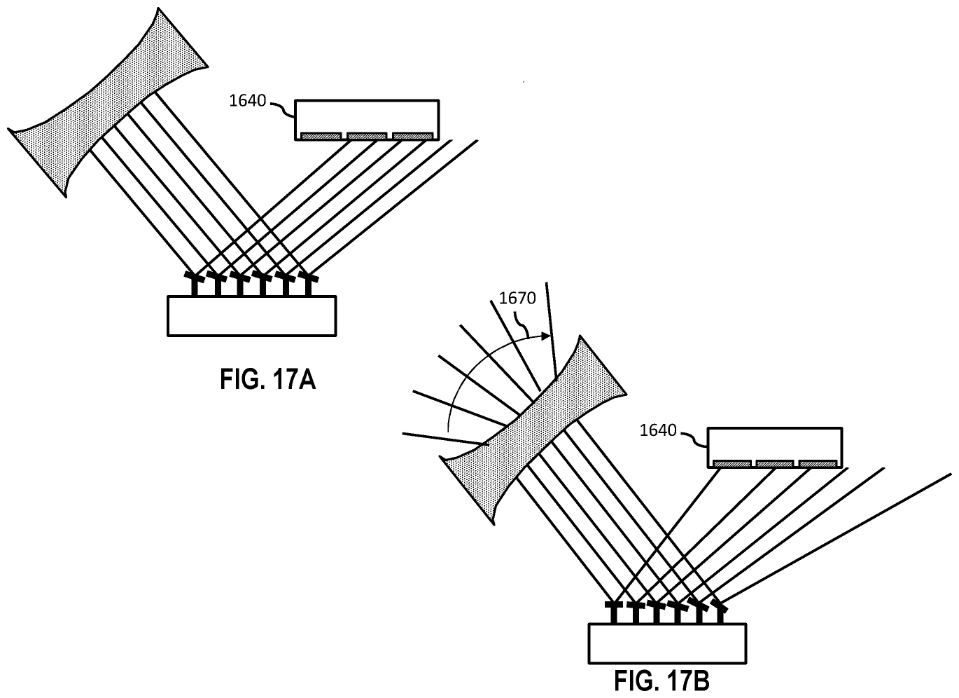

FIG. 16-18 illustrates an embodiment wherein an imaging system having a field of view, identifies one or more regions of interest from sensor data, reconfigures a micromirror array to increase the resolution at a detector array from the region of interest, decreasing the resolution at the detector array from another region of the FOV and thereby senses the entire FOV. Turning to FIG. 16 in one embodiment an imaging system 1600 comprises a reflection positioner 1330 to configure a micromirror array 1610, comprising a plurality of micromirrors (e.g., micromirror 1620), to a first configuration 1630 operable to deflect light (e.g., light ray 1640) from a scene in a vicinity of the micromirror array onto a detector array 1640 comprising a plurality of detector elements or pixels (e.g., element 1650). Imaging system 1600 can be a camera to generate a 2D image or a LIDAR to generate a 3 dimensional (3D) point cloud. Imaging system 1600 can further comprise a lens 1660 to gather light from a FOV indicated by angular range 1670. The FOV can be a 2 dimensional (2D) angular range and can comprise an angular area (e.g., 100×100 square degrees) comprising the set of all directions in which the imaging system 1600 can receive light beams from the local environment. In FIG. 16 the imaging system is illustrated receiving 6 light rays or beams and the micromirror array spreads the light rays uniformly across the detector array (e.g., with a resolution of 1 pixel per two light rays).

FIG. 17A illustrates that the micromirror array can be reconfigured to keep the same resolution but shift the light rays such that only a subset of the light rays are deflected towards the detector array. FIG. 17B illustrates a situation where the micromirror array spreads out the light rays thereby, magnifying a portion of the FOV and increasing the resolution to 1 pixel per light ray. However, a problem illustrated in FIG. 17B is that not all of the original FOV is sensed when the 6 light rays are uniformly spread out or magnified by the micromirror array. Hence, the detector array 1640 senses light rays from only half of the original angular range 1670.

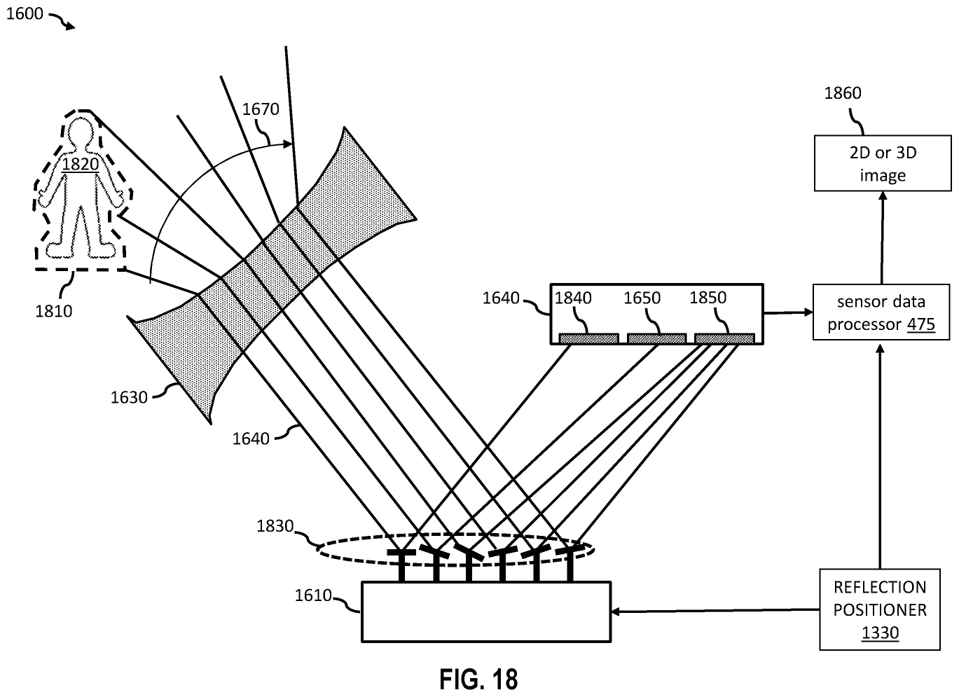

Turning to FIG. 18 imaging system 1600 can further comprises circuitry (e.g., 3D location calculator 464 or sensor data processor 475) to process sensor data from the vicinity of the micromirror array to identify a region of interest in the scene. FIG. 18 illustrates an exemplary region of interest 1810 as a complex shaped portion of the FOV surrounding person 1820. Other exemplary regions of interest could be a 3D volume of space, a set of coordinates defining a region within the local environment of the imaging system 1600. Regions of interest could be portions of a FOV surrounding all cars or a portion of a FOV encompassing or containing a boundary, a feature or time-of-flight boundary from depth data.

In FIG. 18 the micromirror array 1610 is reconfigured to a second configuration 1830 (e.g., relative to the initial configuration 1630). The second configuration can be selected based at least in part on the identified region of interest. For example, in response to identifying a region of interest around person 1820 reflection positioner 1330 can reconfigure the micromirror array (or a subset of the micromirror array) based on the location or size of the region of interest. In the embodiment of FIG. 18 the second configuration 1830 provides at the detector array a second resolution that is greater than the first resolution for light from the region of interest. Additional FIG. 18 illustrates that the second configuration 1830 can increase the resolution at a first portion (including element 1650 and 1840) of the detector array 1640, while decreasing the resolution at a second portion (including element 1850) in order to sense the whole FOV 1670. For example, the resolution is increased for photodetector elements 1650 and 1840 from 1 pixel for 2 light rays to 1 pixel per light ray, while the resolution is reduced to element 1850 to 1 pixel for 4 light rays.

In one aspect the high resolution portion of the detector array can have a high resolution based on the total available number of detector elements or pixels in the detector array, based on the size of the region of interest (e.g., the solid angle or area of the field of view identified as a region of interest based on the sensor data). For example, 25% of a 1000×1000 pixel detector array can be devoted to resolution enhancement. If a small region of interest (e.g., 10×10 square degrees around a face in the background) is identified in a FOV the micromirror array can be reconfigured to provide a very high resolution of 2,500 pixels per square degree. Alternatively if a larger region of interest (e.g., a 1000 square degree complex shaped region around the boundary of a vehicle) is identified the micromirror array can be reconfigured to provide a high resolution of 250 pixels per square degree. In both cases the total number of pixels devoted to resolution enhancement can be 250,000 or 25% of the total detector array.

In one embodiment a method comprises the steps of firstly obtaining a micromirror array, comprising micromirrors in a first configuration; secondly deflecting with the micromirror array a first set of light beams from a FOV towards a detector array; thirdly detecting with the detector array the first set of light beams and thereby generating first sensor data; wherein a subset of the first set of light beams are from a region of interest in the FOV and have a first resolution at the detector array; fourthly in response to processing the first sensor data, reconfiguring at least some of the micromirrors; and fifthly deflecting, with the at least some of the micromirrors, a second set of light beams from the region of interest to the detector array; wherein the reconfiguration of the at least some of the light beams causes the second set of light pulses to have a second resolution at the detector array greater than the first resolution.

In one aspect the reflection positioner 1330 can receive a set of instructions to reconfigure the micromirror array and thereby implement a transfer function between a light rays from a FOV and their placement and resolution on a photodetector array (e.g., FOV 1670 of imaging system 1600). The transfer function can aim to enhance resolution of regions of interest in the FOV such as boundaries, objects of interest, or new objects in need of classification. This dynamically implemented transfer function creates dynamically defined relationship between light rays from the local environment and the sensor data measured by the detector array. With the micromirror array in a configuration to enhance resolution of region(s) of interest the corresponding high-resolution sensor data gathered at the detector array is effectively distorted by the non-uniform configuration of the micromirror array. Hence in one aspect the knowledge of the transfer function by the reflection positioner 1330 can be used by a sensor data processor 475 to process the high-resolution sensor data to enable it to be combined or displayed with other sensor data from other configurations. Sensor data from the detector array can be decoded using knowledge of the micromirror array configuration to place the sensor data in a common frame of reference (e.g., a 2D or 3D array forming an image).

In another embodiment a reflection positioner can generate a set of positioning instructions operable to configure the micromirror array. The positioning instructions can generate a high-resolution region within the micromirror array that functions to deflect light from the FOV with a higher than average resolution or a higher than original resolution towards a corresponding high-resolution portion or region of the detector array. The high resolution region of the micromirror array can deflect light from a region of interest. For example the high-resolution region can have the shape of a line that captures the outline of an object (e.g., a car) in the local environment. The high-resolution region of the detector array can generate high-resolution data. The high resolution data can be processed according to a transfer function indicating the configuration of the micromirror array. This processing of the high-resolution data can place high-resolution data in a common frame of reference or to account for the magnifying effect of the high-resolution region of the micromirror array. The sensor data processor 475 can combine sensor data at a uniform or average resolution (e.g., used to generate the positioning instructions) with high-resolution data to form a 2D or 3D image 1860. For example an imaging system can gradually configure a micromirror array by iteratively processing sensor data, configuring regions of the micromirror array and gradually refining the resolution of regions of interest at the detector array. A 2D or 3D image can be formed by the sensing data from the detector array with the micromirror in the final configuration. Alternatively the 2D or 3D image can combine sets of sensor data from a plurality of configurations leading to a final configuration. For example an initial uniform configuration of the micromirror can serve to provide a foundation of sensor data. Subsequent configurations can provide additional sets of high-resolution sensor data from subsets of the whole FOV that when combined with the first sensor data set provide an enhanced resolution image of all of the FOV with enhanced resolution in dynamically defined regions of interest. For example imaging system 1600 can generate a 2D image or a 3D point cloud comprising sensor data from a first uniform scan of the FOV and a subsequent adaptive resolution scan based on processing data from the first uniform scan.

In one aspect a region of interest, high-resolution region of a micromirror array or a high resolution region of a detector array can be selected based on sensed object, a classification of an object

In a LIDAR embodiment a method comprises firstly generating with one or more emitters an outgoing set of light pulses; secondly deflecting with a micromirror array, having a field of view, a first set of light reflections corresponding to the outgoing set of light pulses; thirdly detecting at a detector array the first set of light reflections and thereby generating a first set of reflection data; fourthly processing the first set of reflection data and thereby identifying a location estimate for a region of interest in the FOV, wherein the region of interest has a first resolution at the detector; fifthly configuring the micromirror array based at least in part on the location estimate for the region of interest and thereby generating a second resolution at the detector for the region of interest that is greater than the first resolution.

### Lidar With Direction Feedback

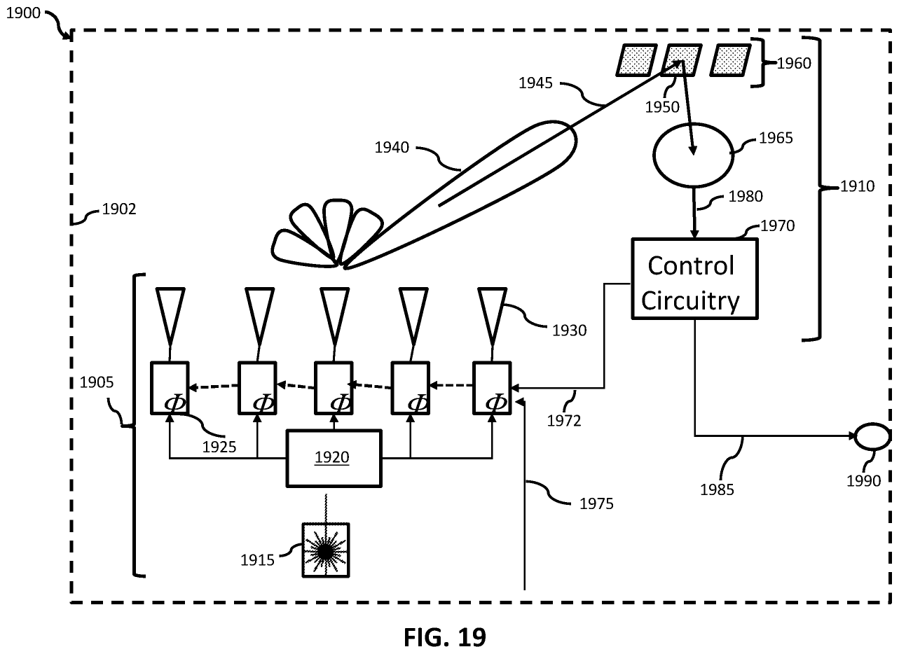

Turning to FIG. 19 a direction-detecting solid-state LIDAR 1900 can comprise an optical phased array (OPA) 1905, and direction feedback subassembly 1910 in a common LIDAR enclosure 1902. In most situations a laser detector in a LIDAR receives laser reflections from objects outside the LIDAR enclosure 1902. The direction feedback subassembly 1910 can function to directly detect the outgoing laser beam in one or more calibration directions. In several embodiments the direction feedback subassembly 1910 can include control circuitry to adjust the OPA and thereby provide a self-calibrating feedback-based solid-state LIDAR. The direction feedback subassembly circuitry can directly detect laser intensity in the one or more calibration directions and adjust the OPA to change the output laser direction. In one aspect the feedback circuitry can adjust the electrical signals to the phase shifters in the OPA to compensate for environmental factors such as temperature or humidity as well as manufacturing variations. In another aspect the electronic circuitry can function to confirm that the OPA and the laser detector in the circuitry are capable of both transmitting a laser beam in the one or more calibration directions and receiving the laser beam.

Turning in detail to FIG. 19, OPA 1905 can comprise a laser generator 1915 such as a laser diode and a laser splitter 1920 operable to divide a laser beam into a plurality of sub-beams. A plurality of phase shifters 1925 (e.g., a liquid crystal, thermal or phase shifter or Indium phosphide phase shifter) can delay each of the sub-beams by varying amounts. The resultant phase shifted sub-beams can be combined through a series of waveguides or antennas 1930 to produce a directed laser beam with a primary far field lobe 1940. In one aspect a direction feedback subassembly 1910 can comprise a reflector 1950 to reflect a laser beam transmitted by the OPA 1905 in a particular calibration direction 1945. Alternatively, a plurality of reflectors 1960 can reflect a laser beam in a plurality of calibration directions. Recent advancements in reflective liquid crystal materials have made electronically switchable mirrors possible (e.g., the e-Transflector product line available from Kent Optoelectronics of Hopewell Junction, NY). In one aspect one reflector 1950 or reflector array 1960 can be electronically switchable mirrors. These electronically switchable mirrors can function to reflect the laser beam towards reflector 1965 when switches ON and function to be transparent to a laser beam (e.g., in direction 1945), when turned OFF, thereby passing a laser beam beyond the enclosure 1902. In this way, an embodiment of direction feedback subassembly 1910 with electronically switchable mirrors can function to measure the directional accuracy of OPA in the reflective state (i.e., the ON state) of the switchable mirrors 1950 or 1960. Laser detector 1965 can be a dedicated photodiode or can be at least a part of the laser detector for the LIDAR 1900. Laser detector 1965 can receive a reflected laser beam and generate a reflection signal 1980 indicating the intensity of the laser reflection. The intensity of the laser reflection and the reflection signals can be compared with an expected value by control circuitry 1970. Alternative control circuitry 1970 can generate a perturbation signal 1985 to the phase shifters 1925 that cause the phase shifters to vary the main lobe direction 1940 and thereby identify an offset adjustment signal 1972 that causes the maximum intensity in the calibration direction 1945, thereby indicating that the main lobe 1940 is pointed in the calibration direction 1945. In a related embodiment laser detector 1965 can detect the laser intensity in the calibration direction and similar directions directly. The offset adjustment signal 1972 can function to adjust the OPA to account for variations due to temperature or aging of the LIDAR.

Similarly, control circuitry can function to adjust the OPA to provide maximal intensity in the calibration direction when a corresponding input calibration signal 1975 commands the OPA to point in the calibration direction 1945. In one embodiment control circuit 1970 can assert a malfunction indicator signal 1985 (e.g., a 0-12 V value) if, in response to the input calibration signal 1975 the OPA does orient the laser beam in the calibration direction 1945. The malfunction indication signal 1985 can connect the control circuit or the laser detector 1965 to a malfunction indicator pin 1990 on the enclosure 1902 of LIDAR 1900. In one embodiment both the input calibration signals 1975 and the offset adjustment signal can be generated by the control circuitry 1970.

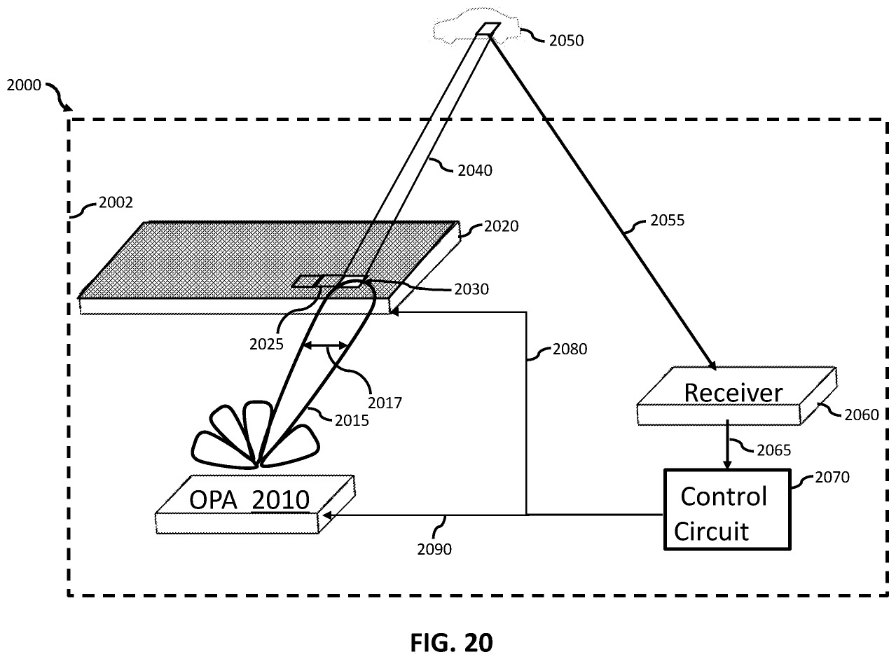

FIG. 20 illustrates a solid state LIDAR 2000 inside an enclosure 2002. OPA 2010 can generate a near-field beam pattern and a primary far-field lobe 2015 with a beam-width 2017.

LIDAR 2000 can further comprise a selective light modulator (SLM) 2020 such as an LCD array that can selectively make pixels such as 2030 and 2025 transparent and opaque. SLM 2020 can function to collimate or narrow the beam-width of far-field lobe 2015, thereby generating a collimated beam 2040. Collimated laser beam 2040 can have a smaller spot size than the uncollimated far-field lobe 2017 and can hence reflect from a distinct region of reflection target 2050. For example far-field lobe 2015 can span a range of directions in a field of view and the SLM can be configured to transmit laser light from the far-field lobe in a subset of the range of directions. Laser detector 2060 can receive reflected laser pulse 2055 and generate reflected signal 2065. In one aspect control circuitry 2070 can control OPA 2010 to adjust the far-field lobe direction to generate the maximum laser intensity for a particular aperture (e.g., subset of transparent pixels such as 2030 in the SLM). In another aspect the aperture in the SLM can be varied for a given OPA setting to achieve enhanced laser resolution for selectively transmitting subsets of the full far-field beam-width. For example, an OPA may be capable of generating 10000 distinct laser beam directions. The SLM can comprise 400×600 LCD pixels and can thereby provide 220000 distinct collimated laser beams 2040. In one aspect a set of laser steering parameters can both scan the far-field lobe laser beam of the OPA and can control the configuration of transparencies of the elements in the SLM. In one embodiment the OPA is adjusted to particular laser direction and a sequence of SLM aperture shapes transmit subsets of the far-field laser beam cross-section thereby enhancing the accuracy and resolution of laser range finding by providing a smaller output laser cross section. A SLM can comprise a 2D array of pixels, segments or elements each with electronically controllable transparency.

In one embodiment A LIDAR comprises one or more emitters to generate a set of laser pulses, wherein each of the plurality of laser pulses has a corresponding direction and beam cross-section; a selective light modulator positioned in the path of the plurality of laser pulses, comprising a plurality of segments with electronically controllable transparency, and control circuitry operable coupled to the selective light modulator and configured to control for each of the plurality of pulses at the electronically controllable transparency of at least some of the plurality of segments to block laser light from at least some the corresponding beam cross-section of the each laser pulse and transmit at least some of the each laser pulse with a transmitted beam cross-section smaller than the corresponding beam cross-section.

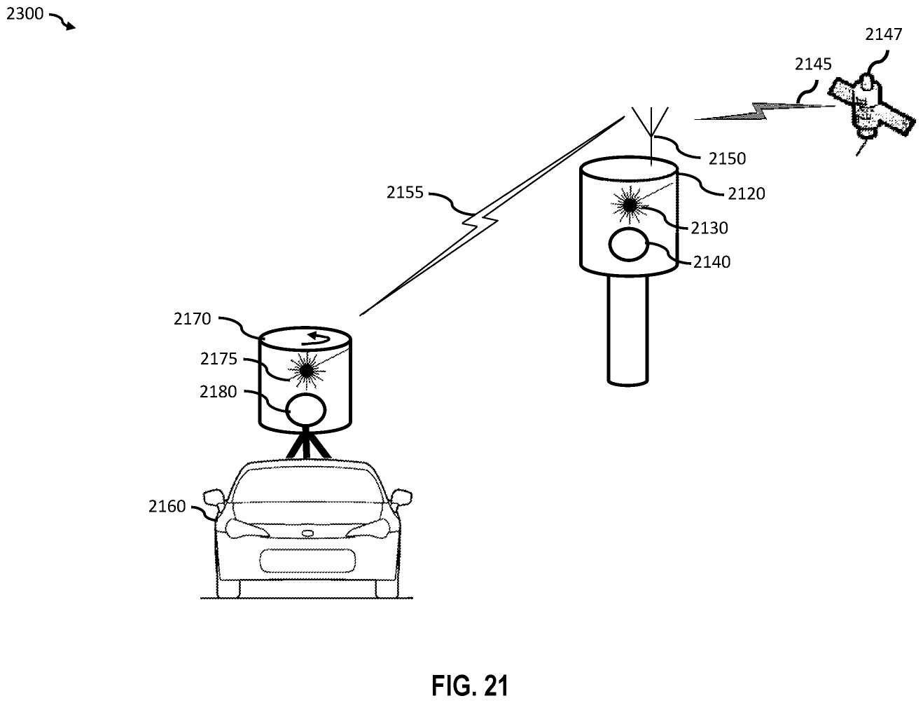

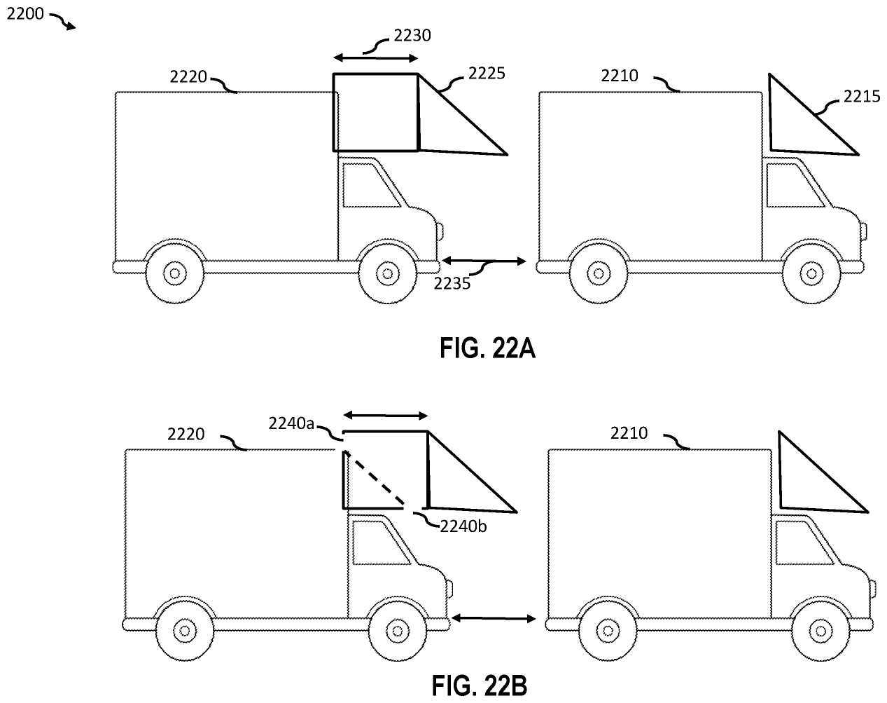

Turning to FIG. 21 a system for augmenting a vehicle based LIDAR with range data from a roadside LIDAR is provided. In one aspect, roadside LIDAR 2120 can be mounted at an intersection or on an overpass and can comprise a laser transmitter 2130 a laser receiver 2140 to perform laser range finding in a local environment (e.g., at an intersection). Roadside LIDAR 2120 can further comprise a transmitter 2150 to transmit range information from the local environment to passing vehicles 2160a and 2160b in signals 2155. For example signals 215 can be RF signals or optical signals and transmitter 2150 can be an RF transmitter or optical transmitter. In one aspect of several embodiments signals 2155 can further comprise location information (e.g., GPS coordinates) indicative of the location of the roadside LIDAR. The location information can be gathered in signals 2145 from satellites 2147 or other localization sources. The location information can also be programmed into the roadside LIDAR upon installation. In one aspect of several embodiments, the location information can enable a passing vehicle 2160a equipped with a LIDAR system 2170 to receive the roadside LIDAR signals 2155 including roadside range data, calculate an offset or transformation for the roadside range data based on the vehicle location and the roadside LIDAR location information, transform the roadside range data based on the offset or calculated transformation and combine the transformed roadside range data with vehicle-based range data from LIDAR 2170.

In a related embodiment a vehicle based laser range finding system 2170 can comprise a receiver to receive roadside range data and roadside LIDAR location data, a processor to transform the Roadside range data to a common origin (e.g., reference point) relative to onboard range data, wherein the transform is based on the roadside LIDAR location information and the vehicle location and finally combine the transformed roadside range data with onboard range data. The transformed roadside range data and the onboard range data can be combined in a single 3D point cloud.

FIG. 22A illustrates a dynamically configurable wind deflector 2225. A lead truck 2210 or vehicle has a wind deflector in a recessed position operable to deflect wind over the trailer of the truck. A drafting truck 2220 or vehicle has a dynamically configurable wind deflector 2225 comprising a movable wind deflector operable to extend from a recessed position (e.g., illustrated by wind deflector 2215) to an extended position 2225. The extended position can be achieved by extending the configurable wind deflector 2225 by a distance 2230 when truck 2220 is drafting a lead truck. The configuration and extension length 2230 can be controlled based on the measured fuel economy of one or both vehicles 2210 and 2220 in order to increase fuel economy. In one aspect airflow from the lead truck can be guided over the drafting truck with less turbulence or wind resistance when the configurable wind deflector is in the extended position, thereby increasing fuel economy. FIG. 22B illustrates a related embodiment whereby the configurable wind deflector has openings 2240a and 2240b to divert airflow from underneath the wind deflector. The extension distance 2220 can be based on observed fuel economy or following distance 2235. The dynamically configurable wind deflector can be controlled by circuitry in the front or rear truck that senses or obtains data indicating one or more aspect of the drafting truck such as following distance 2235 or fuel economy. In one embodiment a system comprises a configurable wind deflector operable to be in a recessed position and an extended position; and circuitry to obtain data indicate of an aspect a first vehicle when the first vehicle is drafting a second vehicle and to reconfigure the configurable wind deflector from the recessed position to the extended position in response to the data. The data can be sensor data indicating the following distance 2235 or fuel economy. The data can be an indication that a first vehicle is drafting the second vehicle.

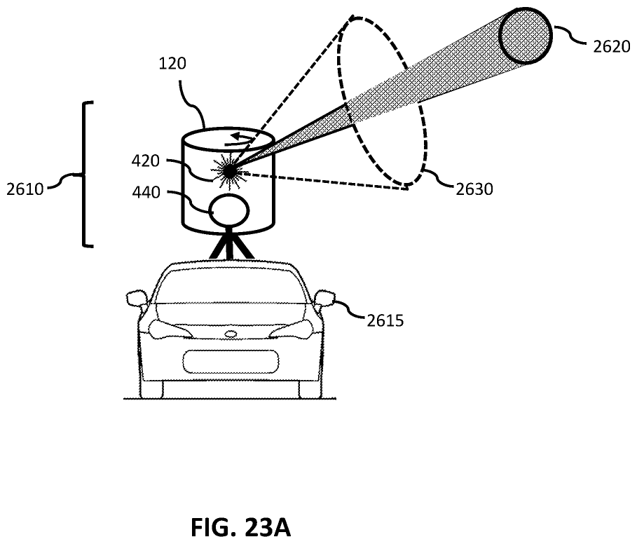

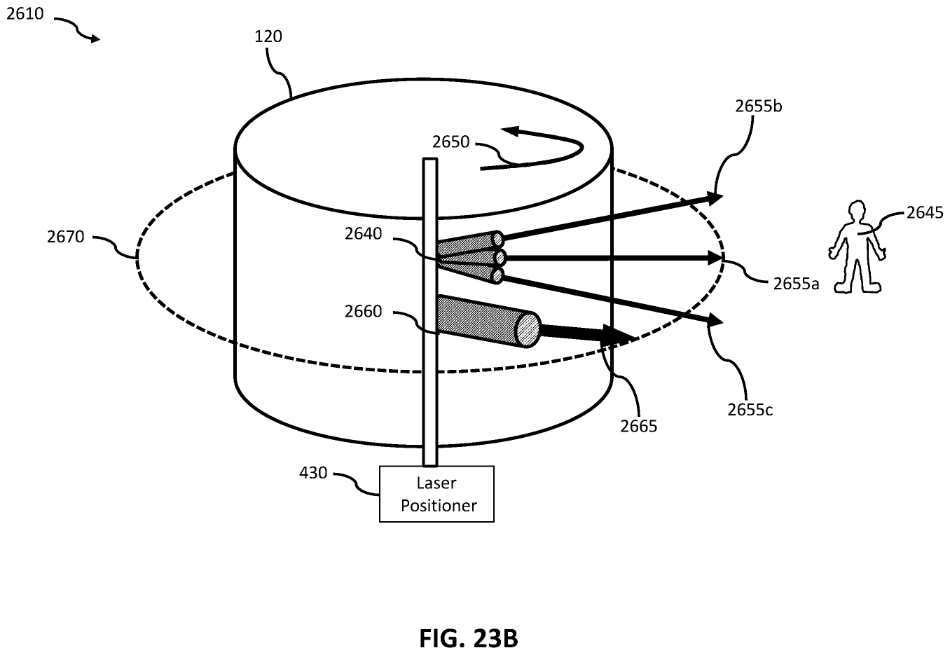

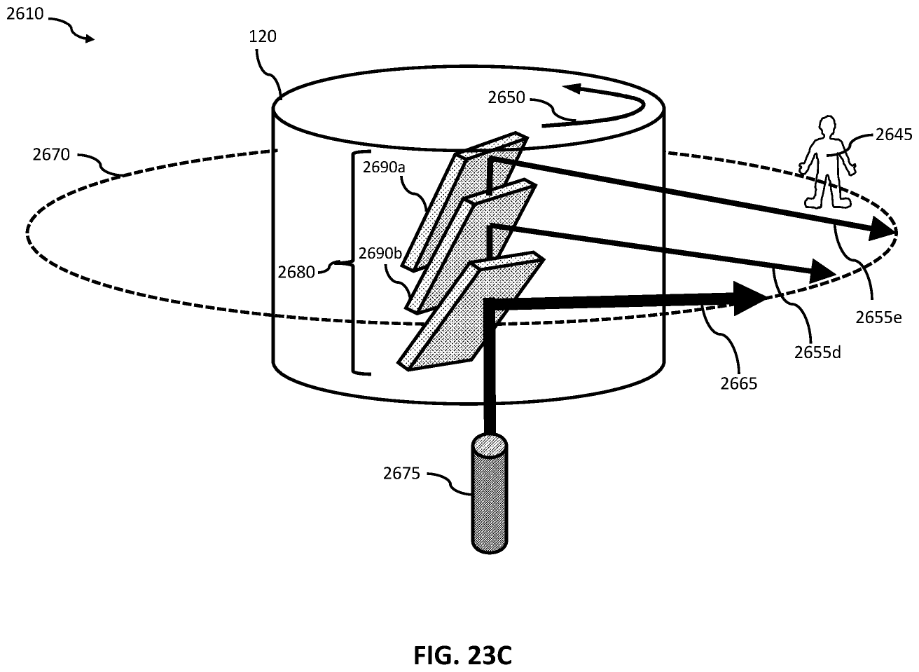

FIG. 23A illustrates a vehicle 2615 with a laser range finder 2610 operable to generate a plurality of laser pulses with variable intensity into the vicinity of the vehicle 2615. In the embodiment of FIG. 23A laser range finder 2610 can comprise a steerable laser assembly 3120 operable to rotate and distribute laser pulses in the surrounding environment. In one aspect, a laser generator 420 in steerable laser assembly 3120 can receive instructions to generate laser pulses of various intensities as the steerable laser assembly rotates. Laser generator 420 and a laser positioner (e.g. 430 in FIG. 4A) can act in combination to generate a high-intensity zone 2620 comprising a set of laser pulses each with an intensity above a threshold intensity. The high-intensity zone can be a discrete zone (e.g. cone shaped) of the vicinity of the laser range finder 2610 through which high-intensity laser pulses travel. In one aspect, laser range finder 2610 can generate a second set of guard laser pulses that occupy a guard zone 2630 around the high-intensity zone 2620. For example, high-intensity laser pulses can have an initial intensity above an eye-safe intensity at the aperture of laser range finder 2610 (e.g. an exit window of the laser range finder). The second set of guard laser pulses can each have an initial intensity below the eye-safe intensity. Reflections from objects in the guard zone and corresponding object distances can function to discontinue the emission of high-intensity laser pulses in the high-intensity zone or cause range finder 2610 to emit lower intensity laser pulses in the high-intensity zone.

FIG. 23B illustrates laser range finder 2610 operable to generate the high-intensity zone 2620 and guard zone 2630 of FIG. 23A. Laser range finder 2610 can comprise a laser positioner (e.g. an induction motor) to rotate or otherwise position one or more guard laser generators 2640. In the embodiment of FIG. 23B laser positioner 430 can rotate steerable laser assembly 3120 counter-clockwise in direction 2650. Guard laser generators 2640 are positioned to generate guard laser pulses (e.g. 2655a, 2655b and 2655c) that precede the path of high-intensity laser generator 2660 operable to generate high-intensity laser pulses (e.g. laser pulse 2665). Reflections from guard laser pulses (e.g. 2655a-c) can function to detect person 2645 before high-intensity laser pulses are launched in the direction of person 2645. For example, laser positioner 430 can rotate steerable laser assembly 3120 at 10 Hz and high-intensity laser generator 2660 can be positioned 90 degrees (e.g. one quarter rotation) behind the guard laser generators 2640. In this example, guard laser pulses are generated 25 milliseconds before high-intensity laser pulses are launched in the equivalent direction. Detection of person 2645 in the path of the high-intensity beam can be used to determine the intensity of laser pulses from laser generator 2660. For example, laser generator 2660 can be instructed to discontinue generator or to decrease the intensity of laser pulses to coincide with the direction of person 2645. Laser generator 2660 can generate high-intensity laser pulses in some or all of azimuthal plane 2670. Some of the guard pulses can be on the same azimuthal plane as high-intensity pulses (e.g. guard pulse 2655a with the same elevation angle as high-intensity laser pulses 2665), while other guard laser pulses can have higher or lower elevation angles (e.g. laser pulses 2655b and 2655c), thereby providing early indication of objects that could stray into the path of high-intensity laser pulses (e.g. 2665) by moving up or down in elevation to enter the azimuthal plane of high intensity laser pulses.

FIG. 23C illustrates another embodiment of a mechanically steered laser range finder 2610 operable to generate a set of guard laser pulses that precede and form a basis for modulating the intensity of high-intensity laser pulses or variable intensity laser pulses. In FIG. 23C a mirror assembly 2680 comprising one or more mirrors (2690a and 2690b) works in combination with a variable intensity laser generator 2675. Laser generator 2675 can generate a first set of guard laser pulses (2655d and 2655e) that are deflected by the mirror assembly 2680 to perform laser ranging ahead of a set high-intensity laser pulses (e.g. 2665). For example, mirror assembly 2680 can comprise a plurality of electrically switchable mirrors (e.g. switchable mirrors from the e-Transflector.TM. product line available from Kent Optronics of Hopewell Junction, N.Y.) Alternatively, a mirror in mirror assembly 2680 can be an imperfect mirror and deflect a high-intensity laser pulse 2665 while transmitting some of the laser light or laser pulses to mirrors 2690a and 2690b positioned to generate guard laser pulses 2655d and 2655e that spatially precede the high-intensity laser pulse 2665. Upon detection of an object (e.g. person 2645) by guard laser pulses, subsequent high-intensity laser pulses can be attenuated or discontinued. Mirrors 2690a and 2690b or reflectors that generate guard laser pulses can be repositionable to cause guard laser pulses to precede adaptive-intensity laser pulses (e.g. pulses 2665) by a variable amount (e.g. guard laser pulses leading high intensity laser pulses by 30-60 degrees in the azimuthal plane 2670).

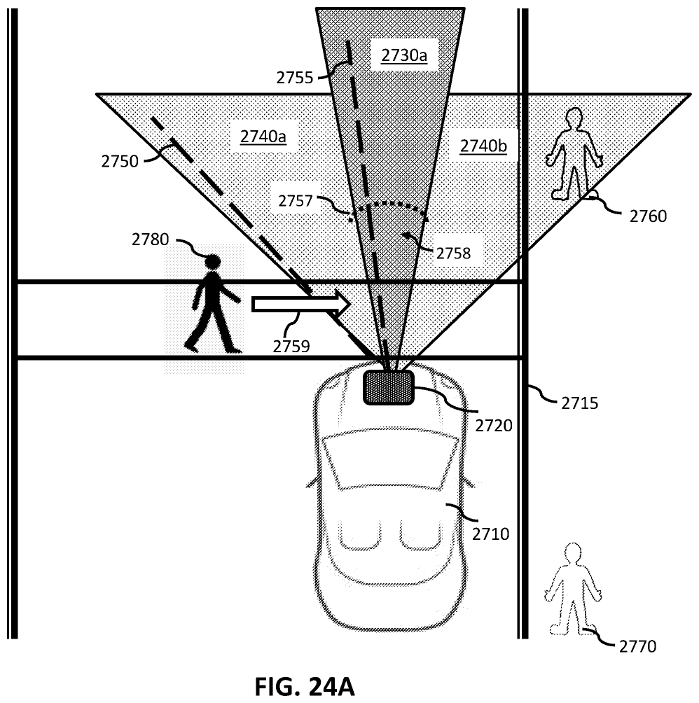

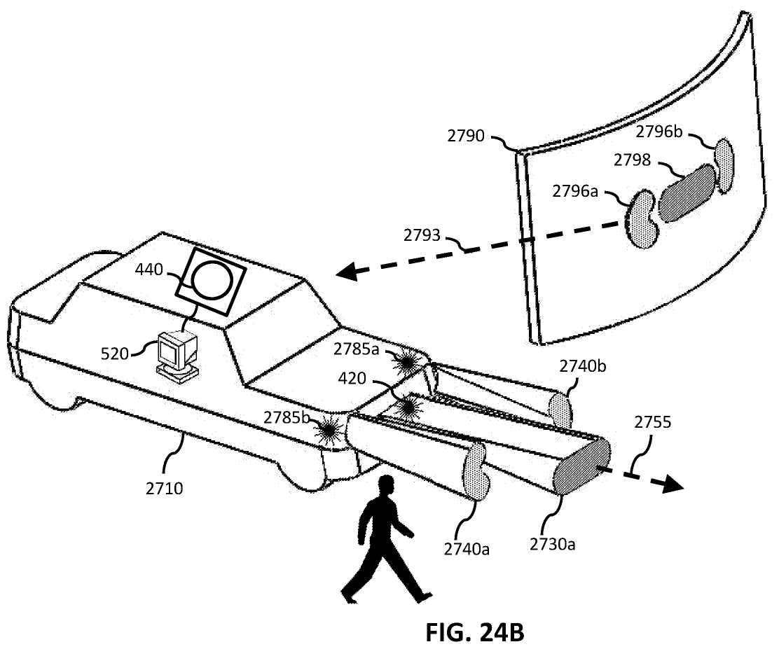

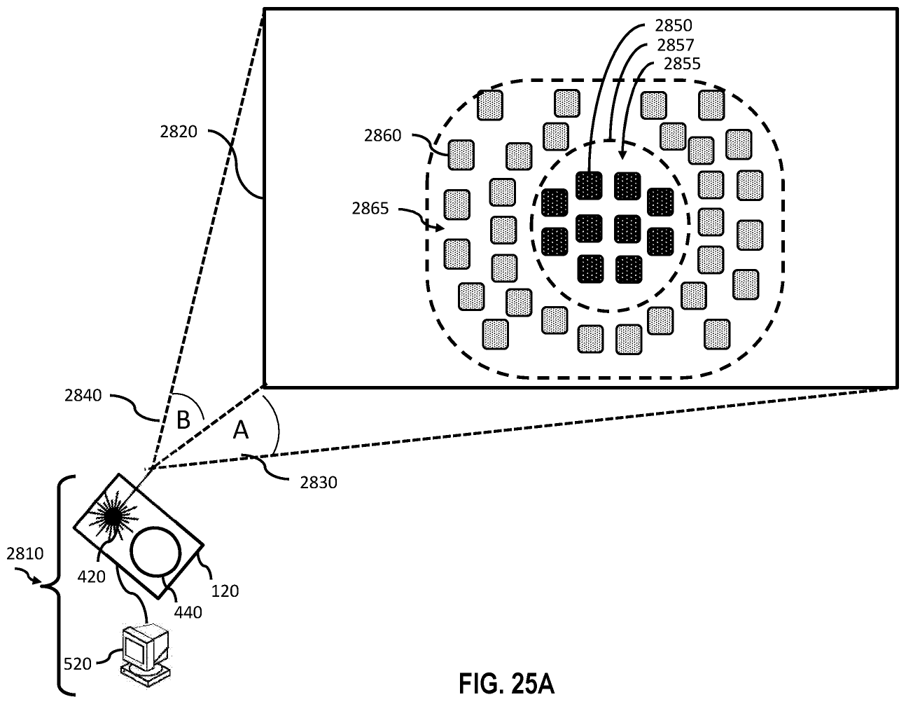

FIG. 24A illustrates a vehicle mounted laser range finder 2720 that uses data from laser pulses in two guard zones to protect objects and people from high-intensity laser pulses in a high-intensity zone. An objective of laser range finder 2720 can be to generate high-intensity laser pulses in a high-intensity zone (e.g. the volume of the vicinity in which laser pulses from a high-intensity region of the FOV travel) contingent on data indicating that a portion of the high-intensity zone (e.g. a keepout zone) is free from objects or imminent ingress by objects. For the purpose of this disclosure a keepout zone can be considered a region of space in the vicinity of a laser range finder in which the intensity of laser pulses is above a corresponding threshold intensity.

Laser range finder 2720 is designed to address several challenges associated with safely generating a set of high-intensity laser pulses. One challenge is to diminish laser intensity and thereby eliminate the keepout zone 2758 before a person 2780 reaches the keepout zone. A related challenge is to increase the accuracy of indications of future ingress into a keepout zone, thereby decreasing the number of false positive ingress indications. For example, the challenge of false positive ingress indications can be to differentiate person 2780 on a trajectory that intersects the keepout zone from person 2770 who is in the vicinity of the vehicle 2710 but not in imminent danger of entering the keepout zone. Similarly person 2760 who is adjacent to the keepout zone (or perhaps at a distance beyond the keepout zone) but has a trajectory that will pass to one side of the keepout zone as vehicle 2710 moves down street 2715.

Previous solutions were to monitor for objects in the keepout-zone and discontinue laser pulses upon detection of a person. A disadvantage of this approach is that person 2780 is irradiated with high-intensity laser pulses for as long as it takes laser range finder 2720 to discover the presence of person 2780.

Turning in detail to the embodiment of FIG. 24A laser range finder 2720 is mounted to the front of vehicle 2710 and can be a solid state electronically steered LIDAR (e.g. the model S3 available for Quanergy Inc. or Sunnyvale, Calif.). Laser range finder 2720 generates a set of high-intensity laser pulses 2755 in a high-intensity zone 2730a, each with an initial intensity above a threshold intensity. Laser pulses 2755 have a corresponding beam divergence and therefore the intensity diminishes as they travel from the laser range finder. The intensity of laser pulses 2755 can remain above an eye-safe intensity threshold out to a threshold distance 2757.

The range of directions comprising the high-intensity zone 2730a combined with the threshold distance can define a keep-out zone 2758.

Laser range finder 2720 further generates a guard set of laser pulses (e.g. pulses 2750), each with an intensity below the threshold intensity in two guard zones 2740a and 2740b. The guard zones 2740a and 2740b are positioned on either side of the high-intensity zone, thereby providing that a large number of potential ingress trajectories (e.g. trajectory 2759) into the keep-out zone require an object to first travel through a guard zone. Laser range finder 2720 can contain a detector and a processing subassembly (e.g. processing subassembly 520 and detector 440 in FIG. 5A). The detector can detect a set of laser reflections from the guard set of laser pulses in the guard zones (e.g. pulses 2750) and thereby generate reflection data indicative of the range to objects in the guard zones. Processing subassembly can process the reflection data, and can instruct a laser generator (e.g. 420 in FIG. 5A) to continue or discontinue high-intensity laser pulses or attenuate laser pulses based on identifying aspects of objects in the guard regions. Exemplary aspects can be presence of an object, trajectory of an object or range to an object, such as placement of an object within a threshold distance.

In several aspects the guard laser pulses and guard zones can provide sufficient time to analyze objects for potential future ingress into a high-intensity zone. This is useful because many objects can naturally move in a trajectory away from the high-intensity regions during monitoring the in guard zone. The guard zones can be sized to provide sufficient reaction time to determine aspects (e.g. trajectory) of objects. In one aspect, as vehicle 2710 drives down street 2715 person 2760 may appear in guard region. Person 2760 can be standing on a footpath beside street 2715. The guard region and associated reflection data can provide basis to determine the person 2760 is proceeding towards the right side of guard region 2740b, and hence is not on a collision course with keep-out zone 2758. In another aspect, a processing subassembly in laser range finder 2720 can process reflection data from the guard regions and identify that person 2780 is on a collision course with the keepout region. In one aspect a guard zone can be a region of space, adjoining a high-intensity zone, through which guard laser pulses travel, such that reflections from the guard laser pulses are operable to control the intensity of laser pulses in the adjoining high-intensity zone. Guard zones can be defined as the volume of space in which guard laser pulses are operable to provide reflections that can control at least in part the intensity of subsequent laser pulses in a high-intensity zone. In the embodiment of FIG. 24A the guard zones have a range of azimuthal angles that extend beyond the range of azimuthal angles of the high-intensity zone, thereby providing that a person 2780 on a trajectory 2759 must enter a guard zone before entering the high-intensity zone.

FIG. 24B illustrates a vehicle mounted bistatic laser range finder operating according to an embodiment of the present technology. In a bistatic laser range finder the detector 440 is located some distance from the laser generators. An objective of the bistatic laser range finder 2720 can be to generate high-intensity laser pulses in a high-intensity zone (e.g. comprising a well-defined set of directions) contingent on data indicating that a portion of the high-intensity zone (e.g. a keepout zone) is free from objects or imminent ingress by objects using lower-intensity laser pulses in the high-intensity zone. In the embodiment of FIG. 24B a main laser generator 420 is mounted on vehicle 2710 separate from detector 440. For example, main laser generator 420 can be located behind the front grille of vehicle 2710 and detector 440 can be located on the roof or behind the windshield. Main laser generator 420 can initially generate high-intensity laser pulses 2755 in region 2730a of the vicinity of vehicle 2710. The bistatic laser range finder also comprises two dedicated guard laser generators 2785a and 2785b laser generators separate from the main laser generator. Guard laser generators 2785a and 2785b can be dedicated to generating guard laser pulses below a threshold intensity in regions 2740a and 2740b. Reflections from guard laser pulses (e.g. reflection 2793) can occupy guard regions 2796a and 2796b of the detector FOV 2790. The detector 440 can detect a set of reflections (e.g. reflection 2793) corresponding to laser pulses in the guard zones of the vicinity. For example, the detector can be configured to generate reflection data from reflections corresponding to the guard laser pulses. Reflections from guard laser pulses can be recognized based on aspects of the laser light, time correlation with transmitted guard laser pulses or association with regions 2796a and 2796b of the detector FOV. Detector 440 can be operable coupled to a processing subassembly 520 and can transmit reflection data from reflections corresponding to the set of guard pulses to the processing subassembly. In various embodiments the processing subassembly can instruct the main laser generator to discontinue or reduce the intensity of laser pulses in the adaptive-intensity region 2798 of detector FOV 2790 (e.g. corresponding to high-intensity zone 2730a) based on sensing an object in a guard region (e.g. 2796a) of the FOV, or based on the result of a safety test performed on the reflection data. Guard laser generators 2785a and 2785b can be laser diodes that progressively scan in zones 2740a and 2740b or flash laser diodes that illuminate all of the guard zones at once. For example, detector 440 can be an array of charge coupled devices or avalanche photo diodes operable to gather data from the entire guard region 2796a and 2796b simultaneously in response to guard laser diodes emitting a laser flash in the guard zones 2740a and 2740b. The shape of the guard zones can be defined in part by a mask placed in front of the guard laser generators. The guard laser generators can be incorporated into a headlight assembly, behind a vehicle grille or behind a windshield.

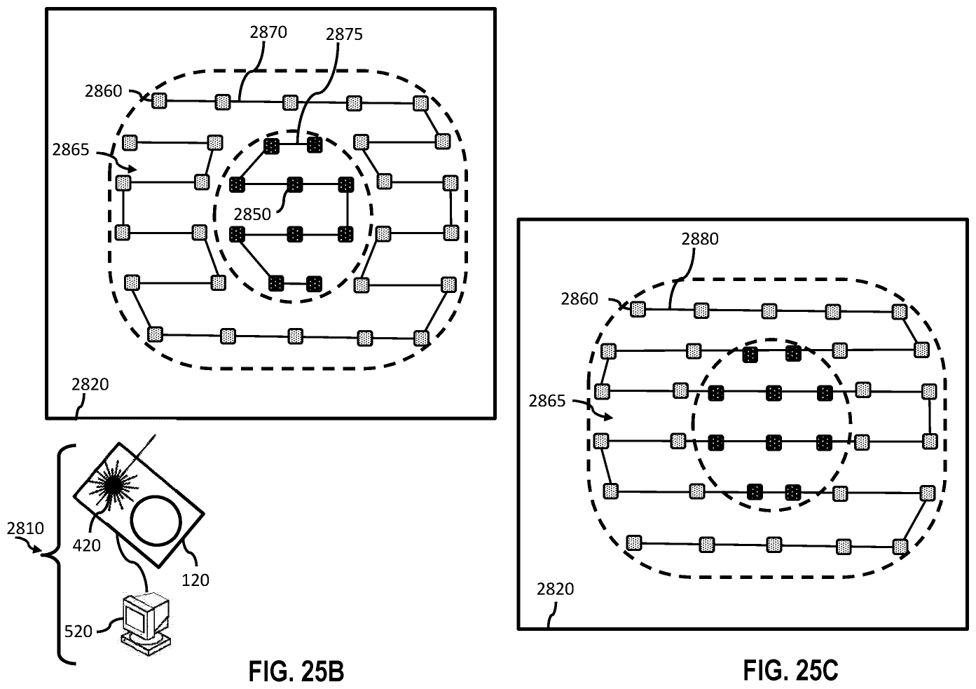

FIG. 25A illustrates a laser range finder 2810 according to an embodiment of the present disclosure having a FOV 2820 comprising a range of azimuthal angles 2830 and a range of elevation angles 2840. Laser range finder 2810 generates a set of high-intensity laser pulses (e.g. pulse 2850) in an adaptive-intensity region 2855 of the FOV. Adaptive-intensity region 2855 can comprise a perimeter 2857 encompassing the set of high-intensity laser pulses. In one embodiment the perimeter can be a minimum perimeter defined as the smallest possible enclosed shape in the FOV that fully encloses the set of high-intensity laser pulses. Each of the set of high-intensity laser pulses can have an initial laser intensity at the aperture (e.g. exit) of the laser range finder 2810 that is above a threshold value (e.g. a threshold intensity of 1 W/cm²). Laser range finder 2810 generates a set of guard laser pulses (e.g. laser pulse 2860) with directions encompassed by a guard region 2865 in the FOV. In the embodiment of FIG. 25A guard region 2865 surrounds the entire exterior perimeter 2857 of the adaptive-intensity region 2855. Each laser pulse in the set of high-intensity laser pulses can have an initial laser intensity at the aperture (e.g. exit) of the laser range finder 2810 that is below the threshold value. In the embodiment of FIG. 25A upon generation of the set of high-intensity laser pulses in the adaptive-intensity region and the surrounding guard set laser pulses, subsequent laser pulses in the adaptive-intensity region can have intensity dependent aspects of reflections form the guard region of the FOV. In one embodiment guard region 2865 can be mutually exclusive from adaptive-intensity region 2855 such that the two regions occupy non-overlapping sets of directions in the FOV 2820.

FIG. 25B and FIG. 25C illustrate two method to generate the high-intensity and guard laser pulses with appropriate placement to ensure safe operation in accordance with embodiments of the present disclosure. In FIG. 25B a steerable laser assembly in laser range finder 2810 dynamically steers at least one laser beam in a complex pattern along path 2870 in FOV 2820 to generate the guard set of laser pulses (e.g. laser pulse 2860). Simultaneously, or subsequently the steerable laser assembly can steer a laser beam along path 2875 to generate high-intensity laser pulses (e.g. laser pulse 2850). In this way steerable laser assembly 3120 can generate a pattern of laser pulses in FOV 2820 with a bimodal distribution of laser pulse intensities forming an adaptive-intensity region and a protective guard region.

In FIG. 25C steerable laser assembly 3120 can dynamically steer a laser beam along a single path 2880 with dynamically varying laser intensity and thereby generate the high-intensity pulses and the guard pulse in the course of a single scan.

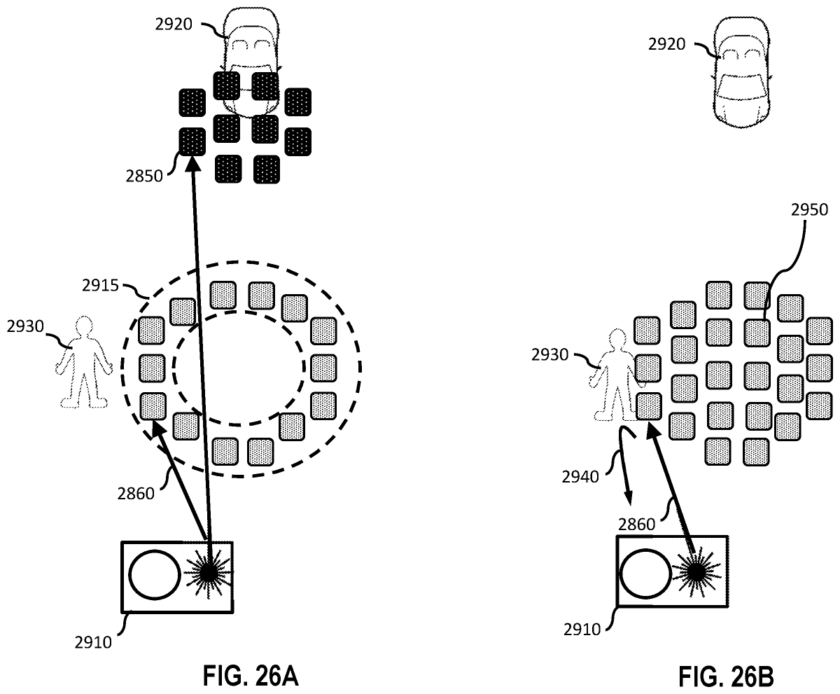

FIG. 26A illustrates an embodiment wherein a laser range finder 2910 generates a set of high-intensity laser pulses (e.g. pulse 2850) operable to perform ranging at a further distance than an encompassing guard set of laser pulses (e.g. laser pulse 2860). For example, the high-intensity laser pulses are operable to provide detectable reflections from vehicle 2920, while reflections form guard laser pulses (e.g. pulse 2860) are operable to ensure that person 2930 does not ingress into the path of the high-intensity laser pulses. In the embodiment of FIG. 26A the guard set laser pulses encircle the high-intensity pulses, such that an area 2915 substantially perpendicular to the direction of travel of the guard laser pulses and containing the guard laser pulses also encompasses the high-intensity laser pulses. FIG. 26B illustrates the operation of laser range finder 2910 according to an embodiment of the present disclosure. Following the generation of high-intensity laser pulses and guard laser pulses, reflections (e.g. 2940) from one or more guard laser pulses in area 2915 can indicate the presence of person 2930 and laser range finder 2910 can respond by discontinuing the high-intensity laser pulses and instead generate lower intensity eye-safe laser pulses (e.g. 2950). Therefore laser range finder 2910 can use the guard area 2915 to detect person 2930 without subjecting person 930 to high-intensity laser pulses. In the embodiment of FIG. 26B laser range finder 910 reduces the intensity of laser pulses in the adaptive-intensity set of directions based on the presence of person 2930.

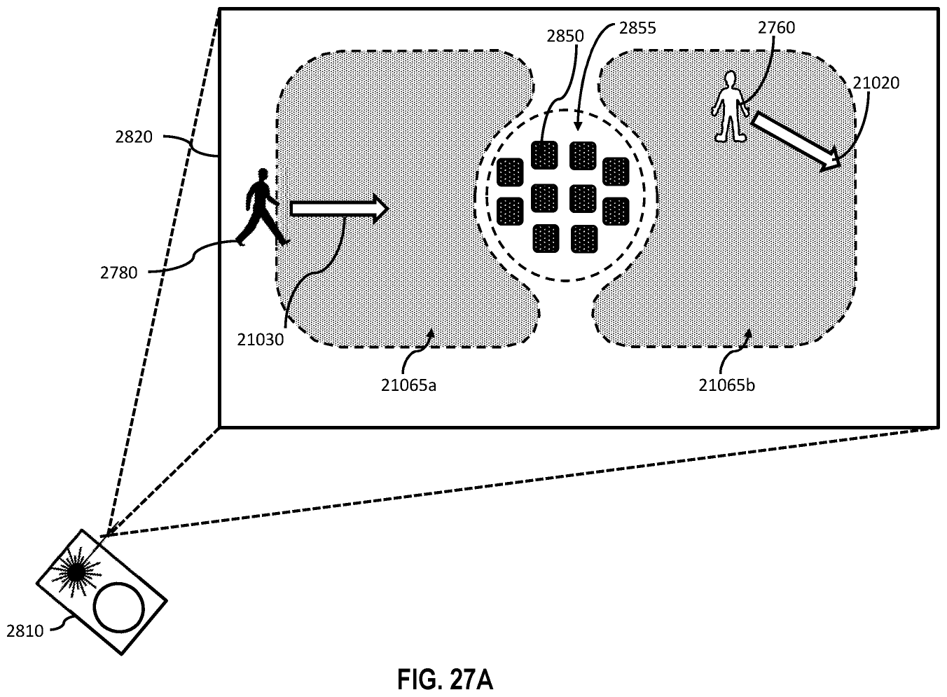

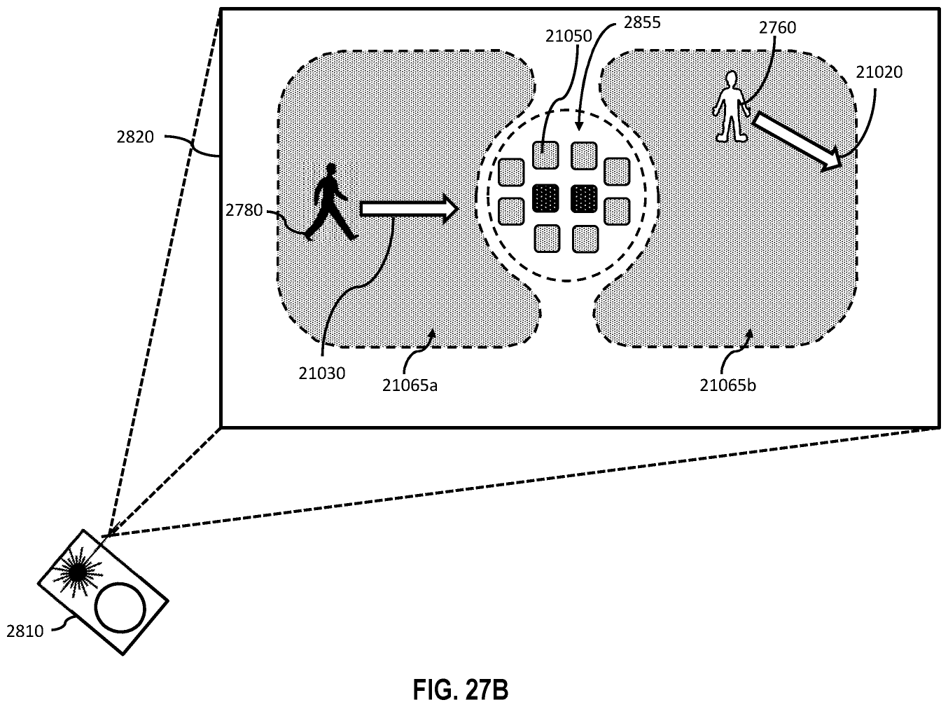

FIGS. 27A and 27B illustrate an embodiment whereby a laser range finder uses guard regions to anticipate or determine the trajectory of an object or person and thereby select the intensity of laser pulses in an adaptive-intensity region of a FOV. In one aspect, using low intensity laser pulses (e.g. eye-safe laser pulses) to encompass one or more trajectories towards an adaptive-intensity region, provides time to determine the trajectory of an object or person. This is important because often objects in guard regions may naturally have a trajectory away from the adaptive-intensity region. In this way embodiments of the present disclosure provide an eye-safe system and method to predict future ingress of object into the adaptive-intensity region while limiting false positive warnings. In this way embodiments can provide for a more complex safety test based on reflection data from a low-intensity set of guard laser pulses, instead of mere object detection.

Turning to FIG. 27A, laser range finder 2810 can generate a set of high-intensity laser pulses (e.g. pulse 2850) within an adaptive-intensity region of a FOV 2820. Laser range finder 2810 can further generate a guard set of lower intensity laser pulses in one or more guard regions 21065a and 21065b. The guard regions (e.g. 21065a and 21065b) can encompass at least some of the perimeter of the adaptive-intensity region, thereby providing that objects (e.g. person 2780) on one of several trajectories (e.g. trajectory 21030) must first pass through a guard region before entering the adaptive-intensity region. In the embodiment of FIG. 27A important locations for guard regions can be on either side of adaptive-intensity region 2855. Portions of the FOV directly above or below the adaptive-intensity region may not be encompasses be a guard region, since these represent less likely path for people to travel towards the adaptive-intensity region. In the embodiment of FIG. 27A person 2760 and their associated trajectory 21020 can be determined based on one or more sets of laser pulses in the guard regions 21065a and 21065b. It can be determined that person 2760 with trajectory 21020 moves towards the right and thereby avoids adaptive-intensity region 2855.

In FIG. 27B laser range finder 2810 can determine the person 2780 has a trajectory 21030 that will intersect the adaptive-intensity region. In the embodiment of FIG. 27B laser range finder 2810 can react by reducing the intensity of some or all of the laser pulses subsequently generated in the adaptive-intensity region (e.g. laser pulse 21050).

FIG. 27B further illustrates that laser range finder 2810 can modify the angular range of subsequent high-intensity laser pulses, relative to the original angular range of high-intensity laser pulses (e.g. in region 2850 of FIG. 27A), in response to sensing an object (e.g. person 2780) or an aspect of an object using laser reflections form guard laser pulses. In response to sensing, detecting or identifying an object or an aspect of an object using laser reflections from the guard set of laser pulses laser range finder 2810 can change the size, shape or angular range of a subsequent set of high-intensity laser pulses. For example, FIG. 27A illustrates that an initial set of high intensity laser pulses illustrated by dark squares (e.g. laser pulse 2850) in adaptive-intensity region 2855, can occupy an angular range (e.g. a 2-D angular range of directions) in field of view 2820. In response to sensing an aspect of person 2780 (e.g. their trajectory 21030), using laser reflections form the guard set of laser pulses, laser range finder 2810 can modify the angular range of directions (e.g. 2-D angular range), of subsequent high intensity laser pulses or bounds of associated high-intensity region(s). FIG. 27B illustrates a second smaller set of high-intensity laser pulses (indicated by the smaller region of dark squares in the center of the adaptive-intensity region 2855) generated in response to detecting an aspect of person 2780 using laser reflections in the guard region. In one aspect FIGS. 27A and 27B illustrate that laser range finder 2810 can reduce the intensity (e.g. below a threshold intensity) for some laser pulses (e.g. laser pulse 21050) in directions or regions of the FOV 2820 previously occupied by high intensity laser pulses (e.g. laser pulse 2850) in response to detecting an aspect of an object (e.g. trajectory of person 2780) using laser reflections form a guard region. In one embodiment, a method comprising generating a first set of high-intensity laser pulses having a first range of directions in a field of view, each with an intensity above a threshold intensity; generating a guard set of laser pulses each with an intensity below the threshold intensity; and in response to detecting an aspect of an object using laser reflections from the guard set of laser pulses, generating a second set of high-intensity laser pulses, each with an intensity above the threshold intensity, having a second range of directions that is different than the first range of directions.

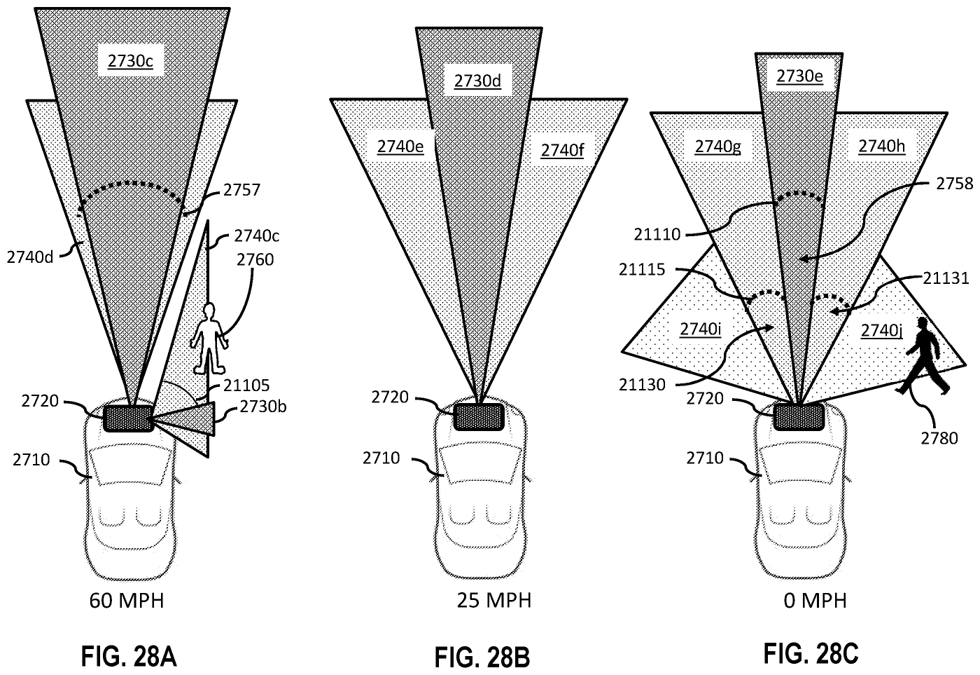

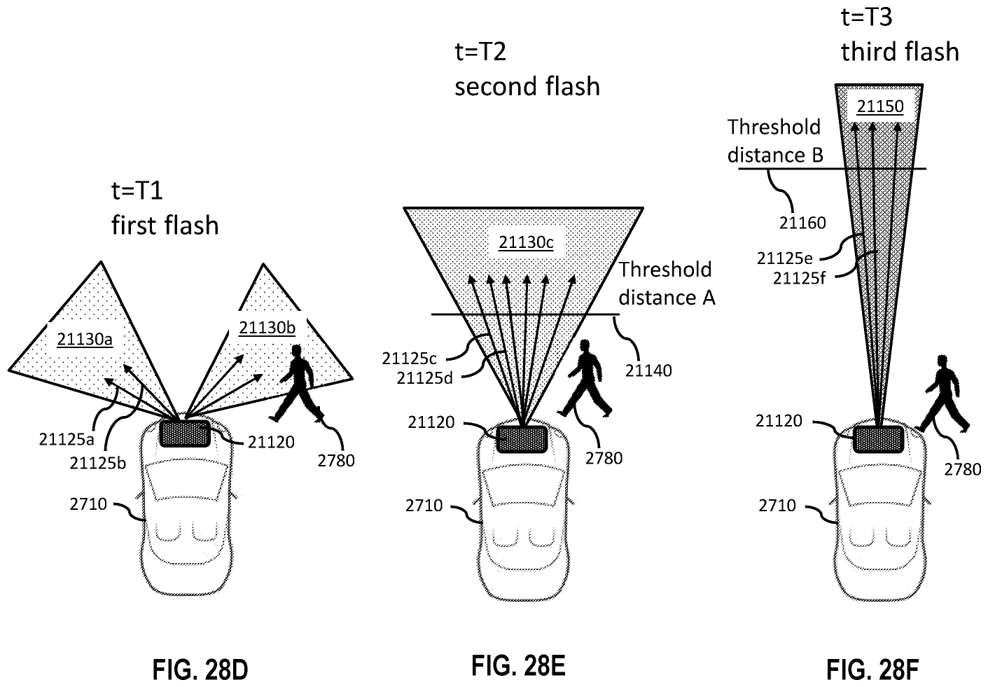

FIGS. 28A-C illustrate embodiments of a laser range finder that adapts the range of angles devoted to high-intensity laser pulses and associated guard zones based in part on the speed of a vehicle. In FIG. 28A vehicle 2710 is travelling at 60 MPH and contains laser range finder 2720. It can be appreciated that as the vehicle 2710 drives forward a common relative trajectory is to pass beside people (e.g. person 2760) resulting in a brief period of time where person 2760 is beside vehicle 715. Therefore high-intensity laser pulses transmitted laterally (e.g. in high-intensity zone 2730b) can require protection with a wide guard zone 2740c. Guard zone 2740c can be sized to provide sufficient time to identify and react to person 2760 or identify and react to objects in general. Laser range finder 2720 can generate guard zone 2740c by generating a corresponding guard set of laser pulses in a guard region of the FOV with an angular range based in part on the direction of travel of the vehicle. Guard zone 2740c can be generated with a set of low-intensity laser pulses (e.g. relative to high-intensity laser pulses in zone 2730b) having an angular range that is based at least in part on the vehicle speed. For example, high-intensity zone 2730b can have a threshold distance of 2 meters (e.g. before the intensity drops below a threshold intensity). Based on the speed of vehicle 2710 laser range finder 2720 can generate a guard zone sufficient to identify objects moving towards the keepout zone corresponding to the 2 meter threshold distance within high-intensity zone 2730b. For example, consider that laser range finder 2720 requires 250 milliseconds to detect person 2760 moving towards the high-intensity laser pulses in zone 2730b and react to diminish the intensity of subsequent laser pulses. At 60 MPH vehicle 2710 moves forward 6.7 meters in 250 milliseconds. Therefore guard zone 2740c would need to extend at least 6.7 meters in front of the high-intensity zone 2730b in the direction of travel at a distance of 2 meters lateral to the vehicle. This results in some angular range 1105 for guard region 2740c in the FOV of range finder 2720 (e.g. 73 degrees in the above example) that can increase with the forward speed of vehicle 2710.

High-intensity zone 2730c in front of vehicle 2710 can also be protected by a guard zone 2740d that is dependent on the speed of the vehicle. For example, consider laser range finder 2720 generating high-intensity laser pulses in zone 2730c while traveling at 60 MPH on vehicle 2710. The high-intensity laser pulses can remain above a threshold intensity out to a threshold distance from laser range finder 2720, thereby generating keepout zone 2758 within the high-intensity zone 2730c. The probability of lateral intrusion into keepout-zone 2758 changes with vehicle speed. In many cases to probability of intrusion is small because vehicle 2710 would likely strike objects in the keepout zone 2758 at 60 MPH. Hence the angular range of forward facing guard regions can decrease as vehicle speed increases.

FIG. 28B illustrates that at reduced vehicle speed (e.g. 25 MPH) the probability of lateral intrusion into a forward facing high-intensity zone increases and the guard zones 2740e and 2740f can be expanded to provide increased detection time (e.g. the angular range of 2740e in the FOV of laser range finder 2720 is increased relative to 2740d). Similarly, the angular range of high-intensity zone 2730d can be smaller than the angular range of zone 2730c.

FIG. 28C illustrates an embodiment where a laser range finder 2720 generates a high-intensity set of laser pulses based in part on satisfying a safety test by reflection data from a plurality of laser reflections in a plurality of guard zones 2740g, 2740h, 2740i and 2740j. The high-intensity zone 2730e contains a set of laser pulses, each with an initial intensity above a threshold intensity. The intensity of the high-intensity laser pulses can remain above an eye-safe intensity out to a threshold distance 21110. Laser range finder 2720 can generate lower intensity laser pulses in guard zones 2740g and 2740h located beside adaptive-intensity region 2730e, each lower intensity laser pulse having initial intensity below the threshold intensity and above a second threshold intensity. In practical implementations even the guard regions 2740g and 2740h can exceed an eye-safe intensity if a person (e.g. person 2780) were to walk into zone 2740g and 2740h at close range (e.g. eye-safe threshold distance 21115<1 m) to the generation source.

Hence even the guard regions 2740g and 2740h can have a threshold distance beyond which the lower laser intensity satisfied a safety criterion (e.g. an eye-safety criterion). In the embodiment of FIG. 28C laser range finder 2720 generates very-low intensity laser pulses, each with an intensity below the second threshold intensity in guard zones 2740i and 2740j. The operation of the embodiment of FIG. 28C can be as follows: guard zones 2740g and 2740h can act to prevent unannounced lateral intrusion into keepout zone 2758. Upon detecting a person or object in guard zone 2740g or 2740h, laser range finder 2720 can discontinue or decrease the intensity of laser pulses in the high-intensity zone 2730e. In turn, guard zones 2740i and 2740j (e.g. resulting from laser pulses with directions in guard regions of the FOV) can protect people and objects form unannounced lateral intrusion into secondary keepout zones 21130 and 21131. In a related embodiment a laser range finder can generate laser pulses in a FOV with decreasing intensity towards the edge of the FOV, where objects are likely to enter from. In respond to detecting an object entering from an edge of the FOV the laser range finder can decrease the intensity of laser pulses in portions of the FOV thereby adapting the intensities to the objects location or trajectory. In another aspect the size and shape of guard regions in the FOV can be based on the steering angle (e.g. 20 degrees left, right or straight) of the vehicle 2710. For example, when vehicle 2710 steers to the right, guard zones (e.g. 2740f) can be adapted to provide a larger range of coverage angles to the right of vehicle 2710, thereby effectively scanning the future path of subsequent high intensity laser pulses as the high-intensity region pans to the right.

In the embodiments of FIGS. 28A-C laser range finder 2720 can scan a laser beam, using a steerable laser assembly (e.g. 120 in FIG. 5A) to generate the high-intensity zones and guard zones. In alternative embodiments laser range finder 2720 can dynamically steer the steerable laser assembly using laser steering parameters (e.g. instructions to position a laser positioner and select a power level) and thereby generate complex patterns of laser pulses with varying intensity.

FIGS. 28D-F illustrates an embodiment in which a flash LIDAR generates laser pulses in a plurality of directions at once with multidirectional laser flashes. In the embodiment of FIGS. 28D-F a flash laser range finder (e.g. similar to the TigerEye Lidar available from Advanced Scientific Concepts Inc. of Santa Barbara, CA) can generate laser flashes in a plurality of zones and with various intensities. In FIG. 28D laser range finder 21120 can begin by generating a first laser flash in a plurality of directions (e.g. 21125a and 21125b) with an intensity at or below a first threshold, thereby forming guard zones 1130a and 1130b. The first guard zones can extend towards the edge of the FOV of laser range finder 21120, thereby operating to identify objects moving into the FOV from an edge. In FIG. 28E laser reflections from objects (e.g. person 2780) can be used to determine the intensity or angular range for a second laser flash in zone 1130c. The second laser flash (e.g. in directions 21125c and 21125d) can have a higher laser intensity than the first laser flash and may have a threshold distance 21140 beyond which the laser intensity drops below a safety threshold. One advantage of this approach is that reflections from the first flash can act to guard against unannounced intrusion into the path of the second flash within the threshold distance 21140.

Laser reflections from the second flash can be used to determine the intensity or angular range for a third laser flash in zone 1150 in FIG. 28F. The third laser flash (e.g. in directions 21125e and 21125f) can have a higher intensity than the second laser flash and may have a threshold distance 21160 beyond which the laser intensity drops below a safety threshold. One advantage of this approach is that reflections from the second flash can act to guard against unannounced intrusion into the path of the third flash within the threshold distance 21160. FIG. 28D-F illustrate a method for generating laser flashes below a threshold intensity in order to guard against unwanted intrusion of an object into the path of a subsequent laser flash above the threshold intensity. In the case where a person or object is detected by one of the laser flashes in the guard regions the intensity of the laser flash in an adaptive-intensity region of the FOV, corresponding to high-intensity zone 1130 can be reduced to below the threshold intensity.

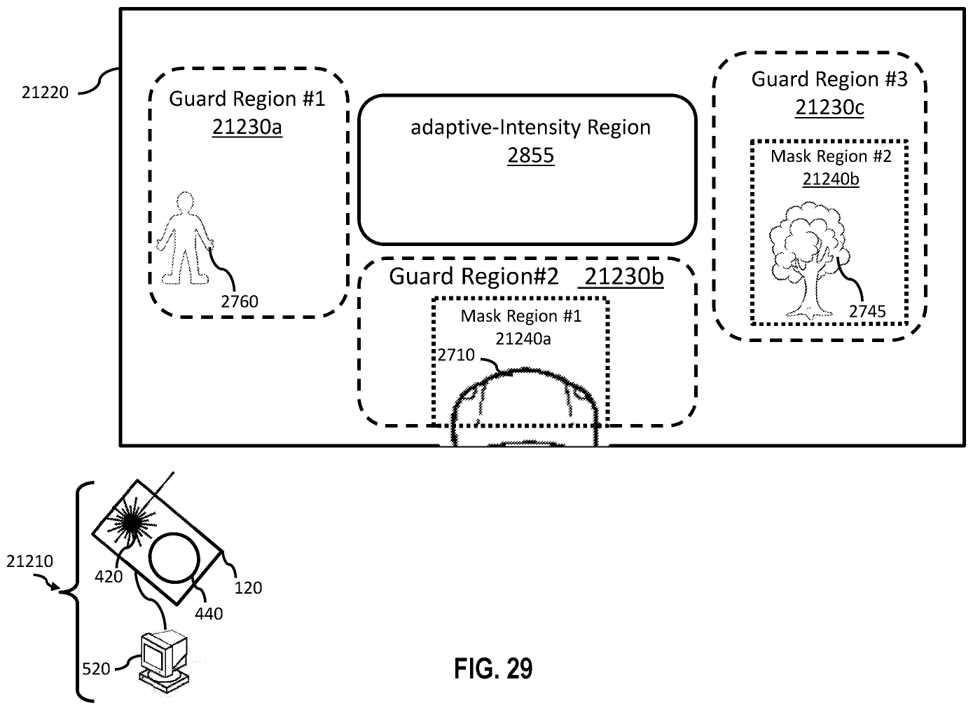

FIG. 29 illustrates an exemplary FOV for a laser range finder 21210, according to an embodiment of the present disclosure. In the embodiment of FIG. 29 laser range finder 21210 can comprise a steerable laser assembly 120 and a processing subassembly 520. Steerable laser assembly 3120 can receive laser steering parameters (e.g. instructions regarding placement of laser pulses) from processing subassembly 520 and thereby generate a complex pattern of laser pulses in FOV 21220. Detector 440 in steerable laser assembly 3120 can detect a set of laser reflections from FOV 21220 and processing subassembly 520 can process those laser reflections to determine the subsequent intensity of laser pulses in an adaptive-intensity region 2855 of the FOV. In one aspect steerable laser assembly can generate regions in the FOV of various intensity according to the present disclosure. For example, laser range finder can generate a first set of high-intensity laser pulses in adaptive-intensity region 2855. Adaptive-intensity region 2855 can comprise the set of all directions in the FOV in which laser range finder 21210 can generates the first set of high-intensity laser pulse. Laser range finder 21210 can further dynamically steer laser assembly 3120 to generate lower-intensity laser pulses in guard regions 21230a, 21230b and 21230c. In one embodiment of laser range finder 21210 the guard regions can the set of all directions for which a laser reflection from sub-threshold laser pulses (e.g. an eye-safe intensity) determine at least in part the subsequent laser intensity in the adaptive-intensity region of the FOV. Therefore in this embodiment guard regions are those parts of the FOV in which sub-threshold intensity laser pulses are operable to control the generation super-threshold laser pulses in a separate adaptive-intensity region of the FOV. Processing subassembly 520 can gather reflection data from laser pulses in the FOV and dynamically determine the size and shape of guard regions 21230a, 21230b and 21230c. In some situations objects detected in a guard region can have permanent placement (e.g. laser reflection indicating the hood of vehicle 2710). In other situations objects in a guard region can be determined to be mundane objects such as tree 2745. In one advantage the use of lower-intensity laser pulses in guard regions enables processing subassembly 520 to classify objects (e.g. as either human or inanimate) as part of a process for generating subsequent laser pulses with adaptive intensity in the adaptive-intensity region. Mask regions 21240a and 21240b serve to define sets of directions in the FOV from which laser reflections are not used (e.g. masked) in the process of determining whether to discontinue high-intensity laser pulses in the adaptive-intensity region. For example, mask region 21240a enables processing subassembly 520 to discount the persistent reflections form the hood of vehicle 2710 in the process of adapting the intensity of laser pulses in adaptive-intensity region 2855 based on a safety test performed using reflections from guard regions. In one embodiment processing subassembly can generate 520 can use historical data from laser reflections or other vehicle sensors (e.g. radar data, and camera data) to generate customized guard regions and in some cases customized adaptive-intensity regions to account for specific local environments.

For example, if two people own the same model of autonomous vehicle using embodiments of the present adaptive intensity laser range finder 21210, processing subassembly 520 can generate guard regions based on previous data (e.g. intrusion paths into high-intensity laser pulses) to best meet the goals of laser safety and ranging performance. Consider that a first driver may drive primarily in rural area with tree-lined streets and processing subassembly 520 can adapt to provide narrow guard regions or mask regions around the adaptive-intensity regions, thereby reducing false positive intensity reduction in the adaptive-intensity region caused by laser reflections form the trees. A second driver with the same model vehicle may drive primarily in urban areas where pedestrians often cross at cross-walks in front of the FOV. Processing subassembly 520 can adapt the guard regions to be wide and have a sufficiently low laser intensity (e.g. 1 mW/cm²) to remain eye-safe. In both bases the guard regions are comprises of laser pulses each with an intensity below a threshold intensity and control the intensity of laser pulses in a high-intensity portion of the FOV. In another aspect an autonomous vehicle (e.g. vehicle 2710) with a laser range finder 1210 according to the present disclosure can record intrusion events into an adaptive-intensity region of the FOV (i.e. where an intrusion into an active keepout zone occurred e.g. keepout zone 2758 in FIG. 24A). The use of guard regions enables valuable precursor data prior to an intrusion event to be generated using lower-intensity laser pulses. The laser range finder can adapt the shape and size of guard regions or adapt a safety test to prevent future intrusions into a keepout zone. Laser range finder 21210 can further transmit precursor data regarding ranging data prior to an intrusion event to a centralized database. Laser range finder in similar vehicles or in similar locations, can base the size and shape of guard regions in the FOV of a laser range finder at least in part on precursor data from previous intrusion events received from a centralized database. In a related aspect if several vehicle stop at a crosswalk, a first vehicle can sense a pedestrian crossing into a guard region of a first laser range finder and transmit (e.g. broadcast) a signal to other vehicle at a crosswalk indicating an object in the guard region. In this way a low-intensity set of guard laser pulses generated by a first vehicle can be used to control a high-intensity set of laser pulses generated by a neighboring vehicle.

### Operation

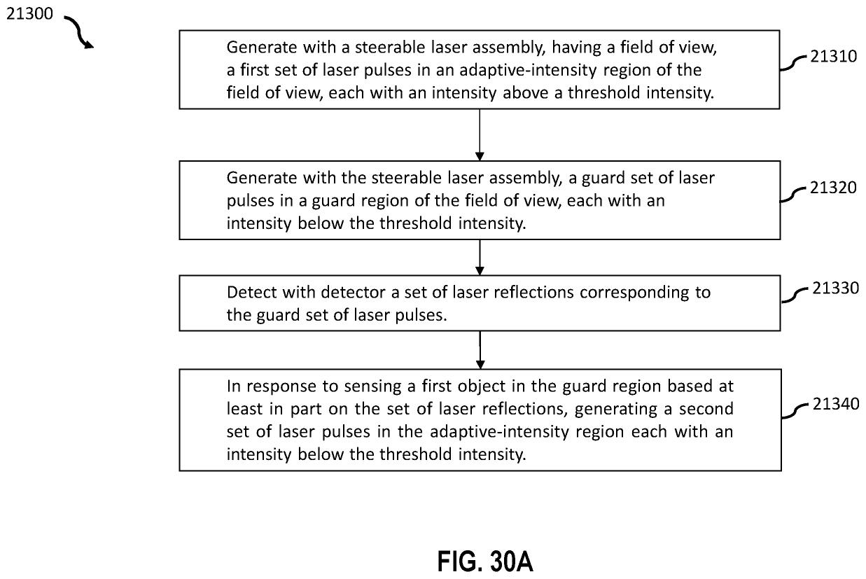

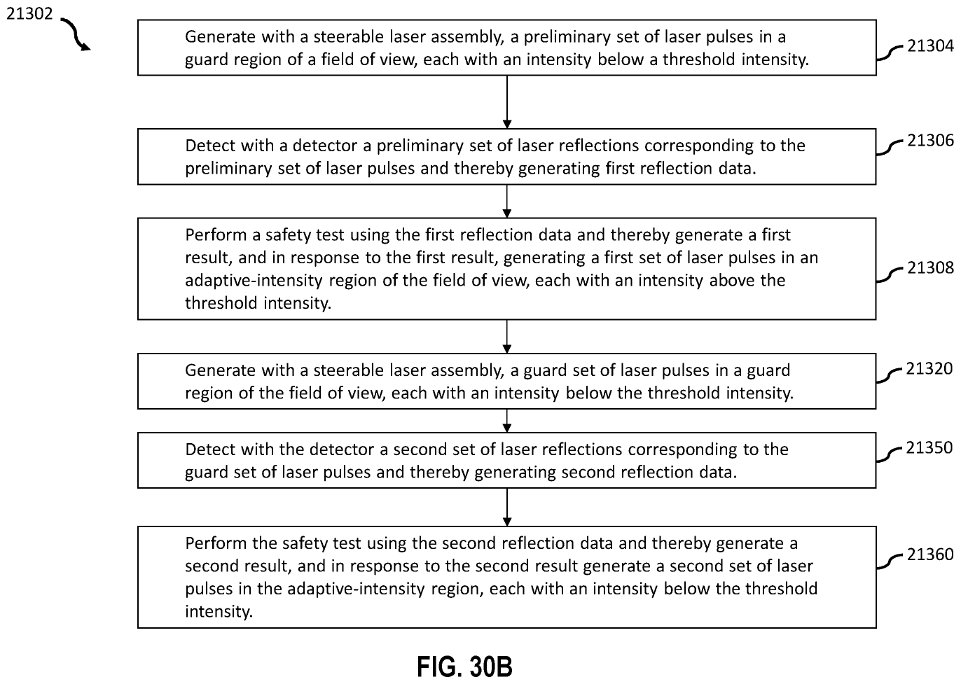

FIG. 30A is a flow chart for a method 21300 to control the intensity of a set of laser pulses in an adaptive-intensity region of a FOV based detecting an object using laser reflections from sub-threshold laser pulses in a neighboring guard region of a FOV. At step 21310 a steerable laser assembly in a laser range finder, having a FOV generates a first set of laser pulses in an adaptive-intensity region of the FOV, each with an intensity above a threshold intensity. At step 21320 the steerable laser assembly generates, a guard set of laser pulses in a guard region of the FOV, each with an intensity below the threshold intensity. At step 21330 a detector in the steerable laser assembly detects a set of laser reflections corresponding to the guard set of laser pulses. The detector 440 can generate reflection data based on the set of laser reflections indicating the direction and range corresponding to each reflection in the set of reflections. At step 21340 in response to sensing a first object in the guard region based at least in part on the set of laser reflections, the steerable laser assembly generates a second set of laser pulses in the adaptive-intensity region each with an intensity below the threshold intensity.

FIG. 30B is a flow chart for a related method 21302 to generate high-intensity laser pulses in a adaptive-intensity region of a FOV based on the result of safety test performed on laser reflections from a neighboring guard region. Subsequently, method 21302 generates another set of laser pulses in the guard region of the FOV, performs the safety test a second time, updates the result of the safety test, and generates a set of laser pulses with reduced intensity below a threshold intensity in the adaptive-intensity region of the FOV based at least in part on the updated result.

At step 21304 a steerable laser assembly in a laser range finder steers at least one laser beam and thereby generates, a preliminary set of laser pulses in a guard region of the field of view, each with an intensity below a threshold intensity. At step 21306 detector in the steerable laser assembly detects a preliminary set of laser reflections corresponding to the preliminary set of laser pulses and thereby generating first reflection data. The first reflection data can indicate the direction and range corresponding to laser reflections in the set of laser reflections.

At step 21308 the laser range finder performs a safety test using the first reflection data and thereby generates a first result. In response to the first result, the steerable laser range finder steers at least one laser beam and thereby generates a first set of laser pulses in an adaptive-intensity region of the field of view, each with an intensity above the threshold intensity. At step 21320 the steerable laser assembly generates, a guard set of laser pulses in a guard region of the FOV, each with an intensity below the threshold intensity. At step 21350 the detector detects a second set of laser reflections corresponding to the guard set of laser pulses and thereby generates second reflection data

At step 21360 the laser range finder performs the safety test again using the second reflection data and thereby generate a second result, and in response to the second result generates a second set of laser pulses in the adaptive-intensity region, each with an intensity below the threshold intensity. The second result can indicate the intrusion of an object (e.g. a person) into the adaptive-intensity region (e.g. the path of the high-intensity laser pulses) at some time in the near future. In several embodiments of method 21302, the laser range finder discontinues generating high-intensity laser pulses and instead exclusively generates laser pulses with intensities below the threshold intensity in the adaptive region, in response to the second result.

Exemplary safety tests can be: (a) a determination of any object is detected in the guard region, (b) a determination if any object in the guard region is moving towards the adaptive-intensity region, (c) a determination if any object in the guard region will intersect with a high-energy laser pulse or ingress into the adaptive-intensity region within a threshold period of time (e.g. a person will enter the adaptive-intensity region within the next 2 seconds), (d) a determination, based on reflection data from the set of guard laser pulses that an object exists in a guard region and within a threshold distance, or (e) a determination whether reflection data indicates an object in the guard region with an angular velocity (e.g. rate of change of direction in the FOV) above some threshold. Exemplary safety test results can be (a) satisfaction of a criterion (e.g. safety test result=TRUE), (b) dissatisfaction of a safety test (e.g. safety test result=FALSE), (c) an indication of a highest or lowest value (e.g. the closest proximity of an object to the adaptive intensity zone, such as result=10 meters) or (d) a velocity or angular velocity towards a keepout-zone for one or more objects.

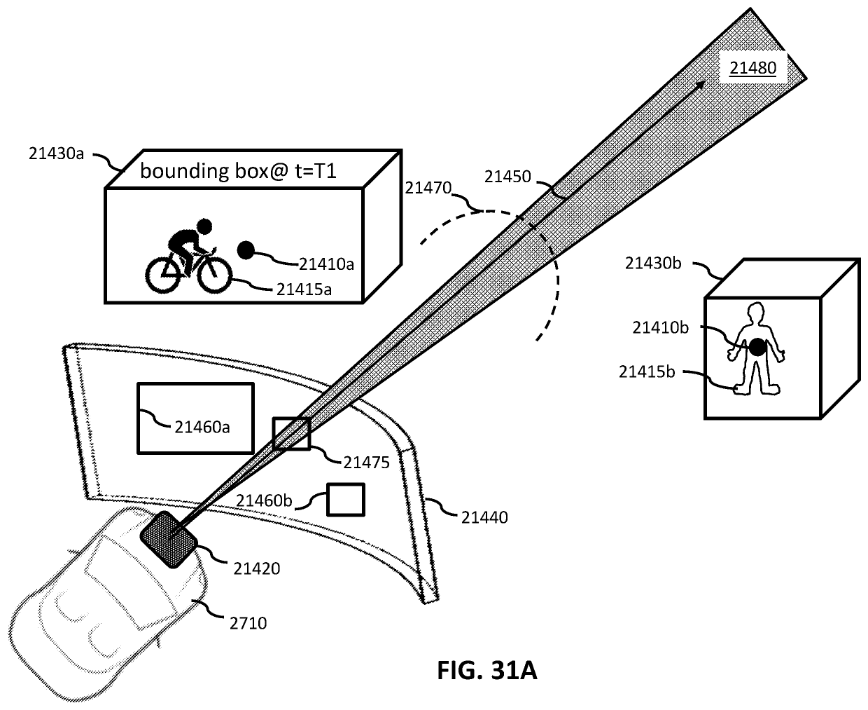

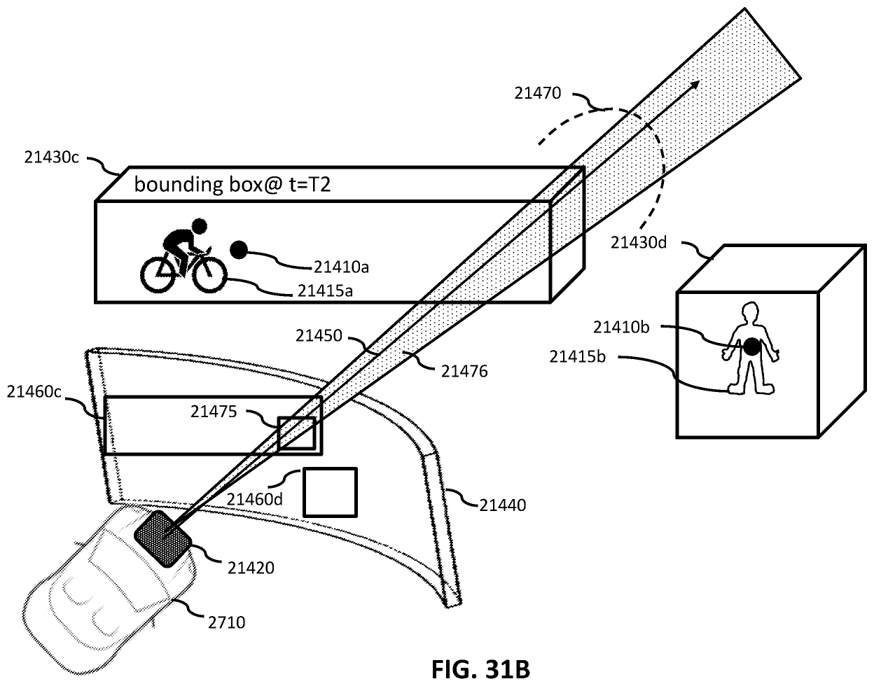

FIG. 31A illustrates a laser range finder 21420 that generates a set of laser pulses, with pulses intensities based location estimates for a set of objects and the associated age of the location estimates. In several embodiments the age of a location estimate of an object can serve be used to determine a range of possible locations for the object at some future time when the range finder is generating laser pulses.

Driving a vehicle often requires near-real time object tracking. In the process of driving a vehicle objects in the vicinity of the vehicle are often constantly changing location relative to the vehicle. For example, a vehicle driver who identifies a location estimate for a cyclist 21415a can instinctually associate an age with the location estimate indicative of the time elapsed since they estimated the location of the cyclist. When the age is low (i.e. the location estimate for the cyclist is very recent) the driver may perform a precise maneuver with the vehicle (e.g. crossing over an associated bicycle lane). Conversely, the driver may decide to be more cautious if the age associated with the cyclist location estimate becomes too large (e.g. the location estimate becomes greater than 5 seconds old).

Turning to FIG. 31A a laser range finder 21420 can apply a similar principal of aging location estimates to the process of generating high-intensity laser pulses. For example, when location estimates are sufficiently current a laser range finder may identify that a region of the FOV is free of objects within a threshold distance and generate high-intensity laser pulses. Conversely, object location estimates become too old the laser range finder may lose confidence that a region of the FOV is free of objects and therefore generate lower-intensity laser pulses instead.

In the embodiment of FIG. 31A a laser range finder 21420 receives a location estimate (e.g. 21410a and 21410b) for each object in a set of objects (e.g. cyclist 21415b and person 21415b). Location estimates 21410a and 21410b can be 3D locations in the vicinity of laser range finder 21420 or 2D location estimates in the FOV 21440 of laser range finder 21420. Location estimates can be provided to a processing subassembly in laser range finder 21420 or calculated by the processing subassembly based on sensor data (e.g. sensor data from a detector in laser range finder 21420, radar sensors, cameras or ultrasound sensors). Laser range finder 21420 can obtain an age associated with each location estimate. The age can be in the form of a time or number of clock cycles indicating the age of the location estimate associated with the corresponding object. For example, the age can be a number of clock cycles or milliseconds since the data used to obtain a location estimate was obtained or since the location estimate itself as calculated.

For each object in the set of objects the corresponding age and the corresponding location estimate can be used to generate a location probability distribution. The location probability distribution for an object (e.g. cyclist 21415a) can be a function or a database of probabilities such that for a candidate 2D or 3D location in the vicinity of the location estimate (e.g. location estimate 21410a) the location probability distribution can indicate a probability that the corresponding object (e.g. cyclist 21415a) occupies the candidate location at some time in the future. The location probability distribution can be based at least in part on a trajectory or direction of travel obtained for an object. For example, laser range finder 21420 can sense a greater velocity (e.g. rate of angular change in the FOV) for cyclist 21415a than pedestrian 21415b. Similarly, cyclist 21415a can be closer to the laser range finder and thereby subtend a larger range of angles per unit time. The laser range finder can calculate a perceived velocity for each object in the set of objects and use the perceived velocity to calculate the location probability distribution at some later time. For each object a threshold can be applied to the corresponding location probability distribution (e.g. a threshold that the probability of occupying a candidate location must be greater than 0.005). Laser range finer 21420 can determine for each object of the set of objects a corresponding object zone (e.g. portion of the surrounding vicinity) in which the location probability is greater than the threshold probability. Alternatively, an object zone corresponding to an object can be a set of 3D locations comprising a region within which the integrated probability of finding the object is greater than a threshold (e.g. the region in which there is a 95% probability of finding cyclist 21415a). For example, laser range finder 21420 can construct bounding box 21430a indicative of the object zone in which there is a 95% probability of finding cyclist 21415a at some time (e.g. at time=T1=2 seconds) after the location estimate 21410a. The bounding boxes 21430a and 21430b or similar object zones determined by a location probability threshold can have a 2D projection onto the FOV 21440, thereby generating corresponding object regions 21460a and 21460b within the FOV. Alternatively, laser range finder 21420 can calculate for each object an updated location estimate based on measurement data providing an initial location estimate, a trajectory and an age of the initial location estimate. In this way the updated location estimate for each object in the set of objects is a prediction of the present location of the object based on the initial location estimate and a measured trajectory.

Laser range finder 21420 can generate a set of laser pulses (e.g. pulse 21450) in a region 21475 of the FOV 21440. The intensity of each laser pulse in the set of laser pulses can be based at least in part on the corresponding location estimate (e.g. 21410a) and the corresponding age for at least one object in the set of objects in the vicinity. In an alternative embodiment each laser pulse can have an intensity based at least in part on a location probability distribution for an object. In yet another embodiment each laser pulses can have an intensity based at least in part on object zone (e.g. 21430a), an object region (e.g. 21460a or 21460b) or an updated location estimate for an object in the set of objects. In one embodiment of FIG. 31A laser range finder can identify that at time T1 the bounding boxes 21430a and 21430b (e.g. object zones indicating the bounds of where objects can reasonably exist at some time T1 after an location estimate) do not touch the zone 21480 and thereby generate high-intensity laser pulses in zone 21480 (e.g. laser pulse 21450).

In a similar embodiment laser range finder 21420 can identify that at time T1 the object regions 21460a and 21460b (e.g. the projections of object zones corresponding to objects onto the FOV) do not touch region 21475 in which the set of adaptive intensity laser pulses are generated and hence laser range finder 21420 can generate high-intensity laser pulses with directions in region 21475 of the FOV (e.g. laser pulse 21450).

In this way laser range finder 21420 uses the age of the location estimates to expand the zones of the vicinity (or regions of the FOV) where object are likely to exist. High-intensity laser pulses can have an initial intensity that is above an eye-safe threshold intensity and remain above the eye-safe intensity up to a threshold distance 21470. In the embodiment of FIG. 31A high-intensity laser pulses are generated when the location of a set of objects cannot reasonable intersect with the path of high-intensity laser pulses.

FIG. 31B illustrates the same laser range finder 21420 at some time T2 after obtaining a set of location estimates for objects in the FOV. In FIG. 31B time T2 is greater than T1. Location estimates 21410a and 21410b are the same as in FIG. 31A, thereby indicating an initial estimate at some time t=0. The object zones indicated by bounding boxes 21430c and 21430d are larger than the corresponding object zones at t=T1, thereby indicating a wider range of possible locations for objects 21415a and 21415b. In particular, the projection of bounding box 21430c onto the FOV generates an object region 21460c that intersects the region of adaptive intensity laser pulses 21475. Hence the validity of an object-free keepout zone 21476 cannot be guaranteed. Laser range finder 21420 can generate a lower-intensity set of laser pulses (e.g. pulse 21450) that eliminates the keepout zone, based in part on the intersection of object region 21460c with adaptive-intensity region 21475.

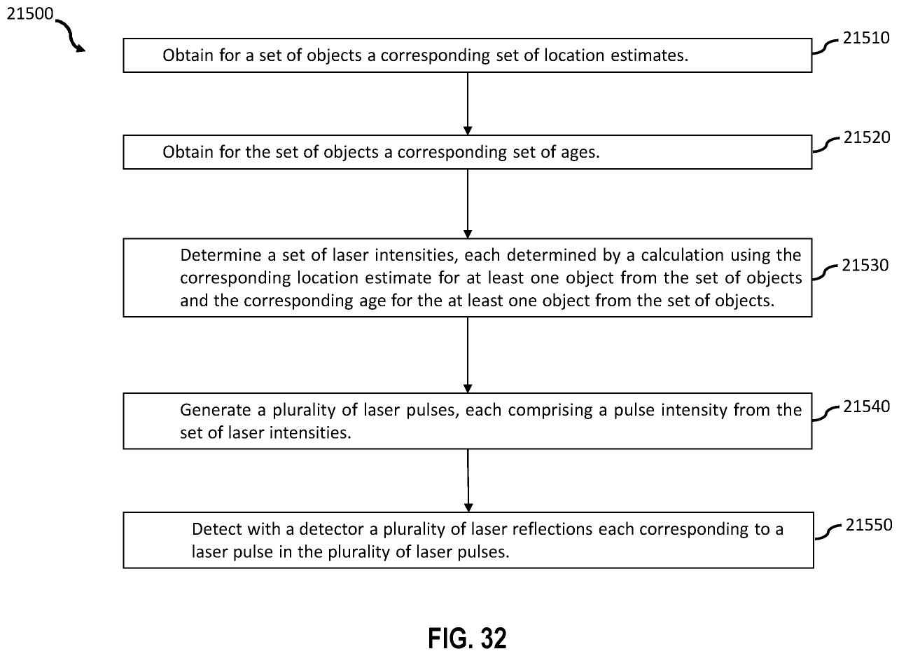

FIG. 32 is a flow chart for a method 21500 to adapt the intensity of laser pulses generated by a laser range finder based, on the possible locations of objects in the FOV. At step 21510 the method obtains for a set of objects a corresponding set of location estimates. At step 21520 the method obtains for the set of objects a corresponding set of ages indicating the time elapsed since the data used to generate the location estimates was gathered. At step 21530 the method determines a set of laser intensities; each calculated using for at least one object from the set of objects the corresponding location estimate and the corresponding age.

At step 21540 the method generates with the laser range finder a plurality of laser pulses, each comprising a laser pulse intensity from the set of laser intensities. At step 21550 the method detects with a detector in the laser range finder a plurality of laser reflections each corresponding to a laser pulse in the plurality of laser pulses

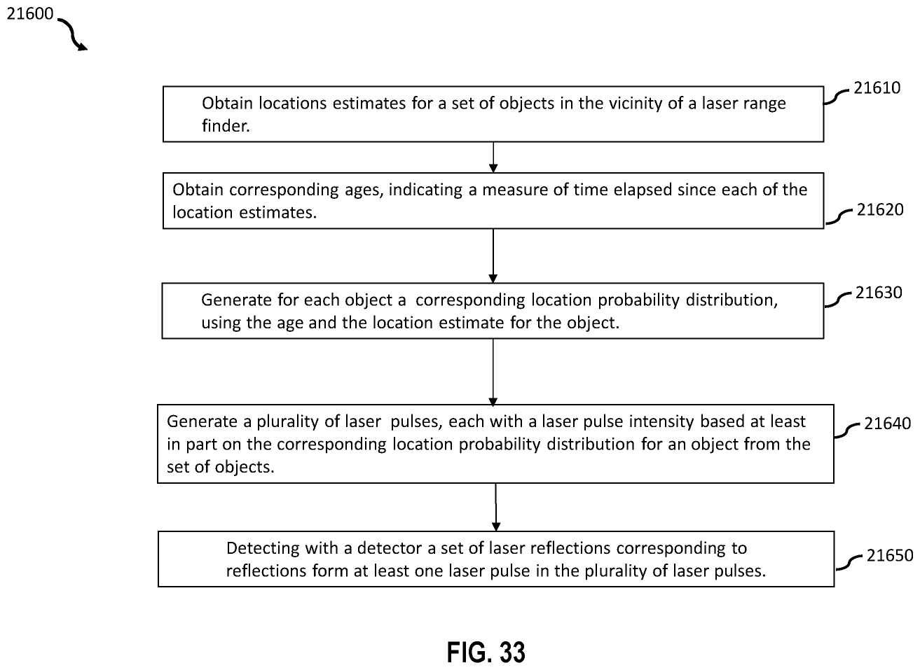

FIG. 33 is a flow chart for a method 21600 to generate a plurality of laser pulses with intensities selected based on the probability of finding each object in a set of objects within a FOV.

At step 21610 the method obtains location estimates for each object in a set of objects in the vicinity of a laser range finder. At step 21620 the method obtains for each object in the set of objects a corresponding age indicative of the time elapsed since the data indicating the location estimate of the corresponding object was gathered. At step 21630 the method generates for each object in the set of objects a corresponding location probability distribution, using the age and the location estimate for the object. At 21640 the method generates with a laser range finder a plurality of laser pulses, each with a laser pulse intensity based at least in part on the corresponding location probability distribution for an object from the set of objects. At step 21650 the method detects with a detector in the laser range finder a plurality of laser reflections, each resulting from at least one laser pulse in the plurality of laser pulses.

While the above description contains many specificities, these should not be construed as limitations on the scope of any embodiment, but as exemplifications of various embodiments thereof. Many other ramifications and variations are possible within the teachings of the various embodiments. Thus the scope should be determined by the appended claims and their legal equivalents, and not by the examples given.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present.

Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure.

Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
scanning, with a light detection and ranging system (LIDAR) mounted to a vehicle, a local environment of the vehicle, wherein the LIDAR emits laser pulses with an intensity at or above a threshold intensity and detects reflections of the emitted laser pulses based on a direction of the LIDAR, and wherein the scanning comprises changing the direction of the LIDAR relative to the vehicle;
emitting a set of guard light pulses with intensities below the threshold intensity and identifying a range of directions of the LIDAR based on one or more reflections from the set of guard light pulses;
determining whether a current direction of the LIDAR is within the identified range of directions;
in response to a determination that the current direction of the LIDAR is within the identified range of directions, stopping generation with the LIDAR of laser pulses with intensities at or above the threshold intensity; and
in response to determining that the current direction of LIDAR is outside the range of directions, resuming generation with the LIDAR of laser pulses with intensities at or above the threshold intensity.

2. The method of claim 1 further comprising the step of scanning a guard laser generator, mounted to the vehicle, to thereby emit the set of guard light pulses, wherein the scanning by the guard laser generator comprises changing a direction of the guard laser generator relative to the vehicle.

3. The method of claim 2 wherein the guard laser generator emits the set of guard light pulses in a guard range of directions that is exclusive from the identified range of directions of the LIDAR.

4. The method of claim 1 wherein the identified range of directions of the LIDAR is based on an intensity of at least one reflection from the guard set of light pulses.

5. The method of claim 1 wherein the step of identifying the range of directions of the LIDAR, uses a magnitude of an intensity and a reflection direction corresponding to at least one reflection from the set of guard light pulses to at least in part identify the range of directions of the LIDAR.

6. The method of claim 1 further comprising the step of in response to the determination that the current direction of the LIDAR is within the identified range of directions, generating with the LIDAR laser pulses with intensities below the threshold intensity.

7. The method of claim 1 further comprising the step of avoiding scanning the range of directions of the LIDAR by emitting with the LIDAR a set of laser pulses with intensities at or above the threshold intensity and steering each of the set of laser pulses in directions that avoid the range of directions.

8. The method of claim 1 wherein the step of identifying a range of directions of the LIDAR is based on an object detected using the one or more reflections from the set of guard light pulses.

9. A method comprising:
scanning, with a light detection and ranging system (LIDAR) mounted to a vehicle, a local environment around the vehicle exterior, wherein the LIDAR comprises a steerable laser assembly, wherein the LIDAR initially emits laser pulses with an intensity at or above a threshold intensity and detects reflections of the emitted laser pulses based on a direction of the steerable laser assembly, and wherein the scanning comprises changing the direction of the steerable laser assembly relative to the vehicle;
emitting a set of guard laser pulses with intensities below the threshold intensity and identifying a range of directions of the steerable laser assembly based on one or more reflections from the set of guard laser pulses;
determining whether a current direction of the steerable laser assembly is within the identified range of directions;
in response to a determination that the current direction of the steerable laser assembly is within the identified range of directions, configuring the LIDAR to stop generating laser pulses with intensities at or above the threshold intensity; and
in response to determining that the steerable laser assembly is scanning a direction outside the range of directions, configuring the LIDAR to resume generating laser pulses with intensities at or above the threshold intensity.

10. The method of claim 9 further comprising the steps of emitting with the LIDAR a set of high-intensity laser pulses, each with an intensity above the threshold intensity, and steering each high-intensity laser pulses in the set of high-intensity laser pulses in a direction that avoids the range of directions.

11. The method of claim 9 wherein the scanning with the LIDAR of the local environment comprises emitting laser pulses in a sequence of directions, and
wherein before the LIDAR scans each direction in the sequence of directions a guard laser pulse is emitted in the each direction.

12. The method of claim 9 further comprising the step of scanning with a guard laser generator the local environment around the vehicle exterior, while emitting the set of guard laser pulses, wherein the scanning with the guard laser generator comprises changing a direction of the guard laser generator relative to the vehicle; and
wherein during the scanning of the local environment by the LIDAR and the scanning of the local environment by the guard laser generator the current direction of the guard laser generator precedes the current direction of the LIDAR by a constant angle.

13. The method of claim 9 further comprising the step of determining a distance to an object using one or more reflections from the guard set of laser pulses and wherein the range of directions is based on the distance to the object.

14. The method of claim 9 further comprising the step of detecting an object with the guard set of laser pulses, and
wherein the identified range of directions functions to avoid emitting laser pulses with the LIDAR in directions that intersect at least some of the object.

15. A system comprising:
a light detection and ranging system (LIDAR), mounted to a vehicle, configured to scan a local environment of the vehicle, by emitting laser pulses with an intensity at or above a threshold intensity and detecting reflections of the emitted laser pulses based on a laser direction of the LIDAR, and wherein the LIDAR is configured to scan the local environment by changing the laser direction of the LIDAR relative to the vehicle;
a guard laser generator configured to emit a set of guard laser pulses with intensities below the threshold intensity; and
circuitry configured to:
identify a range of laser directions of the LIDAR based on one or more reflections from the set of guard laser pulses;
determine whether a current laser direction of the LIDAR is within the identified range of laser directions;
in response to a determination that the current laser direction of the LIDAR is within the identified range of laser directions, stop generation by the LIDAR of laser pulses with intensities at or above the threshold intensity; and
in response to determining that the current laser direction of the LIDAR is outside the range of laser directions, resume generation by the LIDAR of laser pulses with intensities at or above the threshold intensity.

16. The system of claim 15 wherein the guard laser generator is configured to scan a guard region of the local environment, wherein the scanning comprises changing a direction of the guard laser generator relative to the vehicle while emitting the set of guard laser pulses; and
wherein the circuitry is further configured to scan the guard region with the LIDAR after the guard laser generator has scanned the guard region and identified the range of laser directions.

17. The system of claim 15 wherein the guard laser generator is mounted relative to the LIDAR such that a constant angular difference is maintained between the laser direction of the LIDAR and a direction of the guard laser generator as the LIDAR scans the local environment.

18. The system of claim 15 wherein the LIDAR further comprises a mirror that deflects the emitted laser pulses of the LIDAR to define the current laser direction of the LIDAR.

19. The system of claim 15 wherein the LIDAR further comprises a mirror that deflects the emitted laser pulses of the LIDAR to define the laser direction of the LIDAR as the LIDAR scans.

20. The system of claim 15 further comprising an intensity calculator to calculate the intensity of reflections from the set of guard laser pulses and wherein the circuitry is further configured to determine the range of laser directions based at least in part on an intensity of at least one reflections from the set of guard laser pulses.
